(19) United States
(12) Patent Application Publication
(10) Pub. No.: US 2012/0207992 A1
(43) Pub. Date: Aug. 16, 2012

(54) PRODUCTION METHOD OF ANTIREFLECTION FILM, ANTIREFLECTION FILM AND COATING COMPOSITION

(75) Inventors: Nobuyuki AKUTAGAWA, Kanagawa (JP); Hiroyuki YONEYAMA, Kanagawa (JP); Daiki WAKIZAKA, Kanagawa (JP)

(73) Assignee: FUJIFILM Corporation, Tokyo (JP)

(21) Appl. No.: 13/396,195

(22) Filed: Feb. 14, 2012

(30) Foreign Application Priority Data
Feb. 15, 2011 (JP) 2011-030309

(51) Int. Cl. B32B 7/02; C09D 163/00; C09D 183/04; C09D 127/12; B05D 5/06; B05D 3/00

(52) U.S. Cl. 428/216; 427/162; 524/588; 524/544; 523/400

(57) ABSTRACT

A production method of an antireflection film comprises, in order, a step of applying a coating composition obtained by mixing the following components (A) to (D) on a base material to form a coating film, a step of drying the coating film to volatilize the solvent therefrom, and a step of curing the coating film to form a cured layer, wherein a multilayer structure having different refractive indexes is formed from the coating composition: (A) a compound having at least one structure selected from a fluorine-containing hydrocarbon structure and a polysiloxane structure and at least one basic functional group, (B) an inorganic fine particle, (C) a curable binder containing no fluorine atom in the molecule, and (D) a solvent, provided that the mass ratio of [component (A)+component (B)]/[component (C)] is from 1/199 to 60/40.

### CROSS-REFERENCE TO RELATED APPLICATIONS

This application claims priority from Japanese Patent Application No. 2011-30309, filed Feb. 15, 2011, the contents of all of which are hereby incorporated by reference in their entirety.

### BACKGROUND OF THE INVENTION

1. Field of the Invention

The present invention relates to a production method of an antireflection film, an antireflection film, and a coating composition. More specifically, the present invention relates to a coating composition ensuring high production efficiency by making it possible to form a multilayer structure in one coating step, a method for producing an antireflection film having a multilayer structure consisting of two or more layers by using the coating composition, and an antireflection film produced by the method.

2. Description of the Related Art

An antireflection film is required to have low reflectance so as to prevent reduction in the contrast due to reflection of outside light or disturbing reflection of an image when disposed on the display surface of an image display device such as liquid crystal display device (LCD), cathode ray tube display device (CRT), plasma display panel (PDP) and electroluminescent display (ELD), and at the same time, required to have high physical strength (e.g., scratch resistance), transparency and the like.

Therefore, the antireflection film is generally produced by forming a hardcoat layer and a low refractive index layer having a refractive index lower than that of the base material and having an appropriate film thickness, in order, on a base material.

Such an antireflection film is usually produced by a coating method, but stacking of a plurality of thin films differing in the refractive index has a problem in the productivity, because a film forming process including at least performing a coating step a plurality of times is necessary, facilities contingent on the plurality film forming steps must be provided, or a process time for operating the facilities is required.

With respect to this problem, a technique capable of forming two or more layers from one coating solution is disclosed (see, for example, JP-A-2006-206832 (the term “JP-A” as used herein means an “unexamined published Japanese patent application”), JPA-2007-038199, and JP-A-2007-238897). This technique is excellent in that an antireflection film can be produced through a small number of coating steps, but the coating solvent has no latitude of choice, control of the drying step after coating is difficult, and an antireflection film having high antireflection performance obtained under precise film thickness control can be hardly obtained due to fluctuation of conditions or non-uniformity of drying.

Also, in the antireflection film, more improvements are demanded in view of adherence between layers, scratch resistance of the surface and the surface state failure.

### SUMMARY OF THE INVENTION

An object of the present invention is to provide a production method of an antireflection film, where the production efficiency can be enhanced by forming a multilayer structure consisting of two or more layers in one coating step, an antireflection film obtained by the production method, which is excellent in view of reflectance, adherence, scratch resistance and surface failure improvement, and a coating composition used for forming the multilayer structure above.

As a result of intensive studies to solve the above-described problems, the present inventors have found that those problems can be solved and the object above can be attained by employing the following configurations. The present invention has been accomplished based on this finding.

One embodiment of the present invention is a technique related to a coating composition capable of enhancing the production efficiency by forming a two-layer structure in one coating step, particularly, a technique where an inorganic particle is surface-coated with a specific compound having a low surface energy and exhibiting excellent bonding force to the inorganic fine particle to thereby reduce the surface energy of the surface-coated inorganic particle and control the inorganic fine particle to voluntarily make an uneven distribution in the coated film applied.

In particular, the above-described inorganic fine particle reduced in the surface energy can be unevenly distributed to the upper layer on the air interface side and can form a multilayer structure in the coated film. By using, in the coating composition, a curable binder that is prone to phase separation from the above-described compound having a low surface energy, a layer where the inorganic fine particle is present and a layer where the particle is not present can be formed in the upper portion.

The object of the present invention can be attained by the following configurations.

(1) A production method of an antireflection film, comprising, in order, a step of applying a coating composition obtained by mixing the following components (A) to (D) on a base material to form a coating film, a step of drying the coating film to volatilize the solvent therefrom, and a step of curing the coating film to form a cured layer, wherein a multilayer structure having different refractive indexes is formed from the coating composition:

(A) a compound having at least one structure selected from a fluorine-containing hydrocarbon structure and a polysiloxane structure and at least one basic functional group,

(B) an inorganic fine particle,

(C) a curable binder containing no fluorine atom in the molecule, and

(D) a solvent provided that the mass ratio of [component (A)+component (B)]/[component (C)] is from 1/199 to 60/40.

(2) The production method of an antireflection film as described in (1) above, wherein the component (A) is a fluorine-containing polymer represented by the following formula (1):

(MF1)a-(MF2)b-(MF3)c-(MA)d-(MB)e-(MD)g Formula (1):

wherein each of a to e and g indicates the molar fraction of each constituent unit and represents a value satisfying the relationships of 0≦a≦70, 0≦b≦70, 30≦a+b≦70, 0≦c≦50, 0≦d≦50, 0≦e≦50, and 0.1≦g≦30;

(MF1) indicates a constituent unit polymerized from a monomer represented by CF₂═CF—Rf₁, wherein Rf₁ represents a perfluoroalkyl group having a carbon number of 1 to 5;

(MF2) indicates a constituent unit polymerized from a monomer represented by CF₂═CF—ORf₁₂, wherein Rf₁₂ represents a fluorine-containing alkyl group having a carbon number of 1 to 30;

(MF3) indicates a constituent unit polymerized from a monomer represented by CH₂═CH—ORf₁₃, wherein Rf₁₃ represents a fluorine-containing alkyl group having a carbon number of 1 to 30;

(MA) represents a constituent unit having at least one crosslinking groups;

(MB) represents an arbitrary constituent unit; and

(MD) represents a constituent unit having at least one basic functional groups.

(3) The production method of an antireflection film as described in (1) above, wherein the component (A) is a polymer containing a polymerization unit having a fluorine-containing hydrocarbon structure and the basic component-containing constituent unit is grafted.
(4) The production method of an antireflection film as described in (2) above, wherein the (MD) is a constituent unit obtained by reacting an unsaturated group-containing prepolymer containing a basic functional group.
(5) The production method of an antireflection film as described in (2) above, wherein the (MD) is a constituent unit obtained by reacting a component having bonded thereto a basic functional group-containing compound through a polyfunctional epoxy compound.
(6) The production method of an antireflection film as described in (1) above, wherein the component (A) is a polysiloxane compound represented by the following formula (2):

(polysiloxane unit)α-(MA)β-(MB)γ-(MD)ε Formula (2):

wherein each of α to γ and ε indicates the mass proportion of each constituent unit and is a value satisfying the relationships of 2≦α≦99, 0≦β≦70, 0≦γ≦70, and 0.1≦ε≦30;

(polysiloxane unit) represents a polysiloxane unit copolymerizable with other components;

(MA) represents a constituent unit having at least one crosslinking groups;

(MB) represents an arbitrary constituent unit; and

(MD) represents a constituent unit having at least one basic functional groups.

(7) The production method of an antireflection film as described in any one of (1) to (6) above, wherein the component (A) contains both a fluorine-containing hydrocarbon unit and a polysiloxane unit in the molecule.
(8) The production method of an antireflection film as described in any one of (1) to (7) above, wherein the component (A) contains a polymerizable functional group in the molecule.
(9) The production method of an antireflection film as described in any one of (1) to (8) above, wherein the component (B) is a metal oxide fine particle having an average particle diameter of 1 to 150 nm and a refractive index of 1.46 or less.
(10) The production method of an antireflection film as described in any one of (1) to (9) above, wherein the component (B) is an inorganic fine particle surface-treated with at least one member selected from an organosilane compound, its partial hydrolysate and a condensation product thereof.
(11) The production method of an antireflection film as described in any one of (1) to (10) above, wherein the component (B) is a metal oxide particle with the inorganic fine particle surface comprising at least silicon as the constituent component.
(12) The production method of an antireflection film as described in any one of (1) to (11) above, wherein a compound having at least a plurality of unsaturated double bonds in the molecule is contained as the curable binder of the component (C).
(13) The production method of an antireflection film as described in any one of (1) to (12) above, wherein the coating composition further contains, as the component (E), a curable compound having a fluorine atom in the molecule.
(14) The production method of an antireflection film as described in (13) above, wherein both of the component (A) and the component (E) are a fluorine-containing copolymer and at least two constituent units out of constituent units forming each copolymer are common therebetween.
(15) The production method of an antireflection film as described in any one of (1) to (14) above, wherein the free energy of mixing (ΔG=ΔH−T·ΔS) of the curable binder as the component (C) and the compound as the component (A) is larger than 0.
(16) The production method of an antireflection film as described in (13) or (14) above, wherein in the coating composition, the mass ratio [component (A)+component (B)+component (E)]/[component (C)] is from 1/199 to 60/40.
(17) The production method of an antireflection film as described in any one of (1) to (16) above, wherein the component (D) is a mixed solvent of at least the following two solvents:

(D-1) a volatile solvent wherein a difference in the compatibility parameter between the volatile solvent and either one of the component (A) and the component (C) is from 1 to 10, and

(D-2) a volatile solvent having a boiling point of 100° C. or less.

(18) The production method of an antireflection film as described in (17) above, wherein the solvent further contains, as the component (D-3), a volatile solvent having a boiling point exceeding 100° C.
(19) An antireflection film obtained by the production method described in any one of (1) to (18) above.
(20) The antireflection film as described in (19) above, wherein the film thickness of the cured layer formed of the coating composition described in (1) above is from 0.1 to 20 μm, the cured layer has a low refractive index layer in which the component (B) is unevenly distributed to the air interface side, and the film thickness of the low refractive index layer is from 40 to 300 nm.
(21) The antireflection film as described in (20) above, wherein the refractive index of the low refractive index layer in which the component (B) is unevenly distributed to the air interface side is from 1.15 to 1.48.
(22) A coating composition obtained by mixing the following components (A) to (D):

(A) a compound having at least one structure selected from a fluorine-containing hydrocarbon structure and a polysiloxane structure and at least one basic functional group,

(B) an inorganic fine particle,

(C) a curable binder containing no fluorine atom in the molecule, and

(D) a solvent provided that the mass ratio of [component (A)+component (B)]/[component (C)] is from 1/199 to 60/40.

According to the present invention, a coating composition making it possible to form a multilayer structure consisting of two or more layers in one coating step can be provided.

Also, a production method of an antireflection film, ensuring excellent productivity (simplified production process) by using the coating composition, can be provided. Furthermore, an antireflection film having low reflectance, high scratch resistance, high adherence and surface failure improving effect can be provided.

### DETAILED DESCRIPTION OF THE INVENTION

The present invention relates to a production method of an antireflection film, comprising, in order, a step of applying a coating composition obtained by mixing the following components (A) to (D) on a base material to form a coating film, a step of drying the coating film to volatilize the solvent therefrom, and a step of curing the coating film to form a cured layer, wherein a multilayer structure having different refractive indexes is formed from the coating composition:

(A) a compound having at least one structure selected from a fluorine-containing hydrocarbon structure and a polysiloxane structure and at least one basic functional group,

(B) an inorganic fine particle,

(C) a curable binder containing no fluorine atom in the molecule, and

(D) a solvent provided that the mass ratio of [component (A)+component (B)]/[component (C)] is from 1/199 to 60/40.

The present invention also relates to the coating composition above.

<(A) Compound Having at Least One Structure Selected from Fluorine-Containing Hydrocarbon Structure and Polysiloxane Structure and at Least One Basic Functional Group>

The coating composition of the present invention contains, as the component (A), “a compound having at least one structure selected from a fluorine-containing hydrocarbon structure and a polysiloxane structure and at least one basic functional group”.

The fluorine-containing hydrocarbon structure includes, for example, a group containing a fluorine-containing hydrocarbon, and a monomer unit containing a fluorine-containing hydrocarbon (a unit obtained from a monomer containing a fluorine-containing hydrocarbon).

The fluorine-containing hydrocarbon structure is a fluorine-containing aliphatic hydrocarbon group, a fluorine-containing aromatic hydrocarbon group, a monomer unit containing a fluorine-containing aliphatic hydrocarbon, or a monomer unit containing a fluorine-containing aromatic hydrocarbon, preferably a fluorine-containing aliphatic hydrocarbon group or a monomer unit containing a fluorine-containing aliphatic hydrocarbon.

The molecular weight of the fluorine-containing hydrocarbon structure is preferably from 500 to 100,000, more preferably from 1,000 to 80,000, and most preferably from 2,000 to 50,000. As for the adjustment of the molecular weight of the fluorine-containing hydrocarbon structure, in the case of a monomer unit containing a fluorine-containing hydrocarbon, adjustment by changing the polymerization degree of a fluorine-containing vinyl monomer is easy and preferred. Examples of the fluorine-containing vinyl monomer include fluoroolefins, partially or completely fluorinated alkyl ester derivatives of (meth)acrylic acid, and partially or completely fluorinated vinyl ethers. One of these fluorine-containing hydrocarbon structures may be used alone, or a plurality of kinds may be mixed.

The polysiloxane structure is preferably an oligomer or polymer of siloxane substituted with an alkyl group or an aryl group. The alkyl group is preferably an alkyl group having a carbon number of 1 to 4, and a part or all of hydrogen atoms in the alkyl group may be substituted for by a fluorine atom. Examples of the alkyl group include a methyl group, a trifluoromethyl group and an ethyl group. The aryl group is preferably an aryl group having a carbon number of 6 to 20, and a part or all of hydrogen atoms in the aryl group may be substituted for by a fluorine atom. Examples of the aryl group include a phenyl group and a naphthyl group. Among these, a methyl group and a phenyl group are preferred, and a methyl group is more preferred. The molecular weight of the polysiloxane structure is preferably from 500 to 100,000, more preferably from 1,000 to 50,000, and most preferably from 2,000 to 20,000.

Examples of the basic functional group contained in the component (A) include an amino group, a quaternary ammonium group, an amide group, a pyridyl group, a triazine group, a pyryl group, an indolyl group, a carbazoyl group and an imidazoyl group. Among these, in view of interaction with the particle, an amino group and an amide group are preferred.

The number of basic functional groups per molecule of the component (A) is preferably from 1 to 20 and in the case where the basic functional group is randomly present in the compound, more preferably from 1 to 10, and most preferably from 1 to 5. Also, in the case where the basic functional group is introduced to be localized at a specific position in the compound, the number of basic functional groups is preferably from 2 to 20, more preferably from 3 to 20, and most preferably from 4 to 15. The molecular weight of the component (A) is preferably from 1,000 to 100,000, more preferably from 2,000 to 50,000, or from 3,000 to 30,000.

The synthesis method of the “compound having at least one structure selected from a fluorine-containing hydrocarbon structure and a polysiloxane structure and at least one basic functional group” as the component (A) is not particularly limited, but a first preferred synthesis method for synthesizing the component (A) is a synthesis method of reacting (i) a polymerizable basic monomer containing an unsaturated double bond and (ii) a polymerizable compound having a fluorine-containing hydrocarbon structure or a polysiloxane structure and containing an unsaturated double bond.

A second preferred synthesis method for synthesizing the component (A) is a synthesis method of grafting (iii) a prepolymer having an unsaturated double bond and containing a polymerization unit derived from the basic monomer (i) to the (ii) polymerizable compound having a fluorine-containing hydrocarbon structure or a polysiloxane structure and containing an unsaturated double bond.

A third preferred synthesis method for synthesizing the component (A) is a synthesis method of grafting (iv) a prepolymer having a fluorine-containing hydrocarbon structure or a polysiloxane structure and having a carboxyl group at the terminal to (v) a basic compound through (vi) a polyfunctional epoxy compound.

The component (A) obtained by the second or third synthesis method is particularly preferred, because a plurality of basic functional groups can be introduced in a localized manner into the molecule and not only the adsorbability of the component (A) to the inorganic fine particle can be enhanced but also harmful effects such as crosslinking and aggregation of the inorganic fine particle due to the plurality of basic functional groups can be reduced.

### <Basic Monomer, Prepolymer>

The components (i), (iii), (v) and (vi) used in the preferred synthesis methods above are described.

### (i) Polymerizable Basic Monomer Containing an Unsaturated Double Bond

As the polymerizable basic compound containing an unsaturated double bond, which is usable for the first preferred synthesis method of the component (A) in the present invention, the following monomers may be preferably used.

Amino (meth)acrylates:

such as dimethylaminoethyl acrylate, diethylaminoethyl acrylate, dibutylaminoethyl acrylate, dimethylaminoethyl methacrylate, diethylaminoethyl methacrylate, dibutylaminoethyl methacrylate, dimethylaminopropyl acrylate, diethylaminopropyl acrylate, dimethylaminopropyl methacrylate, tert-butylaminoethyl acrylate, tert-butylaminoethyl methacrylate, aminoethyl acrylate, aminoethyl methacrylate, aminopropyl acrylate and aminopropyl acrylate.

### (Meth)acrylamides:

such as N,N-dimethylacrylamide, N,N-diethylacrylamide, N,N-dibutylacrylamide, N,N-dimethylmethacrylamide, N,N-diethylmethacrylamide, N,N-dibutylmethacrylamide, acryloylmorpholine, N-tert-butylacrylamide, N-tert-butylmethacrylamide, **N-hydroxyethylacrylamide, N-(dimethylaminoethyl)acrylamide, N-(diethylaminoethyl)acrylamide, N-(dibutylaminoethyl)acrylamide, N-(dimethylaminoethyl)methacrylamide, N-(diethylaminoethyl)methacrylamide, N-(dibutylaminoethyl)methacrylamide, N-(dimethylaminopropyl)acrylamide, N-(diethylaminopropyl)acrylamide, N-(dimethylaminopropyl)methacrylamide, tert-butylaminoethylacrylamide and tert-butylaminoethylmethacrylamide.

One of these monomers may be used alone, or two or more kinds of monomers may be used in combination.

Among these, a monomer containing a dialkylamino group or a dialkylamide group is preferred.

(iii) Prepolymer Having an Unsaturated Double Bond and being Composed of a Polymer Component Derived from a Basic Monomer

In the present invention, a basic group can be introduced in a localized manner into the component (A) of the present invention by using a prepolymer containing an unsaturated double bond and being composed of a polymer component derived from a basic monomer. The prepolymer is preferably obtained by bonding a part of polyfunctional basic functional groups in the polymer derived from a basic monomer to an epoxy group of a compound containing an epoxy group and an unsaturated double bonding group. Examples of the compound containing an epoxy group and an unsaturated double bonding group include glycidyl acrylate, glycidyl methacrylate and 4-hydroxybutyl acrylate glycidyl ether.

As the basic monomer, the (i) polymerizable basic compound containing an unsaturated double bond is preferably used. This basic monomer may be used by mixing a plurality of kinds of basic monomers or may also be copolymerized with other monomers in the range not impairing the effects of the present invention.

The number of basic functional groups in the polymer derived from the basic monomer is preferably from 2 to 21, more preferably from 4 to 21. The compound containing an epoxy group and an unsaturated double bonding group is preferably added to and reacted with the basic polymer in the range of the epoxy group being from 0.1 to 0.5 equivalents to the basic functional group in the polymer. Under such a condition, the unsaturated double bond can be prevented from excessive introduction in the obtained prepolymer. The number of unsaturated double bonds per molecule of the prepolymer (iii) for use in the present invention is preferably 1.

### (v) Basic Compound

The basic compound (v) is bonded to the (iv) prepolymer having a (terminal) carboxyl group through a polyfunctional epoxy compound, whereby the component (A) of the present invention can be formed. The basic compound usable in this synthesis method is preferably a primary or secondary alkylamine, and this compound has high reactivity with an epoxy group and therefore, can fix a basic amine in a high yield. Examples of the basic compound include:

alkylamine:

such as ethylamine, propylamine, butylamine, isobutylamine, hexylamine, diethylamine, dipropylamine, dibutylamine, dimethylaminoethylamine, diethylaminoethylamine, dimethylaminopropylamine, diethylaminopropylamine, 3-methoxypropylamine, diethylenetriamine and tetraethylenepentamine;

amino heterocyclic compound:

such as N-aminopiperidine, 1-amino-4-methylpiperazine, 2-amino-3-nitropyridine, 2-picolylamine, 3-picolylamine, 2-aminopyridine, 3-aminopyridine, 4-aminopyridine and 2-aminopyrazine; and

heterocyclic compound amine:

such as triazole, imidazole, morpholine, piperidine, pyrrolidine, 2-pipecoline, 3-pipecoline and 4-pipecoline.

One of these may be used alone, or two or more thereof may be used in combination.

### (vi) Polyfunctional Epoxy Compound

The polyfunctional epoxy compound usable in the third preferred embodiment of the present invention is not particularly limited as long as it is a compound having a plurality of epoxy groups per molecule, but the polyfunctional epoxy compound is preferably a (co)polymer of an unsaturated double bond group-containing monomer having a glycidyl group, or a bisphenol A-type, bisphenol F-type, phenol novolak-type or cresol novolak-type epoxy resin. The compound is preferably a compound having a molecular weight of 200 to 5,000, more preferably a molecular weight of 300 to 3,000. The epoxy equivalent is preferably from 150 to 500, more preferably from 150 to 300. The number of epoxy groups per molecule is preferably from 2 to 20, more preferably from 3 to 15. Within this range, it is easy to efficiently combine the fluorine-containing hydrocarbon structure or polysiloxane structure and the basic component of the present invention.

Examples of the commercially available epoxy resin which can be used include EOCN-120, EOCN-102, EOCN-103 and EOCN-104 produced by Nippon Kayaku Co., Ltd.; and Epoxy Resins 1001, 1002, 806, 807, 152, 154 and 157S70 produced by Mitsubishi Chemical Corporation.

### <Monomer or Prepolymer Having Fluorine-Containing Hydrocarbon Structure of Polysiloxane Structure>

The components (ii) and (iv) used in the above-described preferred synthesis methods are described below.

### (ii) Polymerizable Compound Having a Fluorine-Containing Hydrocarbon Structure or a Polysiloxane Structure and Containing an Unsaturated Double Bond

The compound (II) includes a fluorine-containing hydrocarbon-based monomer having an unsaturated double bond and a polysiloxane-based macromonomer having an unsaturated double bond.

Examples of the fluorine-containing vinyl monomer include fluoroolefins (e.g., fluoroethylene, vinylidene fluoride, tetrafluoroethylene, perfluorooctylethylene, hexafluoropropylene), partially or completely fluorinated alkyl ester derivatives of (meth)acrylic acid (e.g., VISCOAT 6FM (produced by Osaka Organic Chemical Industry Ltd.), M-2020 (produced by Daikin Industries, Ltd.)), and partially or completely fluorinated vinyl ethers. One of these fluorine-containing hydrocarbon components may be used alone, or a plurality of kinds may be mixed.

The macromonomer modified with a (meth)acryloyl group or the like at one terminal or both terminals of polydimethylsiloxane is not limited in its synthesis method, but, for example, SILAPLANE Series produced by Chisso Corporation and modified silicone oil produced by Shin-Etsu Chemical Co., Ltd. are available.

Examples of the macromonomer modified with a (meth)acryloyl group include SILAPLANE FM-0711, FM-0721, FM-0725, FM-7711, FM-7721, FM-7725, X-22-164, X-22-164AS, X-22-164A, X-22-164B, X-22-164C, X-22-164E, X-22-174DX, X-22-2426 and X-22-2475.

The molecular weight of the polysiloxane is preferably from 1,000 to 100,000, more preferably from 1,500 to 50,000.

### (iv) Prepolymer Having a Fluorine-Containing Hydrocarbon Structure or a Polysiloxane Structure and Having a (Terminal) Carboxyl Group

In the present invention, a basic group can be introduced into the component (A) of the present invention by using a prepolymer having a fluorine-containing hydrocarbon structure or a polysiloxane structure and having a (terminal) carboxyl group. This prepolymer can be synthesized by the following method.

At the polymerization of a monomer, the polymerization is started using a general-purpose azo-nitrile compound or peroxide compound as the polymerization initiator and a carboxyl group-containing compound such as mercaptoacetic acid is used as the chain transfer agent, whereby a prepolymer in which a carboxyl group is introduced into the terminal of the polymer formed can be synthesized.

Alternatively, the polymerization is started using a carboxyl group-containing initiator such as 4,4′-azobis(4-cyanopentanoic acid), whereby a prepolymer in which a carboxyl group is introduced into the terminal of the polymer formed can be synthesized.

Also, although this is not limited to the terminal, the method for introducing a carboxyl group into a polymer having a fluorine-containing hydrocarbon component or a polysiloxane component is a method where at the formation of a polymer, the monomer is polymerized together with a carboxyl group-containing monomer by using a general-purpose azo-nitrile compound or peroxide compound as the polymerization initiator. Examples of the carboxyl group-containing monomer include an acrylic acid, a methacrylic acid, a maleic acid and a fumaric acid.

Among these three synthesis methods for the prepolymer, a synthesis method of introducing a carboxyl group into the terminal is preferred, because a problem such as gelling is hardly caused in the subsequent synthesis of the component (A).

The molecular weight of the prepolymer synthesized by such a method is preferably from 1,000 to 100,000, more preferably from 2,000 to 50,000.

According to another synthesis method for the component (A) of the present invention, a polymer having a polysiloxane structure in the main chain can be synthesized using a polymer-type initiator such as azo group-containing polysiloxane amide (as the commercially available product, for example, VPS-0501 or 1001, produced by Wako Pure Chemical Industries, Ltd.) described in JP-A-6-93100. The (i) basic monomer containing an unsaturated double bond is polymerized alone or together with other copolymerizable monomers by using the initiator above, whereby a basic compound having a polysiloxane structure can be synthesized.

According to still another synthesis method for the component (A) of the present invention, a compound having a fluorine-containing hydrocarbon component or a polysiloxane component and having an isocyanate group is synthesized and the isocyanate group of the compound is hydrolyzed, whereby a primary amino group can be introduced. The method for introducing an isocyanate group is not limited, but the compound can be synthesized by copolymerizing an isocyanate compound having an unsaturated double bond together with a fluorine-containing hydrocarbon component or polysiloxane component having an unsaturated double bond.

### <Fluorine-Containing Polymer Having Basic Functional Group>

In view of ease in the synthesis and compatibility with a low refractive index curable material used in combination, the compound having a basic functional group in the molecule, which is the component (A) for use in the present invention, is preferably a fluorine-containing polymer having a structure represented by the following formula (1):

(MF1)a-(MF2)b-(MF3)c-(MA)d-(MB)e-(MD)g

In formula (1), each of a to e and g indicates the molar fraction of each constituent unit and represents a value satisfying the relationships of 0≦a≦70, 0≦b≦70, 30≦a+b≦70, 0≦c≦50, 0≦d≦50, 0≦e≦50, and 0.1 g<30.

(MF1) indicates a constituent unit polymerized from a monomer represented by CF₂═CF—Rf₁, wherein Rf₁ represents a perfluoroalkyl group having a carbon number of 1 to 5.

(MF2) indicates a constituent unit polymerized from a monomer represented by CF₂═CF—ORf₁₂, wherein Rf₁₂ represents a fluorine-containing alkyl group having a carbon number of 1 to 30.

(MF3) indicates a constituent unit polymerized from a monomer represented by CH₂═CH—ORf₁₃, wherein Rf₁₃ represents a fluorine-containing alkyl group having a carbon number of 1 to 30.

(MA) represents a constituent unit having at least one (at least one or more) crosslinking groups.

(MB) represents an arbitrary constituent unit.

(MD) represents a constituent unit having at least one (at least one or more) basic groups.

The constituent unit of (MD) is preferably a constituent unit polymerized from the (i) polymerizable monomer having a basic functional group described above in the preferred synthesis methods.

Respective monomers (compounds represented by the following formulae (1-1) to (1-3)) in (MF1) to (MF3) are described below.

CF₂═CF—Rf₁ Formula (1-1)

In the formula, Rf₁ represents a perfluoroalkyl group having a carbon number of 1 to 5.

The compound of formula (I-1) is preferably perfluoropropylene or perfluorobutylene in view of polymerization reactivity and more preferably perfluoropropylene in view of availability.

CF₂═CF—ORf₁₂ Formula (1-2)

In the formula, Rf₁₂ represents a fluorine-containing alkyl group having a carbon number of 1 to 30. The fluorine-containing alkyl group may have a substituent. Rf₁₂ is preferably a fluorine-containing alkyl group having a carbon number of 1 to 20, more a carbon number of 1 to 10, still more preferably a perfluoroalkyl group having a carbon number of 1 to 10. Specific examples of Rf₁₂ include, but are not limited to, the followings.

—CF₃, —CF₂CF₃, —CF₂CF₂CF₃, and —CF₂CF(OCF₂CF₂CF₃)CF₃

CH₂═CH—ORf₁₃ Formula (1-3)

In the formula, Rf₁₃ represents a fluorine-containing alkyl group having a carbon number of 1 to 30. The fluorine-containing alkyl group may have a substituent. Rf₁₃ may be linear or may have a branched structure. Also, Rf₁₃ may have an alicyclic structure (preferably a 5-membered ring or a 6-membered ring). Furthermore, Rf₁₃ may have an ether bond between carbon and carbon. Rf₁₃ is preferably a fluorine-containing alkyl group having a carbon number of 1 to 20, more preferably a carbon number of 1 to 15.

Specific examples of Rf₁₃ include, but are not limited to, the followings.

### (Linear)

—CF₂CF₃, —CH₂(CF₂)aH, and —CH₂CH₂(CF₂)aF (a: an integer of 2 to 12).

(Branched Structure)

—CH(CF₃)₂, —CH₂CF(CF₃)₂, —CH(CH₃)CF₂CF₃, and —CH(CH₃)(CF₂)₅CF₂H.

### (Alicyclic Structure)

For example, a perfluorocyclohexyl group, a perfluorocyclopentyl group, and an alkyl group substituted with such a group.

### (Others)

—CH₂OCH₂CF₂CF₃, —CH₂CH₂OCH₂(CF₂)bH, —CH₂CH₂OCH₂(CF₂)bF (b: an integer of 2 to 12), and —CH₂CH₂OCF₂CF₂OCF₂CF₂H.

In addition, as the monomer represented by formula (I-3), those described, for example, in paragraphs [0025] to [0033] of JP-A-2007-298974 may be also used.

From the standpoint of enhancing the strength of the coating film, the fluorine-containing polymer as the component (A) of the present invention preferably contains, in the polymer molecule, a repeating unit having a crosslinking moiety, and the crosslinking moiety is preferably at least any one of a hydroxyl group- or hydrolyzable group-containing silyl group, a reactive unsaturated double bond-containing group, a ring-opening polymerization reactive group, an active hydrogen atom-containing group, a group capable of being substituted with a nucleophilic agent, and an acid anhydride.

In formula (1), (MA) represents a constituent unit containing at least one crosslinking moieties (a reactive moiety capable of participating in the crosslinking reaction).

Examples of the crosslinking moiety include a hydroxyl group- or hydrolyzable group-containing silyl group (such as alkoxysilyl group and acyloxysilyl group), a reactive unsaturated double bond-containing group (such as (meth)acryloyl group, allyl group and vinyloxy group), a ring-opening polymerization reactive group (such as epoxy group, oxetanyl group and oxazolyl group), an active hydrogen atom-containing group (such as hydroxyl group, carboxyl group, amino group, carbamoyl group, mercapto group, O-ketoester group, hydrosilyl group and silanol group), an acid anhydride, and a group capable of being substituted with a nucleophilic agent (such as active halogen atom and sulfonic acid ester).

The crosslinking group in (MA) is preferably a reactive unsaturated double bond-containing group or a ring-opening polymerization reactive group, more preferably a reactive unsaturated double bond-containing group.

Specific preferred examples of the constituent unit represented by (MA) in formula (1) are illustrated below, but the present invention is not limited thereto.

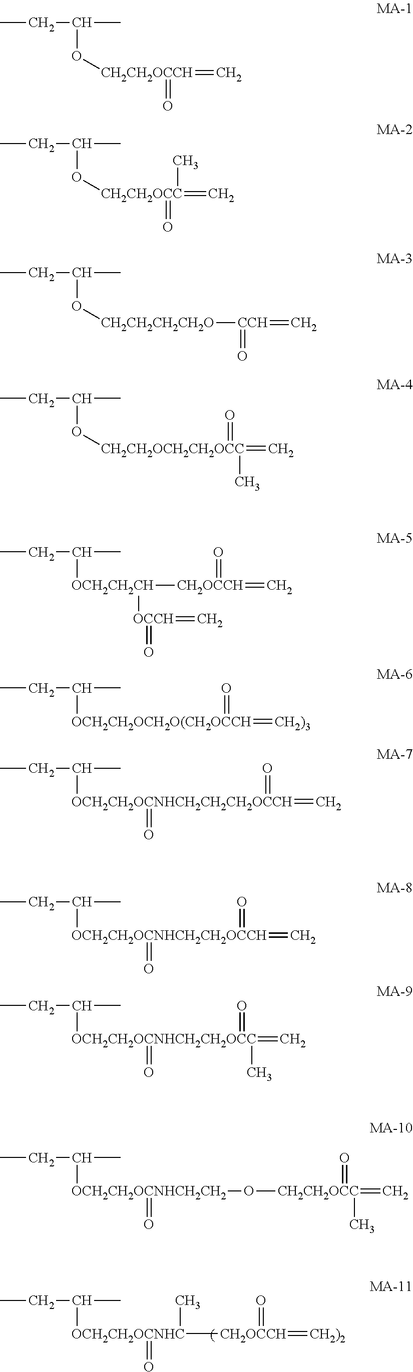

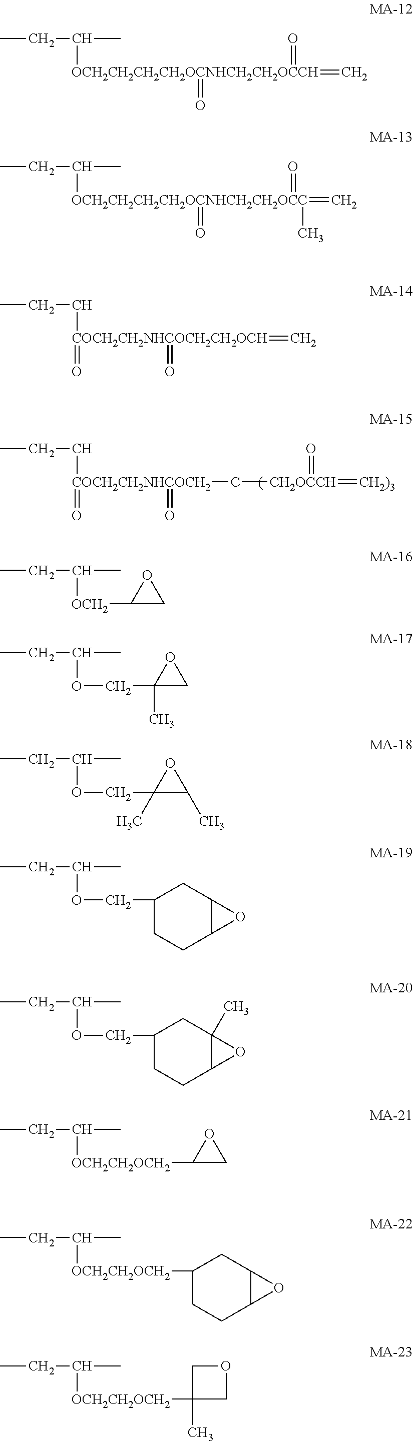

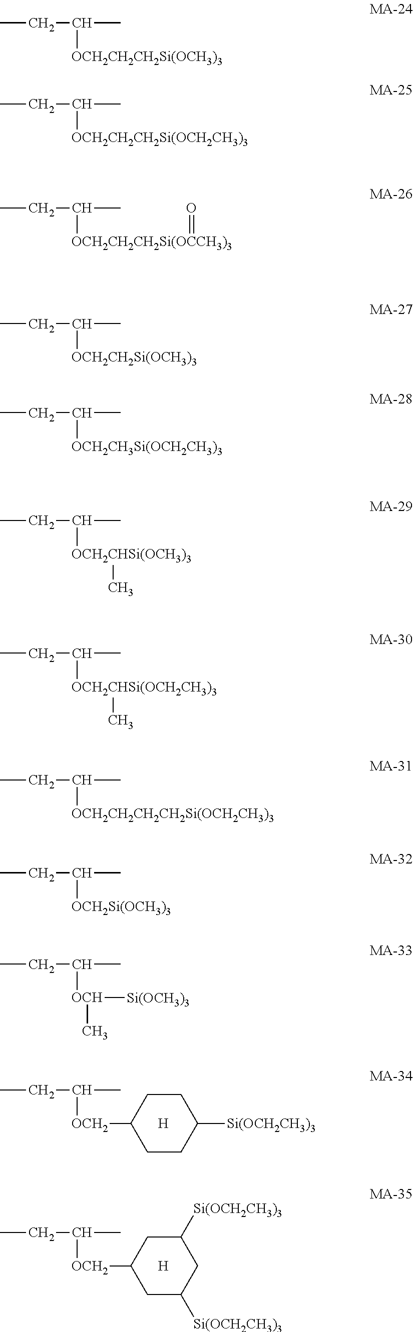

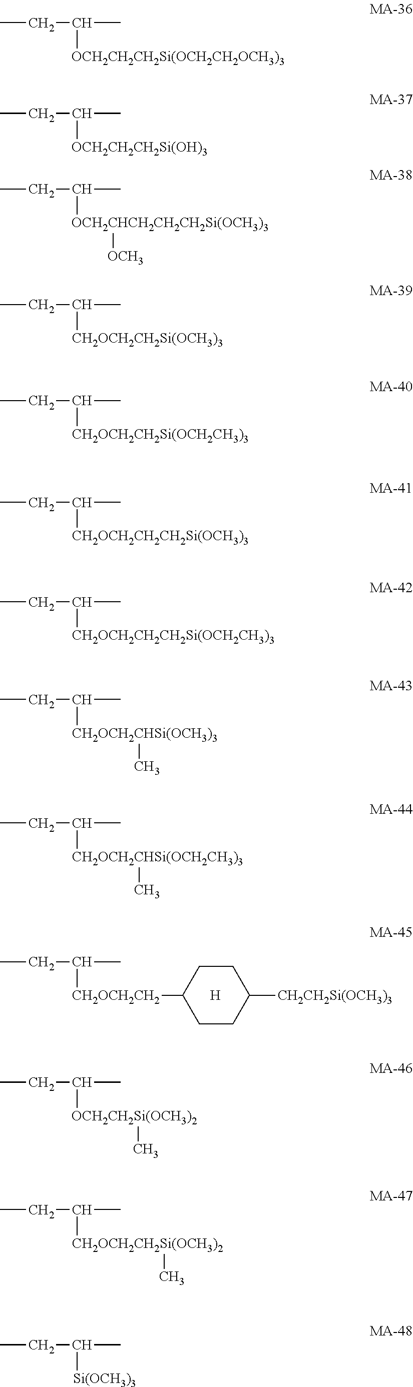

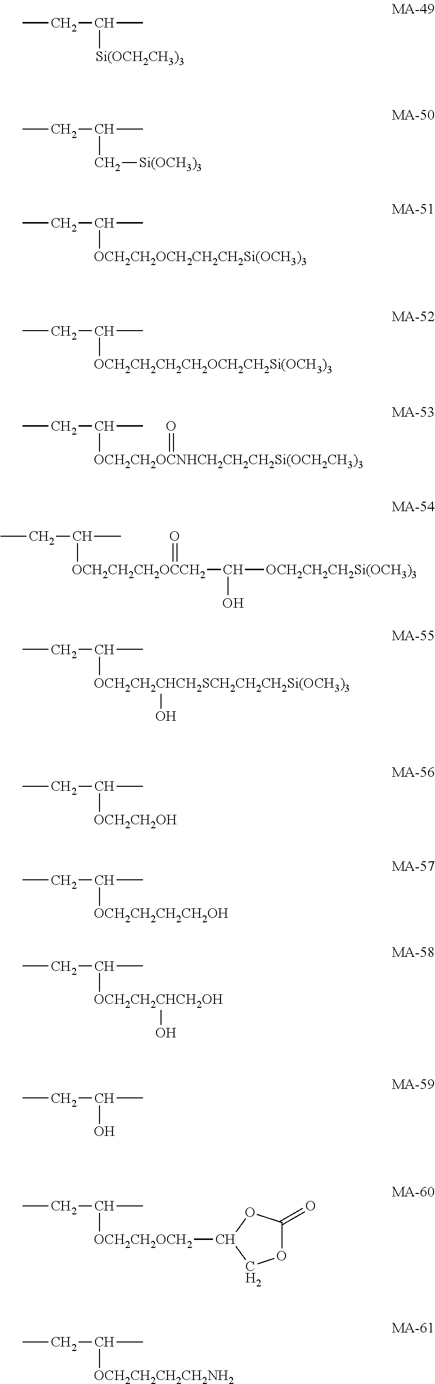

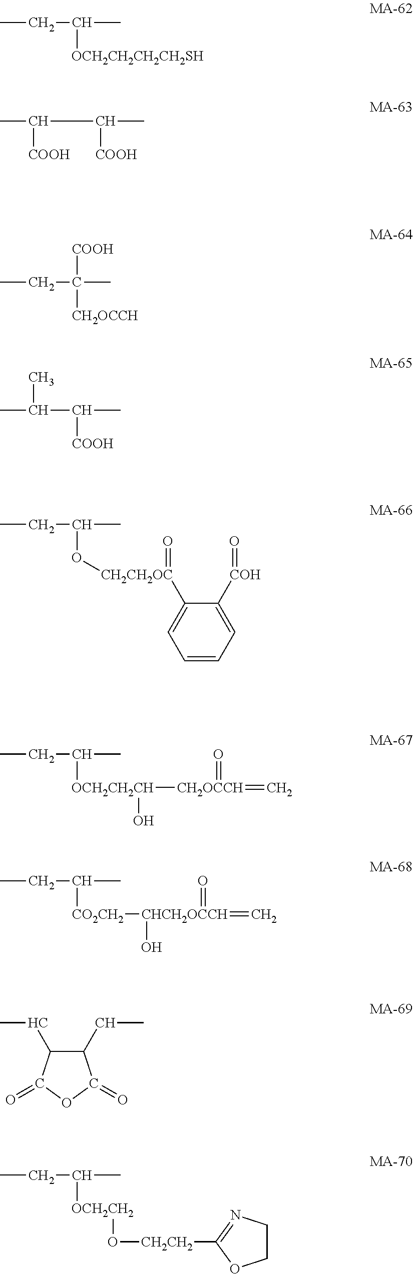

In formula (1), (MB) represents an arbitrary constituent unit. (MB) is not particularly limited as long as it is a monomer constituent unit capable of forming a copolymer together with other constituent units, and this can be appropriately selected from the standpoint of solubility in a solvent, affinity for the inorganic fine particle, dispersion stability of the inorganic fine particle, and the like.

Examples of the monomer for forming (MB) include vinyl ethers such as methyl vinyl ether, ethyl vinyl ether, n-butyl vinyl ether, cyclohexyl vinyl ether and isopropyl vinyl ether, and vinyl esters such as vinyl acetate, vinyl propionate, vinyl butyrate and vinyl cyclohexanecarboxylate.

Also, (MB) preferably contains a constituent unit having a polysiloxane structure. By containing a polysiloxane structure as (MB), the uneven upward distribution of the inorganic fine particle can be enhanced and furthermore, trace inorganic fine particles remaining in the lower layer, giving rise to a surface failure, can be reduced.

More specifically, (MB) preferably contains a polysiloxane repeating unit represented by the following formula (2) in the main chain or the side chain.

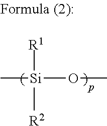

In the formula, each of R¹ and R² independently represents an alkyl group or an aryl group.

The alkyl group is preferably an alkyl group having a carbon number of 1 to 4 and may have a substituent. Specific examples of the alkyl group include a methyl group, a trifluoromethyl group and an ethyl group.

The aryl group is preferably an aryl group having a carbon number of 6 to 20 and may have a substituent. Specific examples of the aryl group include a phenyl group and a naphthyl group.

Each of R¹ and R² is preferably a methyl group or a phenyl group, more preferably a methyl group.

p represents an integer of 2 to 500 and is preferably an integer of 5 to 350, more preferably from 8 to 250.

The polymer having a polysiloxane structure represented by formula (2) in the side chain can be synthesized by a method of introducing a polysiloxane (such as SILAPLANE Series, produced by Chisso Corp.) having a corresponding reactive group (for example, an epoxy group, an amino group for acid anhydride group, a mercapto group, a carboxyl group or a hydroxyl group) at one terminal into a polymer having a reactive group such as epoxy group, hydroxyl group, carboxyl group and acid anhydride group through a polymer reaction described, for example, in J. Appl. Polym. Sci., 2000, 78, 1955 and JP-A-56-28219; or a method of polymerizing a polysiloxane-containing silicon macromer.

Examples of the method for producing the polymer having a polysiloxane structure in the main chain include a method using a polymer-type initiator such as azo group-containing polysiloxane amide (as the commercially available product, for example, VPS-0501 or 1001, produced by Wako Pure Chemical Industries, Ltd.) described in JP-A-6-93100; a method of introducing a reactive group (for example, a mercapto group, a carboxyl group or a hydroxyl group) derived from a polymerization initiator or a chain transfer agent into the polymer terminal and then reacting it with a polysiloxane containing a reactive group (for example, an epoxy group or an isocyanate group) at one terminal or both terminals; and a method of copolymerizing a cyclic siloxane oligomer such as hexamethylcyclotrisiloxane by the anion ring-opening polymerization. Above all, a method utilizing an initiator having a polysiloxane partial structure is easy and preferred.

In formula (1), each of a to e and g indicates the molar fraction of each constituent unit and represents a value satisfying the relationships of 0≦a≦70, 0≦b≦70, 30≦a+b≦70, 0≦c≦50, 0≦d≦50, 0≦e≦50, and 0.1≦g≦30.

By increasing the molar fraction (%) a+b of the component (MF1) and the component (MF2), the surface free energy of the polymer is reduced and uneven upward distribution of the inorganic fine particle is facilitated, but in view of adsorbability to the inorganic fine particle, solubility in a general-purpose solvent, and the like, the molar fraction is preferably not excessively high and is preferably 30≦a+b≦70.

Introduction of (MF3) also contributes to the uneven upward distribution performance of the inorganic fine particle. As described above, the molar fraction c of the component (MF3) is 0≦c≦50, preferably 5≦c≦20.

The sum of molar fractions a to c of the fluorine-containing monomer components is preferably 40≦a+b+c≦90, more preferably 40≦a+b+c≦75.

The molar fraction of the constituent unit having at least one basic groups, represented by (MD), is preferably 0.1≦g≦30, more preferably 0.1≦g≦20, and most preferably 0.2≦g≦10, because the interaction of the polymer with the inorganic fine particle as the component (B) is sufficient and at the same time, the amount of the fluorine-containing component necessary for the uneven upward distribution of the inorganic fine particle as the component (B) can be ensured.

The crosslinking group-containing constituent unit represented by (MA) is preferably introduced into the polymer in view of increase in the hardness of the coating film. Particularly in the present invention, the molar fraction of the component (MA) is preferably 1≦d≦50, more preferably 5≦d≦40, still more preferably 5≦d≦30.

The molar fraction e of the arbitrary constituent unit represented by (MB) is preferably 0≦e≦50, more preferably 0≦e≦20, still more preferably 0≦e≦10.

In the present invention, in view of affinity for the inorganic fine particle, the fluorine-containing polymer preferably has a high-polarity functional group in the molecule. Accordingly, (MB) preferably has a high-polarity functional group in the molecule. The high-polarity functional group is preferably an alkyl ether group, a silanol group, a glycidyl group, an oxetanyl group, a polyalkylene oxide group or a carboxyl group, more preferably an alkyl ether group or a polyalkylene oxide group.

The molar fraction of the polymerization unit having such a functional group is preferably from 0.1 to 15%, more preferably from 1 to 10%.

As described above, a polysiloxane structure is preferably introduced into the fluorine-containing polymer in view of uneven upward distribution of the fine particle and improvement in the coating film surface. The content of the polysiloxane structure in the fluorine-containing polymer is, in terms of molar ratio to all polymers, preferably from 0.5 to mass %, more preferably from 1 to 10 mass %.

The mass average molecular weight of the fluorine-containing polymer is preferably from 1,000 to 100,000, more preferably from 2,000 to 50,000, still more preferably from 3,000 to 30,000.

Here, the mass average molecular weight is a molecular weight measured by the differential refractometer detection in a GPC analyzer using columns of TSKgel GMHxL, TSKgel G4000HxL and TSKgel G2000HxL (all trade names, produced by Tosoh Corp.) and a solvent of THF and expressed in terms of polystyrene.

### <Fluorine-Containing Block or Graft Polymer Having Basic Functional Group>

Among the components (A), from the standpoint that the position of the basic functional polymer in the polymer is easily controlled and not only the interaction with the inorganic particle as the component (B) can be intensified but also harmful effects such as crosslinking and aggregation of particles of the component (B) can be reduced, the fluorine-containing polymer is preferably a block or graft polymer having a structure represented by the following formula (10):

[(MF1)a-(MF2)b-(MF3)c-(MA)d-(MB)e]j-[(ME)]k Formula (10)

In formula (10), each bracket [ ] indicates a prepolymer composed of the constituent units of parentheses ( ) or a structure capable of linking, and each of j and k indicates the mass proportion (wt %) thereof and are 70≦j≦99.8 and 0.2≦k≦30. Each of a to e indicates the molar fraction of each constituent unit in the prepolymer and represents a value satisfying the relationships of a+b+c+d+e=100, 0≦a≦70, 0≦b≦70, 30≦a+b≦70, 0≦c≦50, 0≦d≦50, and 0≦e≦50.

(MF1) indicates a constituent unit polymerized from a monomer represented by CF₂═CF—Rf₁, wherein Rf₁ represents a perfluoroalkyl group having a carbon number of 1 to 5.

(MF2) indicates a constituent unit polymerized from a monomer represented by CF₂═CF—ORf₁₂, wherein Rf₁₂ represents a fluorine-containing alkyl group having a carbon number of 1 to 30.

(MF3) indicates a constituent unit polymerized from a monomer represented by CH₂═CH—ORf₁₃, wherein Rf₁₃ represents a fluorine-containing alkyl group having a carbon number of 1 to 30.

(MA) represents a constituent unit having at least one (at least one or more) crosslinking groups.

(MB) represents an arbitrary constituent unit.

(ME) represents a constituent unit having at least two (at least two or more) basic groups.

In formula (10), (MF1), (MF2), (MF3), (MA) and (MB) are the same as those described in formula (1).

The constituent unit of (ME) is preferably a constituent unit having two or more basic functional groups and being capable of bonding to the polymer, which is described above in the preferred synthesis methods 2 and 3. Specifically, the constituent unit is preferably a constituent formed of (iii) a prepolymer having an unsaturated double bond and comprising a polymer component derived from a basic monomer, or a constituent unit formed of a reaction product of (v) a basic compound and a polyfunctional epoxy compound.

Specific examples of the fluorine-containing copolymer represented by formula (1), which is the component (A) for use in the present invention, are illustrated below, but the present invention is not limited thereto. In Table 1, the copolymer is shown by the combination of the monomers ((MF1), (MF2), (MF3), (MB) and (MD)) forming the fluorine-containing constituent components of formula (1) by being polymerized, and the constituent unit (MA). In the Table, each of a to g represents the molar percentage (%) of the monomer for each component. In the Table, when wt % is shown for the component (MB), this indicates mass % of the component in the entire polymer. In the Table, with respect to the components except for EVE in the column of “(MB)”, the contents (mass %: wt %) of the components in the entire polymer are shown in order from the left following the molar percentage of EVE in the column “e”. Incidentally, in the description of the present invention, unless otherwise indicated, the molecular weight of a polymer means the mass average molecular weight.

TABLE 1

| | | | | | | | | | | | | | Mass Average |
|---|---|---|---|---|---|---|---|---|---|---|---|---|---|
| | | | | | | | | | | | | | Molecular Weight |
| | (MF1) | (MF2) | (MF3) | (MA) | (MB) | (MD) | a | b | c | d | e | g | (ten thousand) |
| EPF-1 | HFP | — | — | — | EVE | DMAEA | 50 | — | — | — | 49 | 1 | 2.2 |
| EPF-2 | HFP | — | — | (MA-8) | EVE | DMAEA | 50 | — | — | 29 | 20 | 1 | 2.3 |
| EPF-3 | HFP | — | — | (MA-8) | EVE/VPS-1001 | DMAEA | 50 | — | — | 29 | 20/2 wt % | 1 | 2.5 |
| EPF-4 | HFP | FPVE | | (MA-8) | EVE/VPS-1001 | DMAEA | 45 | 5 | — | 29 | 20/2 wt % | 1 | 2.5 |
| EPF-5 | HFP | FPVE | MF3-1 | (MA-8) | EVE | DMAEA | 45 | 5 | 5 | 29 | 15 | 1 | 2.2 |
| EPF-6 | HFP | — | — | (MA-8) | EVE/FM-0721 | DMAEA | 50 | — | — | 29 | 20/2 wt % | 1 | 2.3 |
| EPF-7 | HFP | — | — | — | EVE | DMAPAA | 50 | — | — | — | 49 | 1 | 2.5 |
| EPF-8 | HFP | — | — | (MA-8) | EVE | DMAPAA | 50 | — | — | 29 | 20 | 1 | 2.4 |
| EPF-9 | HFP | — | — | (MA-8) | EVE/VPS-1001 | DMAPAA | 50 | — | — | 29 | 20/2 wt % | 1 | 2.4 |
| EPF-10 | HFP | FPVE | — | (MA-8) | EVE/VPS-1001 | DEAA | 45 | 5 | — | 29 | 20 | 1 | 2.2 |
| EPF-11 | HFP | — | — | — | EVE/VPS-0501 | AOI′ *1) | 50 | — | — | — | 49/2 wt % | 1 | 2.2 |
| EPF-12 | HFP | — | — | (MA-8) | EVE/VPS-0501 | HEVE/IPDI′ *2 | 50 | — | — | 29 | 20/2 wt % | 1 | 2.4 |
| EPF-13 | HFP | — | — | (MA-8) | EVE | DMAEA | 50 | — | — | 29 | 16 | 5 | 2.3 |

Abbreviations in the Table above indicate the followings.
Component (MF1):
HFP: Hexafluoropropylene
Component (MF2):
FPVE: Perfluoropropyl vinyl ether
Component (MF3):
MF3-1: CH₂═CH—O—CH₂CH₂—O—CH₂(CF₂)₄H
Component (MB):
EVE: Ethyl vinyl ether
VPS-0501: Azo group-containing polydimethylsiloxane, molecular weight of polysiloxane moiety: about 5,000, produced by Wako Pure Chemical Industries, Ltd.
VPS-1001: Azo group-containing polydimethylsiloxane, molecular weight of polysiloxane moiety: about 10,000, produced by Wako Pure Chemical Industries, Ltd.
FM-0721: Dimethylsiloxane modified with methacryloyl at one terminal, average molecular weight: 5,000, produced by Chisso Corporation.
Component (MD)
DMAEA: Dimethylaminoethyl acrylate, produced by Kohjin Co., Ltd.
DMAPAA: N-(Dimethylaminopropyl)acrylamide, produced by Kohjin Co., Ltd.
DEAA: N—N-Diethylacrylamide, produced by Kohjin Co., Ltd.
*1) AOI′: A constituent component in which the acryloyl of 2-acryloyloxyethyl isocyanate is polymerized to the main chain, obtained by hydrolyzing the isocyanate group.
*2 HEVE/IPDI′: A constituent component in which the vinyl group of hydroxyethyl vinyl ether is polymerized to the main chain, obtained by reacting one isocyanate group of isophorone diisocyanate with a hydroxyl group and hydrolyzing the remaining one isocyanate group.

Specific examples of the fluorine-containing block or graft copolymer represented by formula (10), which is the component (A) for use in the present invention, are illustrated below, but the present invention is not limited thereto. In Table 2, the copolymer is shown by the combination of the monomers ((MF1), (MF2), (MF3), (MB)) forming the fluorine-containing constituent components of formula (10) by being polymerized, and the constituent components (MA) and (ME).

In the Table, the compositional ratio of the fluorine-containing polymer moiety indicates the molar ratio (%) of monomers for respective components of the fluorine-containing polymer, and when wt % is shown, this indicates mass % of the component in the fluorine-containing polymer moiety. In the Table, the equivalent ratio in composition of the basic moiety (MD) indicates the equivalent ratio between the basic functional group and the epoxy group.

Also, the composition (j/k ratio) of the fluorine-containing polymer moiety and the basic moiety in the entire copolymer indicates the mass ratio therebetween.

TABLE 2

| | Fluorine-Containing Polymer Moiety | | Basic Moiety (ME) | | | |
|---|---|---|---|---|---|---|
| | | Composition | | Composition | | Molecular |
| | | (molar | | (equivalent | j/k Composition | Weight |
| | Constituent Component | ratio) | Constituent Component | ratio) | (mass ratio) | (ten thousand |
| EPF-101 | HFP/MA-8/EVE/(VPS-0501) | 50/25/25/(3 wt %) | DMAEA/GMA | 90/10 | 95/5 | 2.9 |
| EPF-102 | HFP/MA-8/EVE/(VPS-0501) | 50/25/25/(3 wt %) | DMAA/GMA | 90/10 | 95/5 | 2.3 |
| EPF-103 | HFP/MA-8/EVE/(VPS-0501) | 50/25/25/(3 wt %) | DMAPAA/GMA | 90/10 | 95/5 | 3.4 |
| EPF-104 | HFP/MA-8/EVE | 50/25/25 | DMAEA/GMA | 90/10 | 95/5 | 2.9 |
| EPF-105 | HFP/MA-8/EVE | 50/25/25 | DMAA/GMA | 90/10 | 95/5 | 2.3 |
| EPF-106 | HFP/MA-8/EVE | 50/25/25 | DMAPAA/GMA | 90/10 | 95/5 | 3.4 |
| EPF-107 | HFP/MA-8/EVE/(VPS-0501) | 50/25/25/(3 wt %) | DMAEA/4HBAGE | 90/10 | 95/5 | 3.0 |
| EPF-108 | HFP/MA-8/EVE/(VPS-0501) | 50/25/25/(3 wt %) | DMAA/4HBAGE | 90/10 | 95/5 | 2.4 |
| EPF-109 | HFP/MA-8/EVE/(VPS-0501) | 50/25/25/(3 wt %) | DMAPAA/4HBAGE | 90/10 | 95/5 | 3.2 |
| EPF-110 | HFP/MA-8/EVE + MAc | 50/25/25 | DEA/EOCN104S | 45/55 | 95/5 | 3.8 |
| EPF-111 | HFP/MA-8/EVE/(VPS-0501) + MAc | 50/25/25/(3 wt %) | DEA/EOCN104S | 45/55 | 95/5 | 3.8 |
| EPF-112 | HFP/MA-8/EVE/(VPS-0501) + MAc | 50/25/25/(3 wt %) | DBA/EOCN104S | 40/60 | 92/8 | 2.8 |
| EPF-113 | HFP/MA-8/EVE/(FM-0721) + MAc | 50/25/25/(3 wt %) | DBA/EOCN104S | 40/60 | 95/5 | 4.5 |
| EPF-114 | HFP/MA-8/EVE/(FM-0721) + ABCPA | 50/25/25/(3 wt %) | DEA/(GMA/MMA = 1/1) | 40/60 | 95/5 | 2.7 |

Abbreviations in the Table above indicate the followings.
Fluorine-Containing Polymer Moiety:
+MAc: A polymer where a carboxyl group is introduced into the polymer terminal by using a mercaptoacetic acid as the chain transfer agent.
+ABCPA: A polymer where a carboxyl group is introduced into the polymer terminal by using 4,4′-azobis(4-cyanopentanoic acid) as the polymerization initiator.
Basic Moiety (ME):
DMAEA/GMA: A methacrylate prepolymer (mass average molecular weight: 1,400) by the reaction between an amino group of a dimethylaminoethyl acrylate polymer and a glycidyl group of glycidyl methacrylate (a mixture in an equivalent ratio of 90/10).
DMAA/GMA: A methacrylate prepolymer (mass average molecular weight: 1,100) by the reaction between an amido group of a dimethylacrylamide polymer and a glycidyl group of glycidyl methacrylate (a mixture in an equivalent ratio of 90/10).
DMAPAA/GMA: A methacrylate prepolymer (mass average molecular weight: 1,700) by the reaction between an amino group of a N-(dimethylaminopropyl)acrylamide polymer and a glycidyl group of glycidyl methacrylate (a mixture in an equivalent ratio of 90/10).
DMAEA/4HBAGE: A methacrylate prepolymer (mass average molecular weight: 1,500) by the reaction between an amino group of a dimethylaminoethyl acrylate polymer and a glycidyl group of 4-hydroxybutyl acrylate glycidyl ether (a mixture in an equivalent ratio of 90/10).
DMAA/4HBAGE: A methacrylate prepolymer (mass average molecular weight: 1,200) by the reaction between an amido group of a dimethylacrylamide polymer and a glycidyl group of 4-hydroxybutyl acrylate glycidyl ether (a mixture in an equivalent ratio of 90/10).
DMAPAA/4HBAGE: A methacrylate prepolymer (mass average molecular weight: 1,600) by the reaction between an amino group of an N-(dimethylaminopropyl)acrylamide polymer and a glycidyl group of 4-hydroxybutyl acrylate glycidyl ether (a mixture in an equivalent ratio of 90/10).
DEA/EOCN104S: A 45/55 (equivalent ratio) reaction product of diethylamine and EOCN-104S (a 7.5-functional (average) phenol novolak-type epoxy resin, epoxy equivalent: about 220)) (molecular weight: about 1,800).
DBA/EOCN104S: A 40/60 (equivalent ratio) reaction product of dibutylamine and EOCN-104S (a 7.5-functional (average) phenol novolak-type epoxy resin, epoxy equivalent: about 220)) (molecular weight: about 1,300).
DEA/(GMA/MMA = 1/1): A reaction product of a glycidyl group of a 1:1 copolymer (weight average molecular weight: about 1,000) of glycidyl methacrylate and methyl methacrylate, with diethylamine (weight average molecular weight: about 1,300), the equivalent ratio of amine and glycidyl group is 40/60.

The resin having a polysiloxane component in the molecule, which is the component (A) for use in the present invention, is preferably a polysiloxane copolymer having the following structure.

### [Polysiloxane Copolymer]

The polysiloxane copolymer preferably has a structure represented by the following formula (2):

(polysiloxane unit)α(MA)β-(MB)γ-(MD)ε Formula (2)

In formula (2), each of α to γ and ε indicates the mass proportion of each constituent component and is preferably a value satisfying the relationships of 2≦α≦99, 0≦β≦70, 0≦γ≦70, and 0.1≦ε≦30.

(Polysiloxane unit) represents a polysiloxane component copolymerizable with other components.

(MA) represents a constituent unit having at least one (at least one or more) crosslinking groups.

(MB) represents an arbitrary constituent unit.

(MD) represents a constituent unit having at least one (at least one or more) basic functional groups.

From the standpoint of enhancing the uneven upward distribution of the polysiloxane copolymer as the component (A) and enhancing the uneven upward distribution of the inorganic fine particle as the component (B), the mass proportion a of the polysiloxane unit in the polysiloxane copolymer is preferably in a range of 2≦α≦99, more preferably 30≦α≦95, still more preferably 50≦α≦90.

From the standpoint of enhancing the scratch resistance and adhesion after curing, the mass proportion β of the constituent unit having at least one crosslinking group in the polysiloxane copolymer is preferably in a range of 0≦β≦70, more preferably 0≦β≦50, still more preferably 0≦β≦30.

In view of dissolution of the component (A) and the component (B) in a solvent, affinity for the inorganic fine particle, dispersion stability of the inorganic fine particle, or the like, the mass proportion γ of the arbitrary constituent unit in the polysiloxane copolymer is preferably in a range of 0≦γ≦70, more preferably 0≦γ≦50, still more preferably 0≦γ≦30.

In view of uneven upward distribution of the inorganic fine particle, the mass proportion c of the constituent unit having at least one basic functional group in the polysiloxane copolymer is preferably in a range of 0.1≦ε≦30, more preferably 0.1≦ε≦20, still more preferably 0.1≦ε≦610.

The (polysiloxane unit) can be introduced by using a macromonomer modified with a (meth)acryloyl group or the like at one terminal or both terminals of polydimethylsiloxane, or a polymerization initiator having a polysiloxane moiety.

As the polysiloxane macromonomer, for example, SILAPLANE Series produced by Chisso Corporation and modified silicone oil produced by Shin-Etsu Chemical Co., Ltd. can be used. Examples of the macromonomer modified with a (meth)acryloyl group include SILAPLANE FM-0711, FM-0721, FM-0725, FM-7711, FM-7721, FM-7725, X-22-164, X-22-164AS, X-22-164A, X-22-164B, X-22-164C, X-22-164E, X-22-174DX, X-22-2426 and X-22-2475.

As the polymerization initiator having a polysiloxane moiety, for example, an azo group-containing polysiloxane amide (for example, an azo group-containing polysiloxane amide described in JP-A-6-93100; as the commercially available product, for example, VPS-0501 or 1001, produced by Wako Pure Chemical Industries, Ltd.) can be used.

The crosslinking group of (MA) is preferably a reactive unsaturated double bond-containing group or a ring-opening polymerization reactive group, more preferably a reactive unsaturated double bond-containing group. Specific structures of (MA) are the same as those described with respect to the fluorine-containing polymer of formula (1).

(MB) is the same as that described with respect to the fluorine-containing polymer of formula (1).

(MD) is preferably a basic compound having an unsaturated double bond in the molecule, and this is the same as that described with respect to the fluorine-containing polymer of formula (1).

Specific examples of the basic compound having a polysiloxane component, which is the component (A) for use in the present invention, are illustrated below, but the present invention is not limited thereto. In Tables 2 and 3, the compound is shown by the combination of raw materials which are reacted to form the component (A).

TABLE 3

| | Polysiloxane | | | | Compositional | Molecular Weight |
|---|---|---|---|---|---|---|
| | Component | (MD) | (MA) | (MB) | Ratio (wt %) | (ten thousand) |
| EPS-1 | VPS-0501 | DMAEA | — | — | 95/5/—/— | 0.5 |
| EPS-2 | VPS-0501 | DMAEA | (MA-8) | — | 90/5/5/— | 0.6 |
| EPS-3 | VPS-0501 | DMAEA | (MA-8) | MMA | 85/5/5/5 | 0.6 |
| EPS-4 | VPS-0501 | DEAA | (MA-8) | MMA | 85/5/5/5 | 0.6 |
| EPS-5 | VPS-0501 | DMAPAA | (MA-8) | MMA | 85/5/5/5 | 0.6 |
| EPS-6 | VPS-1001 | DMAEA | — | — | 95/5/—/— | 1.1 |
| EPS-7 | VPS-1001 | DMAEA | (MA-8) | | 90/5/5/— | 1.1 |
| EPS-8 | VPS-1001 | DMAEA | (MA-8) | MMA | 85/5/5/5 | 1.2 |
| EPS-9 | FM-0721 | DMAEA | — | — | 95/5/—/— | 0.5 |
| EPS-10 | FM-0721 | DMAEA | (MA-8) | — | 90/5/5/— | 0.6 |
| EPS-11 | FM-0721 | DMAEA | (MA-8) | MMA | 85/5/5/5 | 0.6 |
| EPS-12 | FM-0721 | DMAPAA | — | — | 95/5/—/— | 0.5 |
| EPS-13 | FM-0721 | DMAPAA | (MA-8) | — | 90/5/5/— | 0.6 |
| EPS-14 | FM-0721 | DMAPAA | (MA-8) | MMA | 85/5/5/5 | 0.6 |
| EPS-15 | FM-0725 | DMAEA | — | — | 95/5/—/— | 1.1 |
| EPS-16 | FM-0725 | DMAEA | (MA-8) | | 90/5/5/— | 1.1 |
| EPS-17 | FM-0725 | DMAEA | (MA-8) | MMA | 85/5/5/5 | 1.2 |
| EPS-18 | FM-7721 | DMAEA | — | — | 95/5/—/— | 0.5 |
| EPS-19 | FM-7721 | DMAEA | (MA-8) | — | 90/5/5/— | 0.6 |
| EPS-20 | FM-7721 | DMAEA | (MA-8) | MMA | 85/5/5/5 | 0.6 |
| EPS-21 | FM-7725 | DMAEA | — | — | 95/5/—/— | 1.1 |
| EPS-22 | FM-7725 | DMAEA | (MA-8) | — | 90/5/5/— | 1.1 |
| EPS-23 | FM-7725 | DMAEA | (MA-8) | MMA | 85/5/5/5 | 1.2 |

Abbreviations in the Table above indicate the followings.
Polysiloxane Component:
FM-0721: Dimethylsiloxane modified with methacryloyl at one terminal, average molecular weight: 5,000, produced by Chisso Corporation.
FM-0725: Dimethylsiloxane modified with methacryloyl at one terminal, average molecular weight: 10,000, produced by Chisso Corporation.
FM-7721: Dimethylsiloxane modified with methacryloyl at both terminal, average molecular weight: 5,000, produced by Chisso Corporation.
FM-7725: Dimethylsiloxane modified with methacryloyl at both terminal, average molecular weight: 10,000, produced by Chisso Corporation.
VPS-0501: Azo group-containing polydimethylsiloxane, molecular weight of polysiloxane moiety: about 5,000, produced by Wako Pure Chemical Industries, Ltd.
VPS-1001: Azo group-containing polydimethylsiloxane, molecular weight of polysiloxane moiety: about 10,000, produced by Wako Pure Chemical Industries, Ltd.
Component (MD):
DMAEA: Dimethylaminoethyl acrylate, produced by Kohjin Co., Ltd.
DMAPAA: N-(Dimethylaminopropyl)acrylamide, produced by Kohjin Co., Ltd.
DEAA: N—N-Diethylacrylamide, produced by Kohjin Co., Ltd.
Component (MB):
MMA: Methyl methacrylate

In the present invention, a commercially available amino-modified polysiloxane compound may be used. Examples thereof include SILAPLANE Series produced by Chisso Corporation, and the compound modified with an amino group include a both-terminal modification type (e.g., FM-3311, FM-3321, FM-3325). Also, as the modified silicon oil produced by Shin-Etsu Chemical Co., Ltd., the silicon oil modified with an amino group includes a single-terminal modification type (e.g., KF-864, KF-865, KF-868), a diamine type (KF-859, KF-8004), an amino polyether type (X-22-3939A), a both-terminal amino modification type (X-22-161A, X-22-161B, KF-8012), and a side chain modification (KF-857, KF-9001, KF-862, X-22-9192).

### <Preparation Method of Coating Composition>

At the preparation of the coating composition of the present invention, the components each dissolved or dispersed in a solvent may be mixed, and a basic functional group-containing compound as the component (A) and an inorganic fine particle as the component (B) are preferably mixed in advance together with a solvent as the component (D) and then mixed with a binder as the component (C). Particularly, in the case where the component (C) has an acidic functional group (such as carboxyl group, hydroxyl group and mercapto group) capable of interacting with a basic functional group, the method above is preferably employed so as to prevent an unintended side reaction. In the case where the inorganic fine particle is an acidic metal oxide particle, a hydroxyl group exposed to the surface of the acidic metal oxide can interact with a basic functional group of the component (A).

### <Component (B): Inorganic Fine Particle>

The inorganic fine particle as the component (B) for use in the present invention is preferably an inorganic fine particle having an average particle diameter of 1 to 150 nm, more preferably an average particle diameter of 5 to 100 nm, still more preferably an average particle diameter of 10 to 80 nm.

If the particle diameter of the inorganic fine particle is too small, the effect of improving the scratch resistance is reduced, whereas if the particle diameter is excessively large, fine unevenness is created on the cured layer surface and the appearance such as denseness of black or the integrated reflectance may be impaired. Therefore, the particle diameter is preferably in the range above. The inorganic fine particle may be crystalline or amorphous and may be a monodisperse particle or may be even an aggregate particle as long as the predetermined particle diameter is satisfied. The shape is most preferably spherical but even if infinite form, there arises no problem.

Here, the average particle diameter of the inorganic fine particle is measured by the observation through an electron microscope.

The composition of the inorganic fine particle includes for use in the present invention is not particularly limited and, for example, an oxide of silicon, titanium, aluminum, tin, zinc or antimony or a mixture thereof may be used, but in order to achieve uneven upward distribution in the coating film together with the component (A) for use in the present invention, a metal oxide with at least the particle surface having silicon as a constituent component is preferred. For example, a core-shell particle with the surface being composed of silicon dioxide may be used, or a mixed crystal of silicon and another inorganic element may be formed. In particular, from the standpoint of reducing the refractive index, a silicon dioxide (silica) particle is preferred.

Also, in view of strength of the interaction with the component (A), for example, a silicon dioxide (silica) particle or an inorganic fine particle containing antimony as a constituent component is preferably used.

The refractive index of the inorganic fine particle as the component (B) for use in the present invention is preferably 1.46 or less, more preferably from 1.15 to 1.46, still more preferably from 1.15 to 1.40, yet still more preferably from 1.15 to 1.35, and most preferably from 1.17 to 1.32. The inorganic fine particle as the component (B) is unevenly distributed in the upper part of the cured layer to thereby contribute to enhancement of the scratch resistance and reduction in the refractive index and therefore, preferably has a low refractive index.

The inorganic fine particle as the component (B) preferably has a hollow structure. In the case of an inorganic fine particle having a hollow structure, the refractive index does not indicate the refractive index of only the inorganic material of the outer shell but indicates an average value of the whole particle. In this case, assuming that the radius of the cavity inside the particle is a and the radius of the outer shell of the particle is b, the porosity x is represented the following mathematical formula (II).

x=(4πa³/3)/(4πb³/3)×100 Mathematical formula (II)

The porosity x is preferably from 10 to 60%, more preferably from 20 to 60%, still more preferably from 30 to 60%. With the porosity in this range, the low refractive index and the strength of the particle itself can fall in suitable ranges.

The inorganic fine particle as the component (B) is preferably caused to interact with the basic functional group-containing compound as the component (A). According to one preferred embodiment, in the inorganic fine particle as the component (B), the basic functional group of the component (A) interacts with the surface OH group of the inorganic fine particle as the component (B), whereby the surface covering of the inorganic fine particle can be achieved, making it possible to reduce the surface free energy of the inorganic fine particle and let the fine particle be unevenly distributed upward.

As for the component (A) containing a basic functional group and the inorganic fine particle as the component (B), the component (A) is preferably mixed (caused to interact) with the component (B) in advance before preparation of the coating composition of the present invention.

For the purpose of stabilizing the dispersion in a liquid dispersion or a coating solution or for enhancing the affinity for or bonding to the binder component, the inorganic fine particle may be subjected to a physical surface treatment such as plasma discharge treatment and corona discharge treatment, or a chemical surface treatment with a surfactant, a coupling agent or the like. Above all, use of a coupling agent is preferred. As the coupling agent, an alkoxymetal compound (e.g., titanium coupling agent, silane coupling agent) is preferably used. Of these, a silane coupling treatment is particularly effective. A silane coupling agent having a polymerizable functional group is preferred, and the polymerizable functional group is preferably an epoxy group, a vinyl group, a (meth)acryloyl group or the like, and most preferably an acryloyl group. Thanks to the introduction of such a functional group, the coating film strength of the layer formed by the uneven upward distribution of the inorganic fine particle can be enhanced.

In the present invention, the component (B) is preferably an inorganic fine particle surface-treated with at least one member selected from an organosilane compound, its partial hydrolysate and a condensate thereof.

### Ratio Between Component (A) and Inorganic Fine Particle of Component (B):

In the case where the component (A) does not have a crosslinking functional group, the amount of the component (A) based on the component (B) is preferably from 10 to 150 mass %, more preferably from 15 to 100 mass %. In the case where the component (A) has a crosslinking functional group, the amount is preferably from 10 to 200 mass %, more preferably from 15 to 150 mass %, still more preferably from 50 to 150 mass %. The amount in this range is preferred in view of uneven upward distribution of the particle and strength of the coating film.

### <Component (C): Curable Binder Containing No Fluorine Atom in Molecule>

The coating composition of the present invention contains, as a component (C), a curable binder containing no fluorine atom in the molecule. For example, the component (C) is preferably a monomer or oligomer having a reactive group capable of undergoing crosslinking by heat or ionizing radiation, more preferably a resin component containing a polyfunctional monomer or polyfunctional oligomer having a bifunctional or higher functional group, still more preferably a resin component containing a polyfunctional monomer or polyfunctional oligomer having a trifunctional or higher functional group.

The component (C) preferably a larger surface free energy than the component (A). A resin capable of forming a cured layer having a surface free energy of 30 mN/m or more is preferred, and the surface free energy is more preferably from 35 to 80 mN/m, still more preferably from 40 to 60 mN/m. Also, the difference in the surface free energy between the component (A) and the component (C) is preferably 5 mN/m or more, more preferably from 10 to 40 mN/m. Within this range, when the coating composition of the present invention is used, a layer separation structure is more easily formed. If the surface free energy after curing is too high or too low, reflectance reduction, unevenness and the like may be generated. In view of strength and coatability, the surface free energy is preferably not less than the preferred lower limit above.

In order to let the inorganic fine particle of the component (B) be surface-coated with the basic functional group-containing compound of the component (A) and be unevenly distributed to the topmost surface (air interface side) of the coating film, separability between the component (A) and the component (C) is preferably greater.

The separability between the component (A) and the component (C) can be estimated by thermodynamic and kinetic discussions. For example, when the free energy of mixing (ΔG=ΔH−T·ΔS) indicative of separability is determined by the Flory-Huggins's lattice theory, it is known that the separability can be estimated as a function of polymerization degree, volume fraction (φ; in publications, sometimes referred to as composition fraction) and interaction parameter (χ) (see, for example, Bates, “Polymer-Polymer Phase Behavior”, Science, Vol. 251, pp. 898-905, 1991, or Strobl, Konbunshi no Butsuri (Physics of Polymers), Springer-Verlag Tokyo, 1998).

ΔG means that when it is larger than 0, two components proceed to separating from each other, and when it is smaller than zero, two components proceed to mixing with each other. In the present invention, in order to let the component (B) be surface-coated with the component (A) and be unevenly distributed to the topmost surface of the coating film, AG of the component (A) and the component (C) is more preferably greater than zero, and from the standpoint of more accelerating the separation and reducing the disorder of the layer interface, ΔG is more preferably 0.01 or more.

The functional group contained in the curable binder as the component (C) is preferably a photo-, electron beam- or radiation-polymerizable functional group, more preferably a photopolymerizable functional group.

Examples of the photopolymerizable functional group include an unsaturated polymerizable functional group such as (meth)acryloyl group, vinyl group, styryl group and allyl group, with a (meth)acryloyl group being preferred.

From the standpoint of enhancing the scratch resistance, the curable binder as the component (C) preferably contains a compound having at least a plurality of unsaturated double bonds in the molecule.

Specific examples of the curable binder having a photopolymerizable functional group include:

(meth)acrylic acid diesters of alkylene glycol, such as neopentyl glycol acrylate, 1,6-hexanediol (meth)acrylate and propylene glycol di(meth)acrylate;

(meth)acrylic acid diesters of polyoxyalkylene glycol, such as triethylene glycol di(meth)acrylate, dipropylene glycol di(meth)acrylate, polyethylene glycol di(meth)acrylate and polypropylene glycol di(meth)acrylate;

(meth)acrylic acid diesters of polyhydric alcohol, such as pentaerythritol di(meth)acrylate; and

(meth)acrylic acid diesters of ethylene oxide or propylene oxide adduct, such as 2,2-bis{4-(acryloxy.diethoxy)phenyl}propane and 2-2-bis{4-(acryloxy.polypropoxy)phenyl}propane.

Furthermore, epoxy (meth)acrylates, urethane (meth)acrylates and polyester (meth)acrylates may be also preferably used as the photopolymerizable polyfunctional monomer.

Among these, esters of a polyhydric alcohol with a (meth)acrylic acid are preferred, and a polyfunctional monomer having three or more (meth)acryloyl groups per molecule is more preferred. Specific examples thereof include trimethylolpropane tri(meth)acrylate, trimethylolethane tri(meth)acrylate, 1,2,4-cyclohexane tetra(meth)acrylate, pentaglycerol triacrylate, pentaerythritol tetra(meth)acrylate, pentaerythritol tri(meth)acrylate, (di)pentaerythritol triacrylate, (di)pentaerythritol pentaacrylate, (di)pentaerythritol tetra(meth)acrylate, (di)pentaerythritol hexa(meth)acrylate, tripentaerythritol triacrylate and tripentaerythritol hexatriacrylate. In the description of the present invention, the terms “(meth)acrylate”, “(meth)acrylic acid” and “(meth)acryloyl” indicate “acrylate or methacrylate”, “acrylic acid or methacrylic acid” and “acryloyl or methacryloyl”, respectively.

As for the monomer binder, monomers differing in the refractive index may be used for controlling the refractive index of each layer. In particular, examples of the high refractive index monomer include bis(4-methacryloylthiophenyl)sulfide, vinylnaphthalene, vinyl phenyl sulfide and 4-methacryloxyphenyl-4′-methoxyphenylthioether.

Furthermore, dendrimers described, for example, in JP-A-2005-76005 and JP-A-2005-36105, and norbornene ring-containing monomers described, for example, in JP-A-2005-60425 may also be used.

Two or more kinds of polyfunctional monomers may be used in combination.

In the coating composition of the present invention, as for the contents of the components (A), (B) and (C), from the standpoint of forming two or more layers differing in the refractive index in one coating step and at the same time, imparting hardcoat property, the mass ratio of [component (A)+component (B)]/[component (C)] is from 1/199 to 60/40, preferably from 1/199 to 50/50, more preferably from 1/99 to 10/90.

As for the mass ratio of the components (A), (B) and (C) and the later-described component (E) for use in the coating composition of the present invention, [component (A)+component (B)+component (E)]/[component (C)] is preferably from 1/199 to 60/40, more preferably from 1/199 to 50/50, still more preferably from 1/99 to 10/90.

### <Component (D): Solvent>

As the solvent (D) for use in the present invention, various solvents selected from the standpoint that the solvent can dissolve or disperse each component, readily provides a uniform surface state in the coating step and drying step, ensures liquid storability and possesses an appropriate saturated vapor pressure, may be used.

One kind of a solvent may be used, or two or more kinds of solvents may be mixed and used.

The component (D) is preferably a mixed solvent of at least the following two solvents:

(D-1) a volatile solvent wherein a difference in the compatibility parameter between the volatile solvent and either one of the component (A) and the component (C) is from 1 to 10, and

(D-2) a volatile solvent having a boiling point of 100° C. or less.

It is more preferred to further contain (D-3) a volatile solvent having a boiling point exceeding 100° C.

Particularly, in view of drying load, while using a solvent having a boiling point of 100° C. or less at room temperature under atmospheric pressure as the main component, a solvent having a boiling point of 100° C. or more is preferably contained in a small amount (a solvent having a boiling point of 100° C. or more in an amount of 1 to 50 parts by mass, preferably from 2 to 40 parts by mass, more preferably from 3 to 30 parts by mass, per 100 parts by mass of the solvent having a boiling point of 100° C. or less) for adjusting the drying speed. The difference in the boiling point between two solvents is preferably 25° C. or more, more preferably 35° C. or more, still more preferably 50° C. or more. By using at least two organic solvents differing in the boiling point, uneven upward distribution of the inorganic fine particle and separation of the binder are facilitated. Furthermore, a solvent wherein a difference in the compatibility parameter between the solvent and either one of the component (A) and the component (C) is from 1 to 10, is preferably contained in a small amount (from 1 to 50 parts by mass, preferably from 2 to 40 parts by mass, more preferably from 3 to 30 parts by mass, per 100 parts by mass of the solvent having a boiling point of 100° C. or less). Thanks to the addition of a solvent having bad solubility, separation of the binder is encouraged.

Examples of the solvent having a boiling point of 100° C. or less include hydrocarbons such as hexane (boiling point: 68.7° C.), heptane (98.4° C.), cyclohexane (80.7° C.) and benzene (80.1° C.); halogenated hydrocarbons such as dichloromethane (39.8° C.), chloroform (61.2° C.), carbon tetrachloride (76.8° C.), 1,2-dichloroethane (83.5° C.) and trichloroethylene (87.2° C.); ethers such as diethyl ether (34.6° C.), diisopropyl ether (68.5° C.), dipropyl ether (90.5° C.) and tetrahydrofuran (66° C.); esters such as ethyl formate (54.2° C.), methyl acetate (57.8° C.), ethyl acetate (77.1° C.), isopropyl acetate (89° C.) and dimethyl carbonate (90.3° C.); ketones such as acetone (56.1° C.) and methyl ethyl ketone (79.6° C.); alcohols such as methanol (64.5° C.), ethanol (78.3° C.), 2-propanol (82.4° C.) and 1-propanol (97.2° C.); cyano compounds such as acetonitrile (81.6° C.) and propionitrile (97.4° C.); and carbon disulfide (46.2° C.). Among these, ketones and esters are preferred, and ketones are more preferred. Out of ketones, methyl ethyl ketone is preferred.

Examples of the solvent having a boiling point of 100° C. or more include octane (125.7° C.), toluene (110.6° C.), xylene (138° C.), tetrachloroethylene (121.2° C.), chlorobenzene (131.7° C.), dioxane (101.3° C.), dibutyl ether (142.4° C.), isobutyl acetate (118° C.), cyclohexanone (155.7° C.), 2-methyl-4-pentanone (same as MIBK, 115.9° C.), 1-butanol (117.7° C.), N,N-dimethylformamide (153° C.), N,N-dimethylacetamide (166° C.) and dimethyl sulfoxide (189° C.). Among these, cyclohexanone and 2-methyl-4-pentanone are preferred.

In the present invention, a solvent whose difference in the SP value (solubility parameter) from either one of the component (A) and the component (C) is from 1 to 10, is preferably used.

The solvent with the solubility parameter difference from the component (A) being from 1.0 to 10 is preferably a solvent having a solubility parameter of, in terms of the absolute value, from 20 to 30, more preferably from 21 to 27, still more preferably from 22 to 26. Examples thereof include propylene glycol monoethyl ether (solubility parameter=23.05), ethyl acetate (solubility parameter=23.65), methanol (solubility parameter=28.17), ethanol (solubility parameter=25.73), and 2-butanol (solubility parameter=22.73), with propylene glycol monoethyl ether being preferred.

The solvent having a solubility parameter of 20 or more in terms of absolute value has a high propensity to decrease in the compatibility with the component (A) in the course of applying the coating composition and allowing the drying to proceed, and for enhancing the layer separability, use of a solvent having a solubility parameter difference of 1.0 or more is suited. Also, the solvent having a solubility parameter of 30 or more in terms of absolute value exhibits a marked tendency to hardly dissolve the component (A) at the preparation of the coating composition and therefore, use of a solvent having a solubility parameter difference of 10 or less is suited.

The solvent whose solubility parameter difference from the component (C) is from 1.0 to 10 is preferably a solvent having a solubility parameter of, in terms of absolute value, from 10 to 20, more preferably from 12 to 18.

Examples of such a solvent include 1,1,2,2-tetrafluoro-1-(2,2,2-trifluoroethoxy)ethane (solubility parameter=14.54), trifluoromethylbenzene (solubility parameter=16.76), perfluoroheptylethyl acetate (solubility parameter=14.79), 1,1,2,2,3,3,4,4,5,5,6,6-dodecafluorohexylethyl acetate (solubility parameter=16.72), and methyl trifluoroacetate (solubility parameter=15.73), with 1,1,2,2-tetrafluoro-1-(2,2,2-trifluoroethoxy)ethane being preferred. Combination use of a solvent having a solubility parameter difference of 1.0 to 10 makes it easy to satisfy the required minimum solubility while keeping appropriate layer separability.

### (Solubility Parameter)

The solubility parameter expresses by a numerical value how easily soluble in a solvent or the like and has the same concept as the polarity often used for an organic compound. A larger solubility parameter indicates that the polarity is larger. The component (A) for use in the present invention is preferably a fluorine-containing polymer and the solubility parameter thereof as calculated by the Fedor's estimation method is, for example, 19 or less. The solubility parameter of DPHA as the component (C), which is a mixture of dipentaerythritol pentaacrylate and dipentaerythritol hexaacrylate is 21.4. The SP value as used herein is a value as calculated, for example, by the Fedor's estimation method (Hideki Yamamoto, SP-chi Kiso•Ovo to Keisan Houhou (Foundation and Application of SP Values and Calculation Method), page 66, Johokiko Co., Ltd. (issued on Mar. 31, 2005)).

As for the blending ratio of an organic solvent as the component (D) in the coating composition of the present invention, the organic solvent is preferably added to give a coating composition having a solid content concentration of 2 to 70 mass %, more preferably from 3 to 60 mass %, still more preferably from 5 to 50 mass %. If the solid content concentration is too low, for example, drying may take time or film thickness unevenness attributable to drying may be liable to be generated, whereas if the solid content concentration is excessively high, for example, uneven distribution of particles may not be sufficiently achieved or coating unevenness may be readily caused due to reduction in the amount coated.

### <(E) Curable Compound Containing Fluorine Atom>

The coating composition of the present invention preferably contains, as the component (E), a curable compound containing a fluorine atom. Containing the component (E) produces effects of enhancing the uneven upward distribution of the components (A) and (B), thereby reducing the surface state failure, and at the same time, decreasing the refractive index of the uneven upward distribution layer. Also for enhancing the scratch resistance of the antireflection film of the present invention, it is preferred to increase the hardness or slipperiness of the topmost layer by the uneven upward distribution of the fluorine atom-containing curable compound (E).

The fluorine atom-containing curable compound (E) may be either a polymer or a monomer, but in the case of a fluorine-containing polymer, a polymer containing a fluorine-containing moiety and a moiety of a functional group capable of participating in the crosslinking reaction and having a molecular weight of 1,000 or more is preferred. On the other hand, in the case of using a fluorine-containing monomer, the polymerizable group of a polyfunctional fluorine monomer preferably has any one group selected from an acryloyl group, a methacryloyl group and —C(O)OCH═CH₂.

A mixture of a fluorine-containing polymer and a fluorine-containing monomer may be also used as the component (E). The polymer and the monomer are described in detail below.

### <Fluorine-Containing Polymer>

The fluorine-containing polymer usable as the component (E) preferably has a structure represented by the following formula (3):

(MF1)a-(MF2)b-(MF3)c-(MA)d-(MB)e Formula (3):

In formula (3), each of a to e indicates the molar fraction of each constituent component and represents a value satisfying the relationships of 0≦a≦70, 0≦b≦70, 30≦a+b≦70, 0≦c≦50, 5≦d≦50, and 0≦e≦50.

(MF1) indicates a constituent unit polymerized from a monomer represented by CF₂═CF—Rf₁, wherein Rf₁ represents a perfluoroalkyl group having a carbon number of 1 to 5.

(MF2) indicates a constituent unit polymerized from a monomer represented by CF₂═CF—ORf₁₂, wherein Rf₁₂ represents a fluorine-containing alkyl group having a carbon number of 1 to 30.

(MF3) indicates a constituent unit polymerized from a monomer represented by CH₂═CH—ORf₁₃, wherein Rf₁₃ represents a fluorine-containing alkyl group having a carbon number of 1 to 30.

(MA) represents a constituent unit having at least one (at least one or more) crosslinking groups.

(MB) represents an arbitrary constituent unit.

(MF1) to (MF3) are the same as those described with respect to the fluorine-containing polymer of formula (1), and preferred structures and the like are also the same.

The fluorine atom-containing curable compound (E) is required to contain a repeating unit having a crosslinking moiety, and the crosslinking moiety is preferably at least any one of a hydroxyl group- or hydrolyzable group-containing silyl group, a reactive unsaturated double bond-containing group, a ring-opening polymerization reactive group, an active hydrogen atom-containing group, a group capable of being substituted with a nucleophilic agent, and an acid anhydride.

In formula (3), (MA) represents a constituent component containing at least one crosslinking moieties (a reactive moiety capable of participating in the crosslinking reaction).

Examples of the crosslinking moiety include a hydroxyl group- or hydrolyzable group-containing silyl group (such as alkoxysilyl group and acyloxysilyl group), a reactive unsaturated double bond-containing group (such as (meth)acryloyl group, allyl group and vinyloxy group), a ring-opening polymerization reactive group (such as epoxy group, oxetanyl group and oxazolyl group), an active hydrogen atom-containing group (such as hydroxyl group, carboxyl group, amino group, carbamoyl group, mercapto group, 3-ketoester group, hydrosilyl group and silanol group), an acid anhydride, and a group capable of being substituted with a nucleophilic agent (such as active halogen atom and sulfonic acid ester).

The crosslinking group in (MA) is preferably a reactive unsaturated double bond-containing group or a ring-opening polymerization reactive group, more preferably a reactive unsaturated double bond-containing group. Specific preferred examples of the constituent component represented by (MA) are MA-1 to MA-70 in formula (1).

In formula (3), (MB) represents an arbitrary constituent unit. (MB) is not particularly limited as long as it is a constituent unit obtained from a monomer copolymerizable with monomers forming the constituent units represented by (MF1) and (MF2) and with a monomer forming the constituent unit represented by (MA), and this can be appropriately selected in view of various points such as adherence to substrate, Tg of polymer (contributing to film hardness), solubility in solvent, transparency, slipperiness, dust resistance and antifouling property.

Examples of the monomer for forming (MB) include vinyl esters such as methyl vinyl ether, ethyl vinyl ether, n-butyl vinyl ether, cyclohexyl vinyl ether and isopropyl vinyl ether, and vinyl esters such as vinyl acetate, vinyl propionate, vinyl butyrate and vinyl cyclohexanecarboxylate.

(MB) preferably contains a constituent component having a polysiloxane structure. By containing a polysiloxane structure as (MB), uneven upward distribution in the coating film is facilitated and there are produced effects such as low reflection of the film obtained and improvement of the surface state. Also, thanks to the polysiloxane structure contained, slipperiness and antifouling property of a laminate can be enhanced.

It is preferred that both the component (A) and the component (E) are a fluorine-containing copolymer and at least two constituent units out of constituent units forming each copolymer are common therebetween. Particularly, in the case where the component (A) is a fluorine-containing polymer represented by formula (1), the components (A), (B) and (E) being similar in the structure are liable to be unevenly distributed upward together. For prominently bringing out this effect, the compound of formula (1) and the compound of formula (3) are preferably in a configuration where out of the constituent units forming each copolymer, at least two kinds of constituent units, more preferably three kinds of constituent units, are common between the compounds.

As for the method to introduce a polysiloxane structure, the same methods as those described for the compound of formula (1) may be used.

In formula (1), each of a to e indicates the molar fraction of each constituent component and represents a value satisfying the relationships of 0≦a≦70, 0≦b≦70, 30≦a+b≦70, 0≦c≦50, 5≦d≦50, and 0≦e≦50.

The molar fraction (%) a+b of the component (MF1) and the component (MF2) is preferably increased for achieving a low refractive index, but in a general solution-type radical polymerization reaction, the polymerization reactivity imposes a limit on the introduction to approximately from 50 to 70%, and an introduction in a higher ratio is generally difficult. In the present invention, the lower limit of a+b is preferably 40 or more, more preferably 45 or more.

Introduction of (MF3) also contributes to achieving a low refractive index. As described above, the molar fraction c of the component (MF3) is 0≦c≦50, preferably 5≦c≦20.

The sum of molar fractions a to c of the fluorine-containing monomer components is preferably 40≦a+b+c≦90, more preferably 50≦a+b+c≦75.

If the proportion of the polymer unit represented by (MA) is too small, the strength of the cured film is reduced. In the present invention, particularly, the molar fraction of the component (MA) is preferably 5≦d≦40, more preferably 15≦d≦30.

The molar fraction e of the arbitrary constituent component represented by (MB) is preferably 0≦e≦50, more preferably 0≦e≦20, still more preferably 0≦e≦10.

In the present invention, from the standpoint of improving the coating surface state and the scratch resistance of the film, the fluorine atom-containing curable compound (E) preferably has a high-polarity functional group in the molecule. Accordingly, (MB) preferably has a high-polarity functional group in the molecule. The high-polarity functional group is preferably a hydroxyl group, an alkyl ether group, a silanol group, a glycidyl group, an oxetanyl group, a polyalkylene oxide group or a carboxyl group, more preferably a hydroxyl group, an alkyl ether group or a polyalkylene oxide group.

The molar fraction of the polymerization unit having such a functional group is preferably from 0.1 to 15%, more preferably from 1 to 10%.

As described above, a polysiloxane structure is preferably introduced into the fluorine-containing polymer in view of coating film surface state and scratch resistance. The content of the polysiloxane structure in the fluorine-containing polymer is preferably from 0.5 to 15 mass %, more preferably from 1 to 10 mass %, in terms of the mass ratio to all polymers.

The number average molecular weight of the fluorine-containing polymer is preferably from 1,000 to 1,000,000, more preferably from 5,000 to 500,000, still more preferably from 10,000 to 100,000.

Specific examples of the copolymer represented by formula (3) are illustrated below, but the present invention is not limited thereto. In Table 4, the copolymer is shown by the combination of the monomers (MF1), (MF2) and (MF3) forming the fluorine-containing constituent units of formula (3) by being polymerized, and the constituent components (MA) and (MB). In the Table, each of a to e represents the molar percentage (%) of the monomer for each component. In the Table, when wt % is shown for the component (MB), this indicates mass % of the component in the entire polymer. In Table 4, with respect to the components except for EVE in the column of “(MB)”, the contents (mass %: wt %) of the components in the entire polymer are shown in order from the left following the molar percentage of EVE in the column “e”.

TABLE 4

| | | | | | | | | | | | Molecular Weight |
|---|---|---|---|---|---|---|---|---|---|---|---|
| | (MF1) | (MF2) | (MF3) | (MA) | (MB) | a | b | c | d | e | (ten thousand) |
| P-1 | HFP | — | — | (MA-8) | EVE | 50 | — | — | 30 | 20 | 2.0 |
| P-2 | HFP | — | — | (MA-8) | EVE/VPS-1001 | 50 | — | — | 30 | 20/2 wt % | 2.3 |
| P-3 | HFP | FPVE | — | (MA-8) | EVE/VPS-1001 | 45 | 5 | — | 30 | 20/2 wt % | 2.2 |
| P-4 | HFP | FPVE | — | (MA-8) | EVE/VPS-0501 | 45 | 5 | — | 30 | 20/2 wt % | 2.0 |
| P-5 | HFP | FPVE | — | (MA-8) | EVE/FM-0721 | 45 | 5 | — | 30 | 20/2 wt % | 2.0 |
| P-6 | HFP | FPVE | — | (MA-8) | EVE/FM-0725 | 45 | 5 | — | 30 | 20/2 wt % | 2.5 |
| P-7 | HFP | FPVE | MF3-1 | (MA-8) | EVE/FM-0721 | 45 | 5 | 5 | 30 | 15/2 wt % | 2.0 |
| P-8 | HFP | FPVE | — | (MA-9) | EVE/FM-0721 | 45 | 5 | — | 30 | 20/2 wt % | 2.0 |
| P-9 | HFP | FPVE | — | (MA-8)/(MA-56) | EVE/FM-0721 | 45 | 5 | — | 25/5 | 20/2 wt % | 1.9 |
| P-10 | HFP | — | — | (MA-1) | EVE | 50 | — | — | 35 | 15 | 2.2 |
| P-11 | HFP | — | — | (MA-1) | EVE/VPS-1001 | 50 | — | — | 35 | 15/2 wt % | 2.3 |
| P-12 | HFP | FPVE | — | (MA-1) | EVE/VPS-1001 | 45 | 5 | — | 35 | 15/2 wt % | 2.1 |
| P-13 | HFP | FPVE | — | (MA-1) | EVE/VPS-0501 | 45 | 5 | — | 35 | 15/2 wt % | 2.0 |
| P-14 | HFP | FPVE | — | (MA-1) | EVE/FM-0721 | 45 | 5 | — | 35 | 15/2 wt % | 2.1 |
| P-15 | HFP | FPVE | — | (MA-1) | EVE/FM-0725 | 45 | 5 | — | 35 | 15/2 wt % | 2.4 |
| P-16 | HFP | FPVE | MF3-1 | (MA-1) | EVE/FM-0721 | 45 | 5 | 5 | 35 | 10/2 wt % | 2.0 |
| P-17 | HFP | FPVE | — | (MA-2) | EVE/FM-0721 | 45 | 5 | — | 35 | 15/2 wt % | 2.2 |
| P-18 | HFP | FPVE | — | (MA-1)/(MA-56) | EVE/FM-0721 | 45 | 5 | — | 30/5 | 15/2 wt % | 2.0 |
| P-19 | HFP | — | — | (MA-56) | EVE | 50 | — | — | 25 | 25 | 2.6 |
| P-20 | HFP | — | — | (MA-56) | EVE/VPS-1001 | 50 | — | — | 25 | 25/2 wt % | 2.7 |
| P-21 | HFP | FPVE | — | (MA-56) | EVE/VPS-1001 | 45 | 5 | — | 25 | 25/2 wt % | 2.7 |
| P-22 | HFP | FPVE | — | (MA-56) | EVE/VPS-0501 | 45 | 5 | — | 25 | 25/2 wt % | 2.5 |
| P-23 | HFP | FPVE | — | (MA-56) | EVE/FM-0721 | 45 | 5 | — | 25 | 25/2 wt % | 2.5 |
| P-24 | HFP | FPVE | — | (MA-56) | EVE/FM-0725 | 45 | 5 | — | 25 | 25/2 wt % | 2.7 |
| P-25 | HFP | FPVE | MF3-1 | (MA-56) | EVE/FM-0721 | 40 | 5 | 5 | 25 | 25/2 wt % | 2.7 |
| P-26 | HFP | FPVE | — | (MA-57) | EVE/FM-0721 | 45 | 5 | — | 25 | 25/2 wt % | 2.6 |
| IPF-27 | HFP | — | — | (MA-21) | EVE/FM-0721 | 50 | — | — | 30 | 20/2 wt % | 2.6 |
| IPF-28 | HFP | — | — | (MA-22) | EVE/FM-0721 | 50 | — | — | 30 | 20/2 wt % | 2.4 |

Abbreviations in the Table above indicate the followings.
Component (MF1):
HFP: Hexafluoropropylene
Component (MF2):
FPVE: Perfluoropropyl vinyl ether
Component (MF3):
MF3-1: CH₂═CH—O—CH₂CH₂—O—CH₂(CF₂)₄H
Component (MB):
EVE: Ethyl vinyl ether
VPS-1001: Azo group-containing polydimethylsiloxane, molecular weight of polysiloxane moiety: about 10,000, produced by Wako Pure Chemical Industries, Ltd.
FM-0721: Methacryloyl-modified dimethylsiloxane modified, average molecular weight: 5,000, produced by Chisso Corporation.
FM-0725: Dimethylsiloxane modified with methacryloyl at one terminal, average molecular weight: 10,000, produced by Chisso Corporation.
VPS-0501: Azo group-containing polydimethylsiloxane, molecular weight of polysiloxane moiety: about 5,000, produced by Wako Pure Chemical Industries, Ltd.

Incidentally, in the case where the fluorine-containing polymer contains a hydrolyzable group-containing silyl group (a hydrolyzable silyl group) as the crosslinking group, a known acid or base catalyst may be blended as the catalyst for a sol-gel reaction. The amount of this curing catalyst added is arbitrary depending on the kind of the catalyst or difference of the curing-reactive moiety but in general, the amount added is preferably on the order of 0.1 to 15 mass %, more preferably on the order of 0.5 to 5 mass %, based the entire solid content of the coating composition.

Also, in the case where the fluorine-containing polymer contains a hydroxyl group as the crosslinking group, the composition of the present invention preferably contains a compound (curing agent) capable of reacting with the hydroxyl group in the fluorine-containing polymer.

The curing agent preferably has two or more, more preferably four or more, moieties capable of reacting with the hydroxyl group.

The structure of the curing agent is not particularly limited as long as it has the above-described number of functional groups capable of reacting with a hydroxyl group. Examples thereof include polyisocyanates, a partial condensate or multimer of a isocyanate compound, an adduct with a polyhydric alcohol or a low-molecular-weight polyester film, a blocked polyisocyanate compound in which an isocyanate group is blocked with a blocking agent (e.g., phenol), aminoplasts, and a polybasic acid or anhydride thereof.

From the standpoint of satisfying both the stability during storage and the activity of crosslinking reaction as well as in view of strength of the film formed, the curing agent is preferably aminoplasts capable of undergoing a crosslinking reaction with a hydroxyl group-containing compound under acidic conditions. The aminoplasts are a compound containing an amino group capable of reacting with a hydroxyl group present in the fluorine-containing polymer, that is, a hydroxyalkylamino group or an alkoxyalkylamino group, or containing a carbon atom adjacent to a nitrogen atom and substituted with an alkoxy group. Specific examples thereof include a melamine-based compound, a urea-based compound and a benzoguanamine-based compound.

The melamine-based compound is generally known as a compound having a skeleton in which a nitrogen atom is bonded to a triazine ring, and specific examples thereof include melamine, alkylated melamine, methylolmelamine and alkoxylated methylmelamine. In particular, methylolated melamine, alkoxylated methylmelamine, which are obtained by reacting melamine and formaldehyde under basic conditions, and derivatives thereof are preferred, and alkoxylated methylmelamine is more preferred in view of storage stability. The methylolated melamine and alkoxylated methylmelamine are not particularly limited, and various resins obtained by the method described, for example, in Plascic Zairvo Kouza, (Plastic Material Course) [8] Urea.Melamine Jushi (Urea.Melamine Resin), The Nikkan Kogyo Shimbun Ltd. may be also used.

As the urea compound, polymethylolated urea, alkoxylated methyl urea as a derivative of polymethylolated urea, and a compound having a glycol uril skeleton or 2-imidazolidinone skeleton, which are a cyclic urea structure, are also preferred, in addition to urea. Also for the amino compound such as urea derivative, various resins described, for example, in Urea Melamine Jushi (Urea Melamine Resin), supra may be used.

In view of compatibility with the fluorine-containing polymer, the compound suitably usable as the curing agent is preferably a melamine compound or a glycol uril compound. In view of reactivity, the curing agent is more preferably a compound containing a nitrogen atom in the molecule and having two or more carbon atoms substituted with an alkoxy group adjacent to the nitrogen atom. Above all, the curing agent is preferably a compound having a structure represented by the following formula H-1 or H-2, or a partial condensate thereof.

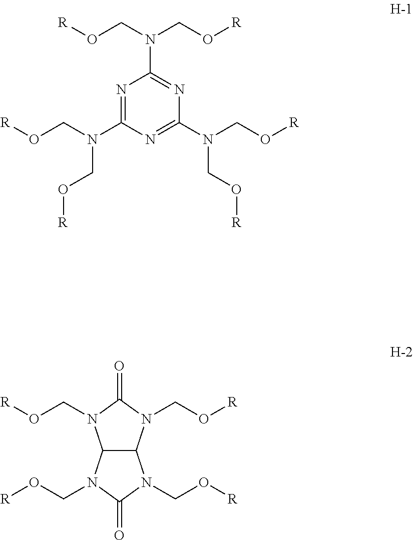

In the formulae, R represents an alkyl group having a carbon number of 1 to 6 or a hydroxyl group.

The amount of the aminoplast added to the fluorine-containing polymer is preferably from 1 to 50 parts by mass, more preferably from 3 to 40 parts by mass, still more preferably from 5 to 30 parts by mass, per 100 parts by mass of the fluorine-containing polymer. When the amount added is 1 part by mass or more, durability as a thin film can be sufficiently brought out, and when it is 50 parts by mass or less, a low refractive index can be advantageously maintained.

In the reaction of the fluorine-containing polymer containing a hydroxyl group and the curing agent, a curing catalyst is preferably used. In this system, since the curing is promoted by an acid, an acidic substance is preferably used as the curing catalyst, but when a normal acid is added, the crosslinking reaction proceeds in the coating solution to cause a failure (such as unevenness and repelling). Therefore, in order to satisfy both the storage stability and curing activity in a thermosetting system, it is more preferred that a compound capable of generating an acid by heating or a compound capable of generating an acid by light is added as the curing catalyst. Specific compounds are described in paragraphs [0220] to [0230] of JP-A-2007-298974.

### [Fluorine-Containing Monomer]

The fluorine-containing monomer which can be used as the component (E) is a compound having an atomic group (hereinafter, sometimes referred to as a “fluorine-containing core moiety”) mainly composed of a plurality of fluorine atoms and carbon atoms (provided that a part of the atomic group may contain an oxygen atom and/or a hydrogen atom) and substantially kept from participating in polymerization and a polymerizable group such as radical polymerizable group, ionic polymerizable group and condensation polymerizable group through a linking group such as ester bond and ether bond, and preferably has two or more polymerizable groups.

The fluorine-containing monomer is preferably a compound (polymerizable fluorine-containing compound) represented by the following formula (I):

Rf{-(L)ₘ-Y}ₙ Formula (I):

(wherein Rf represents an n-valent chained or cyclic group containing at least a carbon atom and a fluorine atom, which may contain at least either an oxygen atom or a hydrogen atom, n represents an integer of 2 or more, L represents a single bond or a divalent linking group, m represents 0 or 1, and Y represents a polymerizable group).

In formula (I), Y represents a polymerizable group. Y is preferably a radical polymerizable group, an ionic polymerizable group or a condensation polymerizable group, more preferably a polymerizable unsaturated group or a ring-opening polymerizable group, still more preferably a polymerizable unsaturated group. Specifically, a group selected from a (meth)acryloyl group, an allyl group, an alkoxysilyl group, an α-fluoroacryloyl group, an epoxy group and —C(O)OCH═CH₂ is preferred. Among these, in view of polymerizability, a (meth)acryloyl group, an allyl group, an α-fluoroacryloyl group, an epoxy group or —C(O)OCH═CH₂ each having radical polymerizability or cationic polymerizability is more preferred, a (meth)acryloyl group, an allyl group, an α-fluoroacryloyl group or —C(O)OCH═CH₂ each having radical polymerizability is still more preferred, and a (meth)acryloyl group or —C(O)OCH═CH₂ is most preferred.

The polymerizable fluorine-containing compound may be a crosslinking agent in which the polymerizable group is a crosslinking group.

Examples of the crosslinking group include a hydroxy group- or hydrolyzable group-containing silyl group (such as alkoxysilyl group and acyloxysilyl group), a reactive unsaturated double bond-containing group (such as (meth)acryloyl group, allyl group and vinyloxy group), a ring-opening polymerization reactive group (such as epoxy group, oxetanyl group and oxazolyl group), an active hydrogen atom-containing group (such as hydroxyl group, carboxyl group, amino group, carbamoyl group, mercapto group, β-ketoester group, hydrosilyl group and silanol group), an acid anhydride, and a group capable of being substituted with a nucleophilic agent (such as active halogen atom and sulfonic acid ester).

L represents a single bond or a divalent linking group and is preferably an alkylene group having a carbon number of 1 to 10, an arylene group having a carbon number of 6 to 10, —O—, —S—, —N(R)— or a divalent linking group obtained by combining two or more of these groups. R represents a hydrogen atom or an alkyl group having a carbon number of 1 to 5.

In the case where L represents an alkylene group or an arylene group, the alkylene group or arylene group represented by L is preferably substituted with a halogen atom, more preferably substituted with a fluorine atom.

Here, the “calculated value of inter-crosslink molecular weight” indicates the sum of atomic weights of atomic groups sandwiched between (a) and (a), between (b) and (b) or between (a) and (b), on the assumption that in a polymer where all polymerizable groups in the polymerizable fluorine-containing compound are polymerized, the carbon atom substituted with 3 or more carbon atoms and/or silicon atoms and/or oxygen atoms in total is (a) and the silicon atom substituted with 3 or more carbon atoms and/or oxygen atoms in total is (b). Increase of the inter-crosslink molecular weight can raise the fluorine content in the fluorine-containing monomer and enhance the reflectance reduction, electrical conductivity and antifouling performance, but the strength and hardness of the coated film are decreased and the coated layer surface comes to lack in the scratch resistance and abrasion resistance. On the other hand, decrease of the inter-crosslink molecular weight can raise the inter-crosslink density and improve the film strength, but the amount of fluorine is decreased and the reflectance increases. Therefore, in view of crosslink density and fluorine content, the calculated value of inter-crosslink molecular weight when all polymerizable groups in the polymerizable fluorine-containing compound are polymerized is preferably 2,000 or less, more preferably less than 1,000, and most preferably more than 50 and less than 800. The polymerizable fluorine-containing compound preferably contains, in the molecule, a carbon atom substituted with 3 or more oxygen atoms and/or carbon atoms and/or silicon atoms in total (exclusive of an oxygen atom of carbonyl group). By containing this carbon atom, a dense crosslink network structure can be established at the curing, and the hardness of the coating film tends to be increased.

A more preferred embodiment of the polymerizable fluorine-containing compound represented by formula (I) is a compound represented by the following formula (I-1), (I-2) or (I-3):

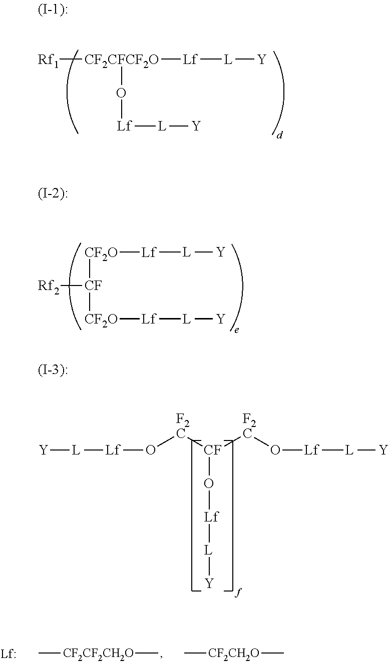

wherein Rf₁ represents an oxygen atom or a d-valent organic group which is a group composed of substantially only a carbon atom and a fluorine atom or a group composed of only a carbon atom, a fluorine atom and an oxygen atom; Rf₂ represents an oxygen atom or an e-valent organic group which is a group composed of substantially only a carbon atom and a fluorine atom or a group composed of only a carbon atom, a fluorine atom and an oxygen atom; Lf represents —CF₂CF₂CH₂O— or —CF₂CH₂O— (in both, the carbon atom side is bonded to the oxygen atom); L and Y have the same meanings as L and Y in formula (I); each of d and e independently represents an integer of 2 or more; and f represents an integer of 1 or more.

The carbon number of Rf₁ and Rf₂ is preferably from 0 to 30, more preferably from 0 to 10.

A still more preferred embodiment of the compound represented by formula (I-1), (I-2) or (I-3) is a compound represented by the following formula (I-1′), (I-2′) or (I-3′):

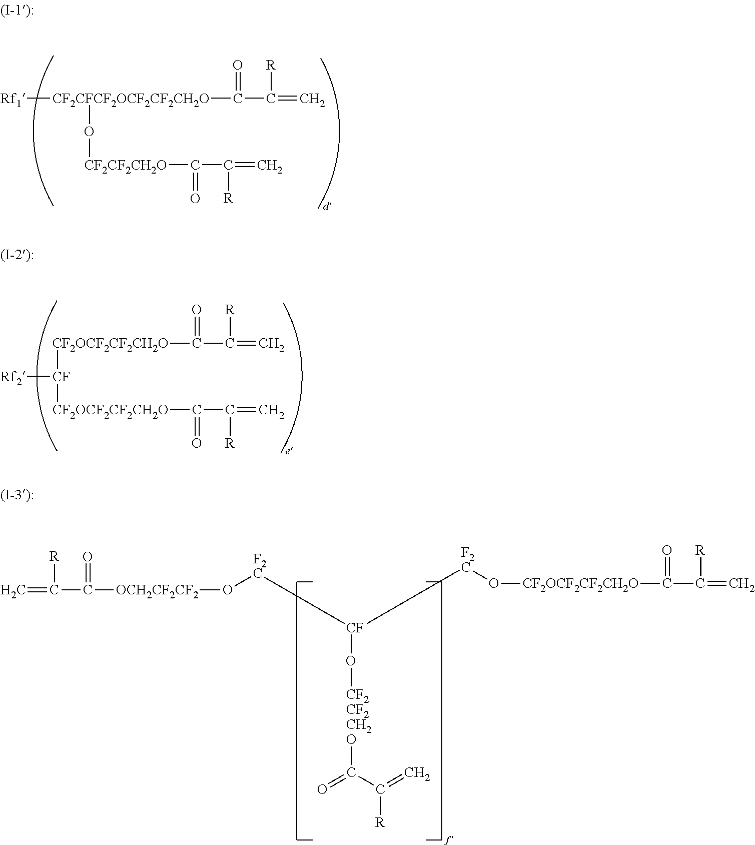

wherein Rf₁′ represents an oxygen atom or a d′-valent organic group which is a group composed of substantially only a carbon atom and a fluorine atom or a group composed of only a carbon atom, a fluorine atom and an oxygen atom; Rf₂′ represents an oxygen atom or an e′-valent organic group which is a group composed of substantially only a carbon atom and a fluorine atom or a group composed of only a carbon atom, a fluorine atom and an oxygen atom, R represents a hydrogen atom, a fluorine atom, an alkyl group (preferably an alkyl group having a carbon number of 1 to 5) or a fluoroalkyl group (preferably a perfluoroalkyl group having a carbon number of 1 to 5), each of d′ and e′ independently represents an integer of 2 or 3; and f represents an integer of 1 to 4.

The carbon number of Rf₁′ or Rf₂′ is preferably from 0 to 30, more preferably from 0 to 10.

Specific examples of the polymerizable fluorine-containing compound represented by formula (I) of the present invention are illustrated below, but the present invention is not limited thereto.

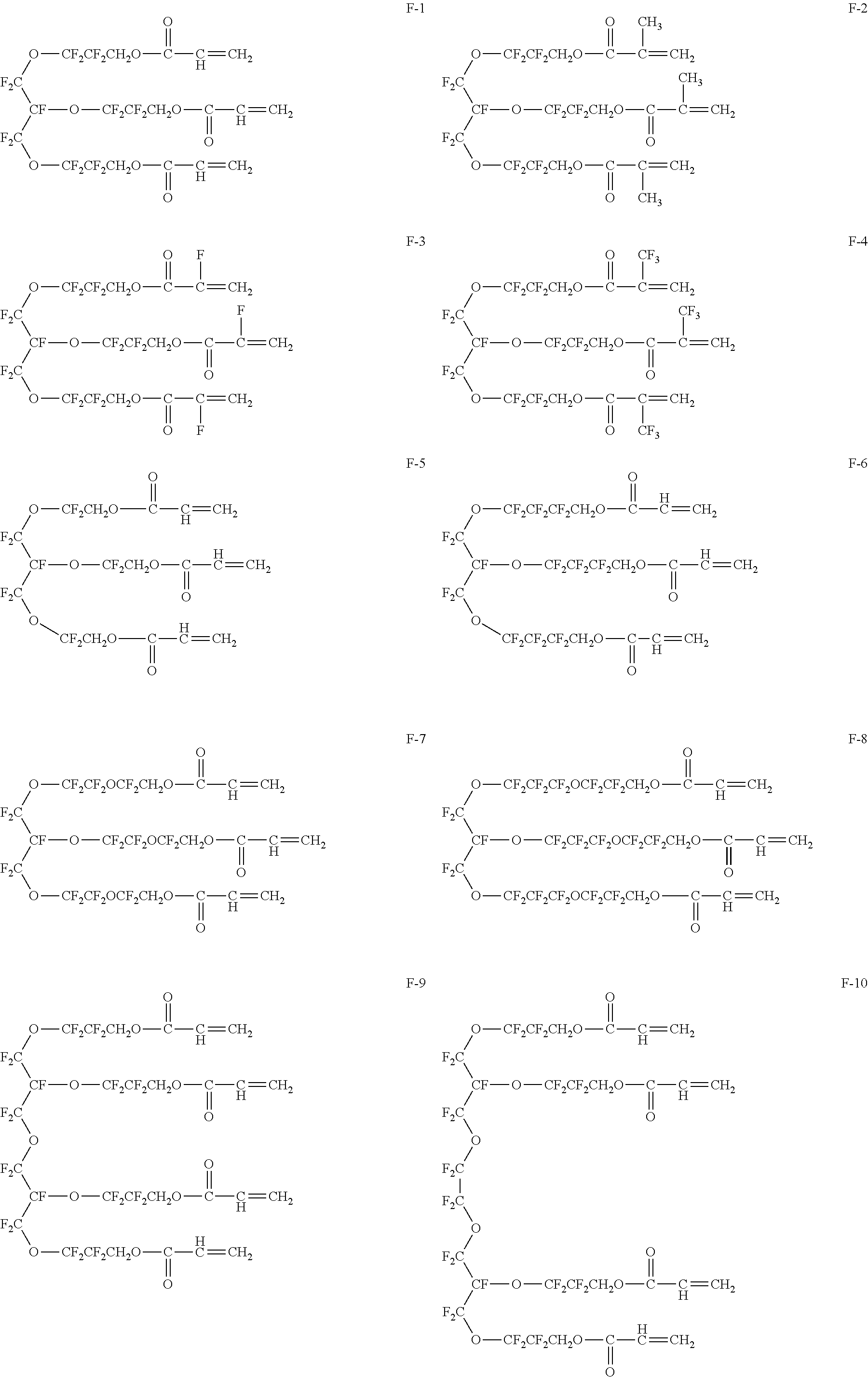

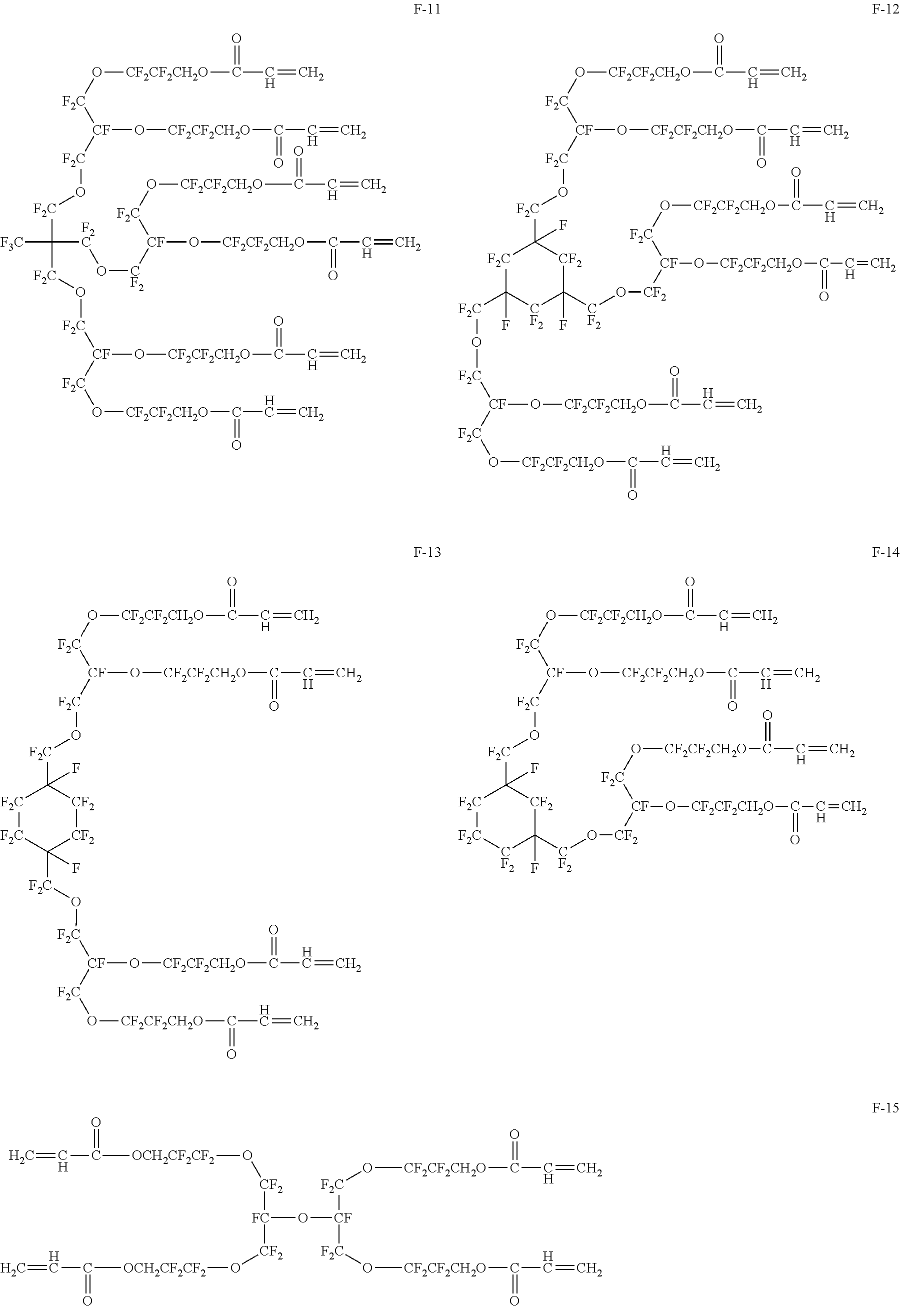

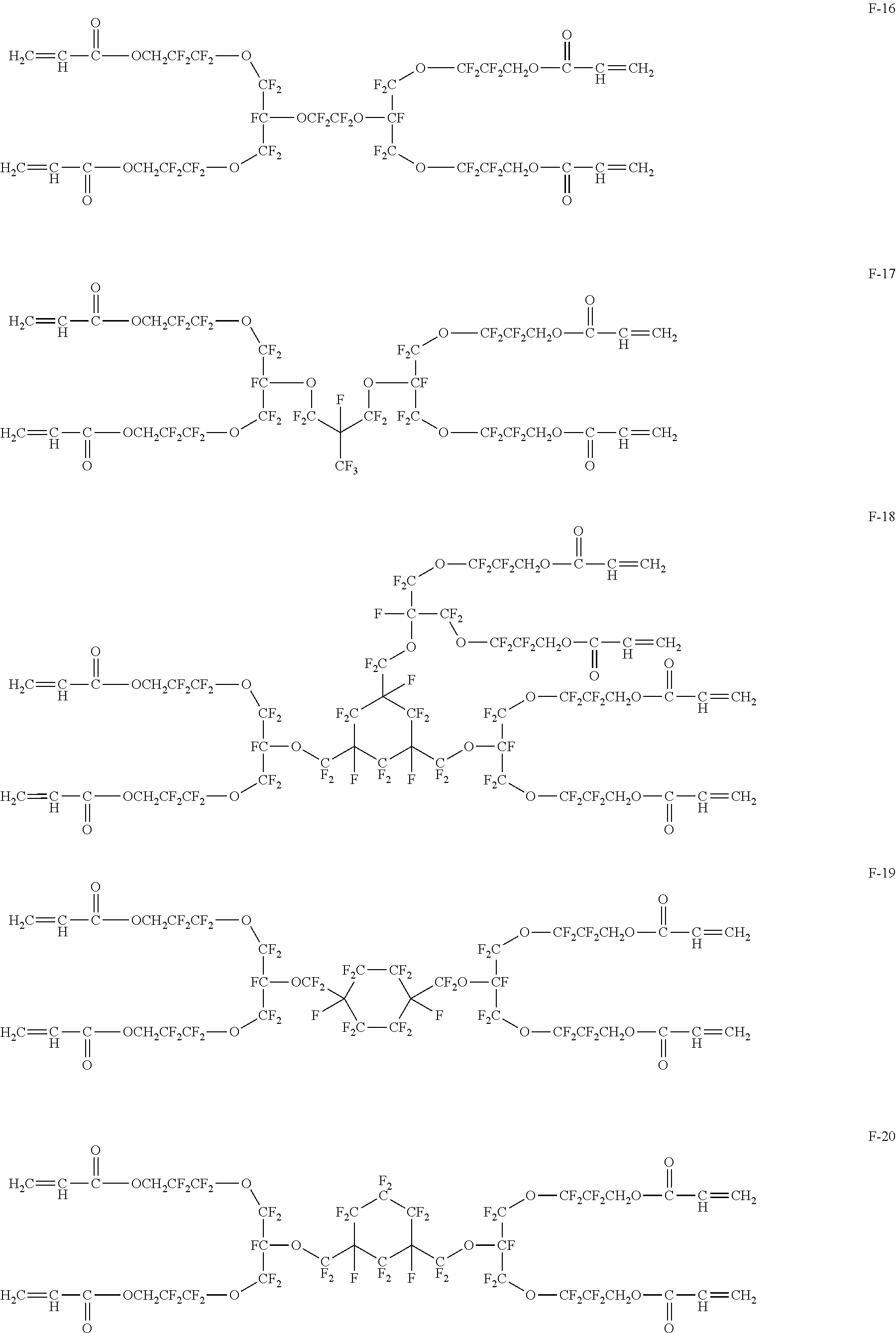

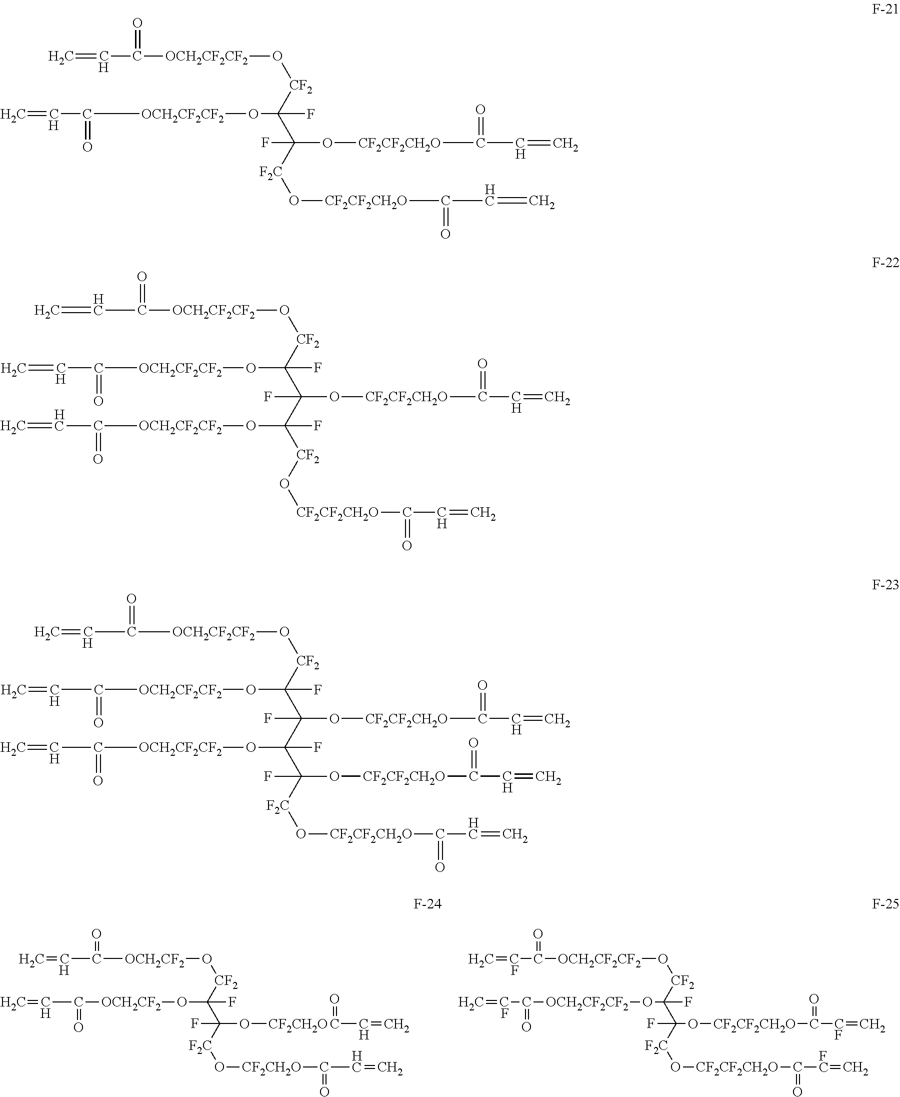

The polymerizable fluorine-containing compound represented by formula (I) of the present invention is not particularly limited in its production method and can be produced, for example, by a combination of known methods described below. In the following description, unless otherwise indicated, the same symbols as used hereinbefore have the same meanings as those described above.

Step 1: A step of subjecting a compound represented by Rh(CO₂R₁)ₐ or Rh(CH₂OCOR₂)ₐ to a liquid phase fluorination reaction and a subsequent reaction with methanol described in U.S. Pat. No. 5,093,432 and International Publication No. 00/56694 to obtain a methyl ester of Rf(CO₂CH₃)ₐ.

(In the formulae above, R₁ represents a lower alkyl group such as methyl group and ethyl group, R₂ represents an alkyl group, preferably a fluorine-containing alkyl group, more preferably a perfluoroalkyl group, and Rh represents a group capable of becoming Rf by the liquid phase fluorination reaction.)

Step 2: A step of reducing the compound represented by Rf(CO₂CH₃)ₐ with a reducing agent such as hydrogenated lithium aluminum and hydrogenated boron sodium to obtain an alcohol of Rf(CH₂OH)ₐ.

Step 3: A step of blockwise or randomly adding one or more members selected from ethylene carbonate, ethylene oxide and glycidyl alcohol to the compound represented by Rf(CH₂OH)ₐ to obtain Rf(CH₂O-L-H)ₐ. This step is not necessary when b=c=0.

Step 4: A step of introducing a polymerizable group into the compound represented by Rf(CH₂O-L-H)ₐ to obtain a compound of Rf(CH₂O-L-Y)ₐ represented by formula (I).

Here, in the case where Y is —COC(R₀)═CH₂, as the reaction of introducing a polymerizable group, an esterification reaction of the alcohol Rf(CH₂O-L-H)ₐ with an acid halide XCOC(R₀)═CH₂ (wherein X represents a halogen atom, preferably a chlorine atom) or dehydration condensation with a carboxylic acid HOCOC(R₀)═CH₂ can be utilized. In the case where Y is other polymerizable group, for example, a nucleophilic substitution reaction with a halide compound corresponding to Rf(CH₂O-L-H)ₐ can be utilized.

Specific preferred examples of the fluorine-containing monomer are illustrated below, but the present invention is not limited thereto.

From the standpoint of improving the coated surface state and the scratch resistance of the film, the compounds shown below may be also preferably used as the fluorine-containing monomer, in addition to X-2 to X-4, X-6, X-8 to X-14 and X-21 to X-32 described in paragraphs [0023] to [0027] of JP-A-2006-28409.

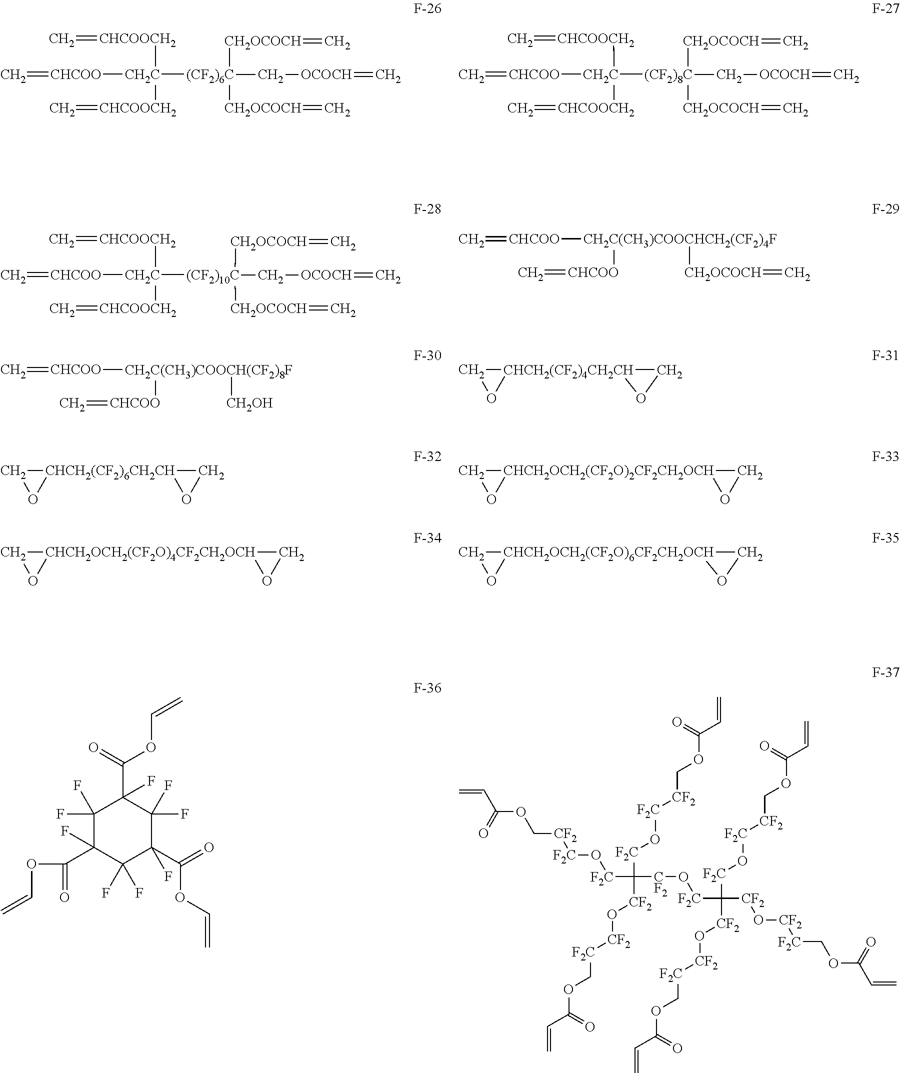

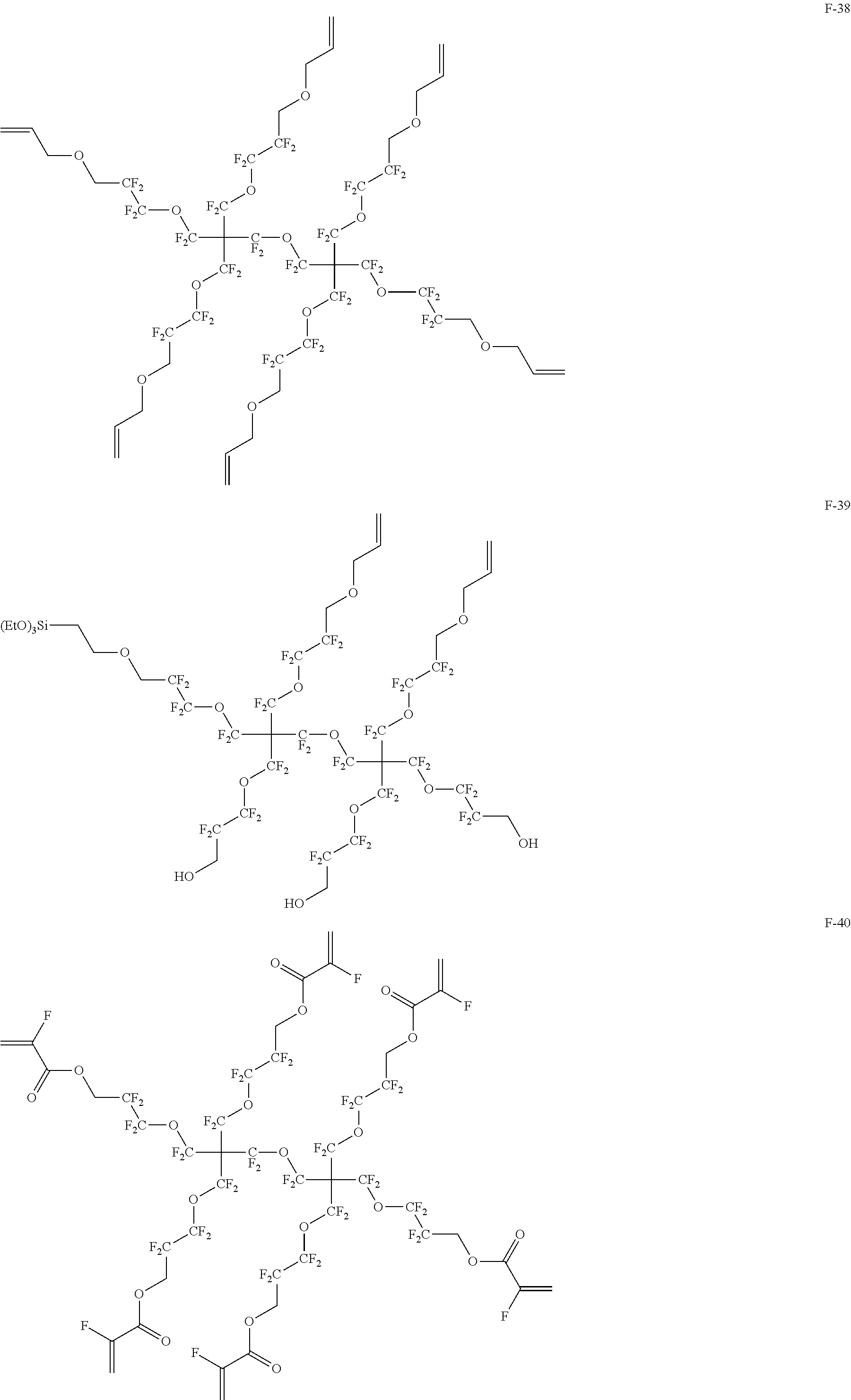

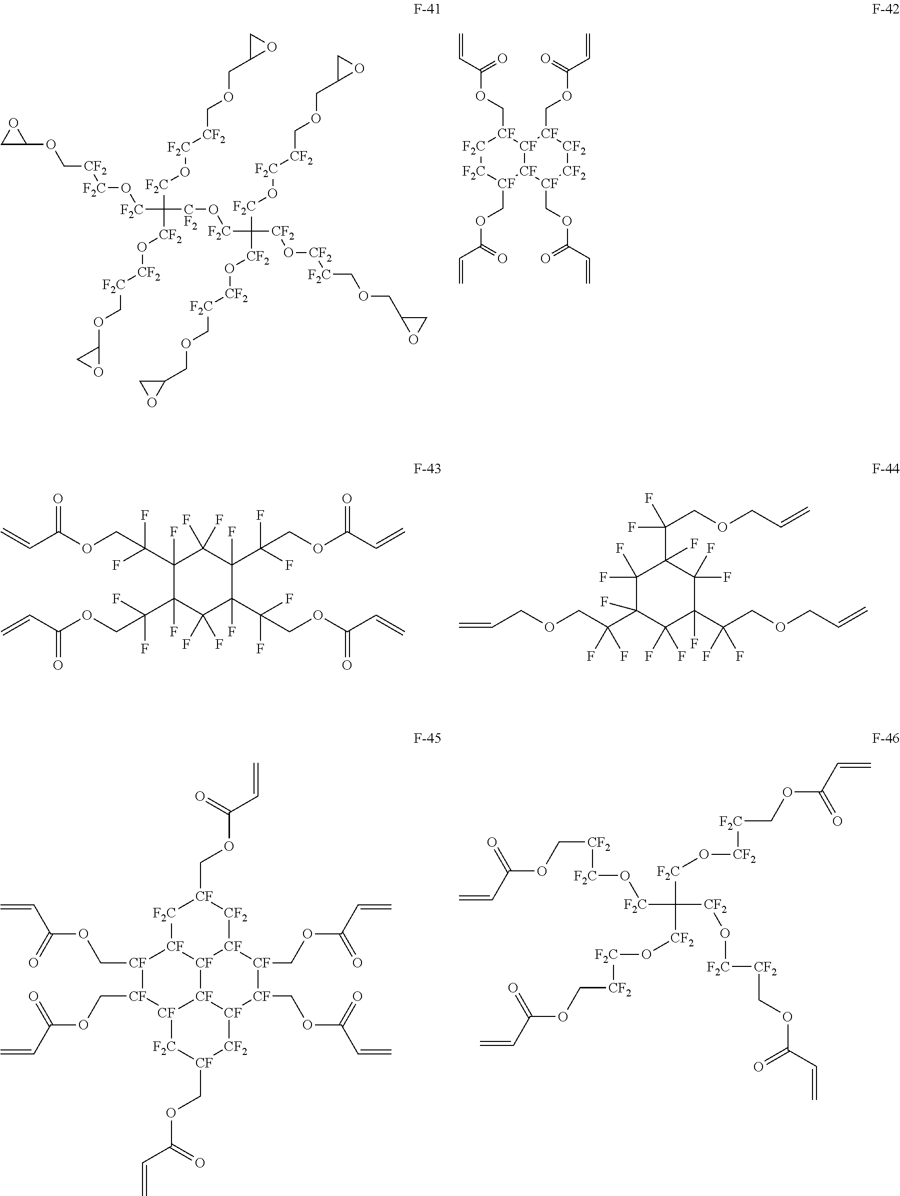

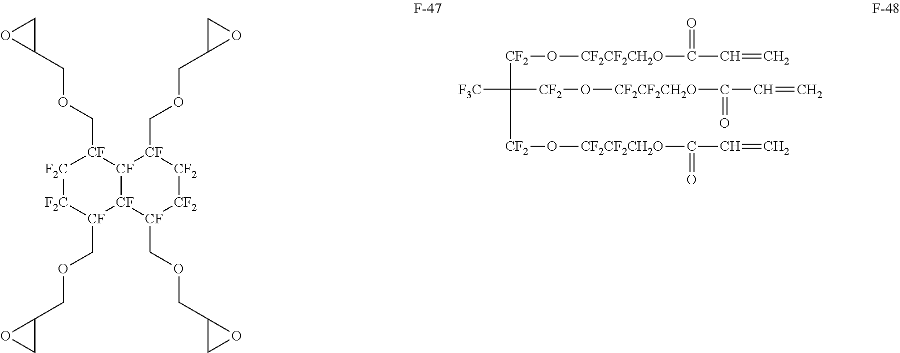

In addition, the following compounds may be also preferably used.

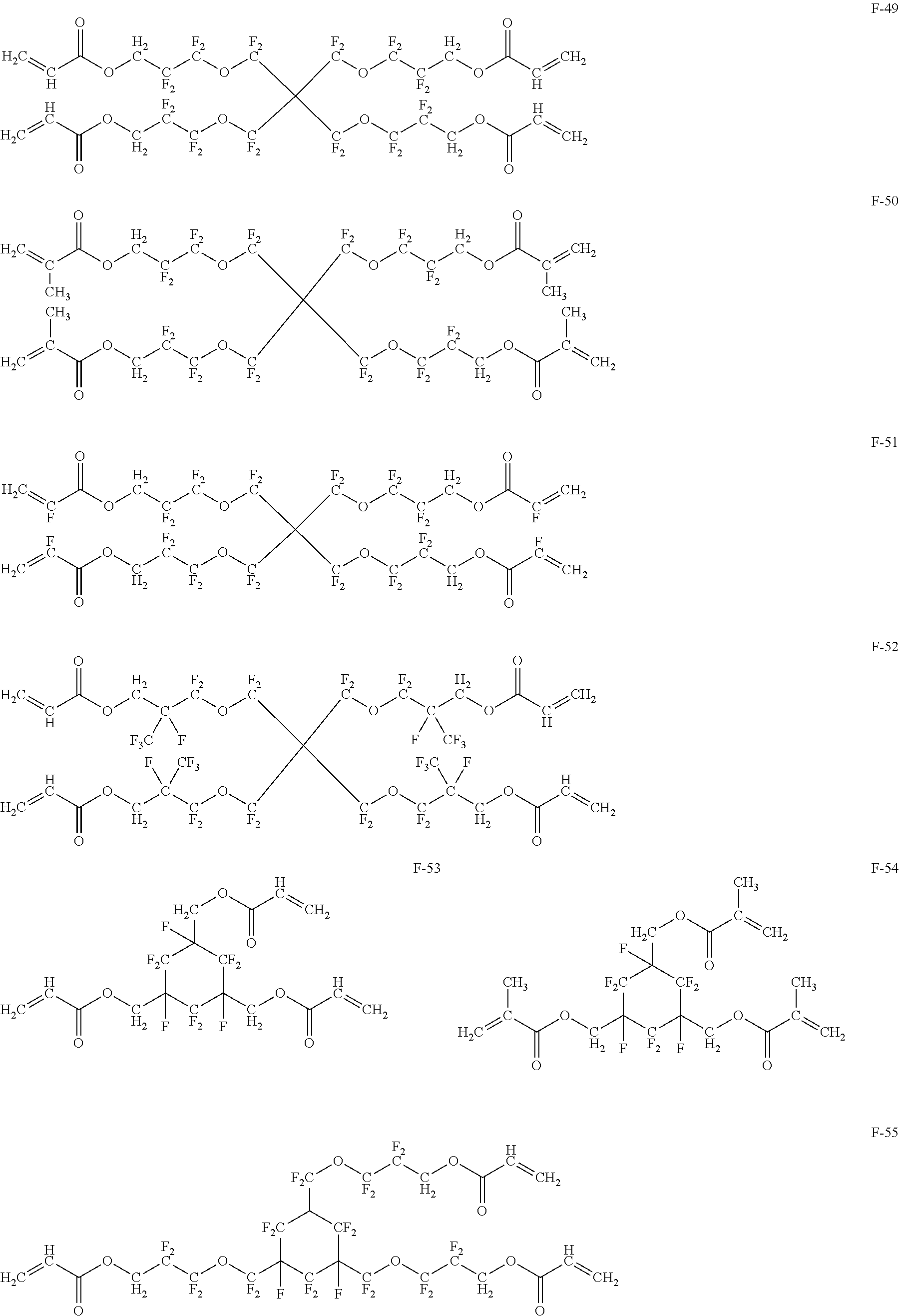

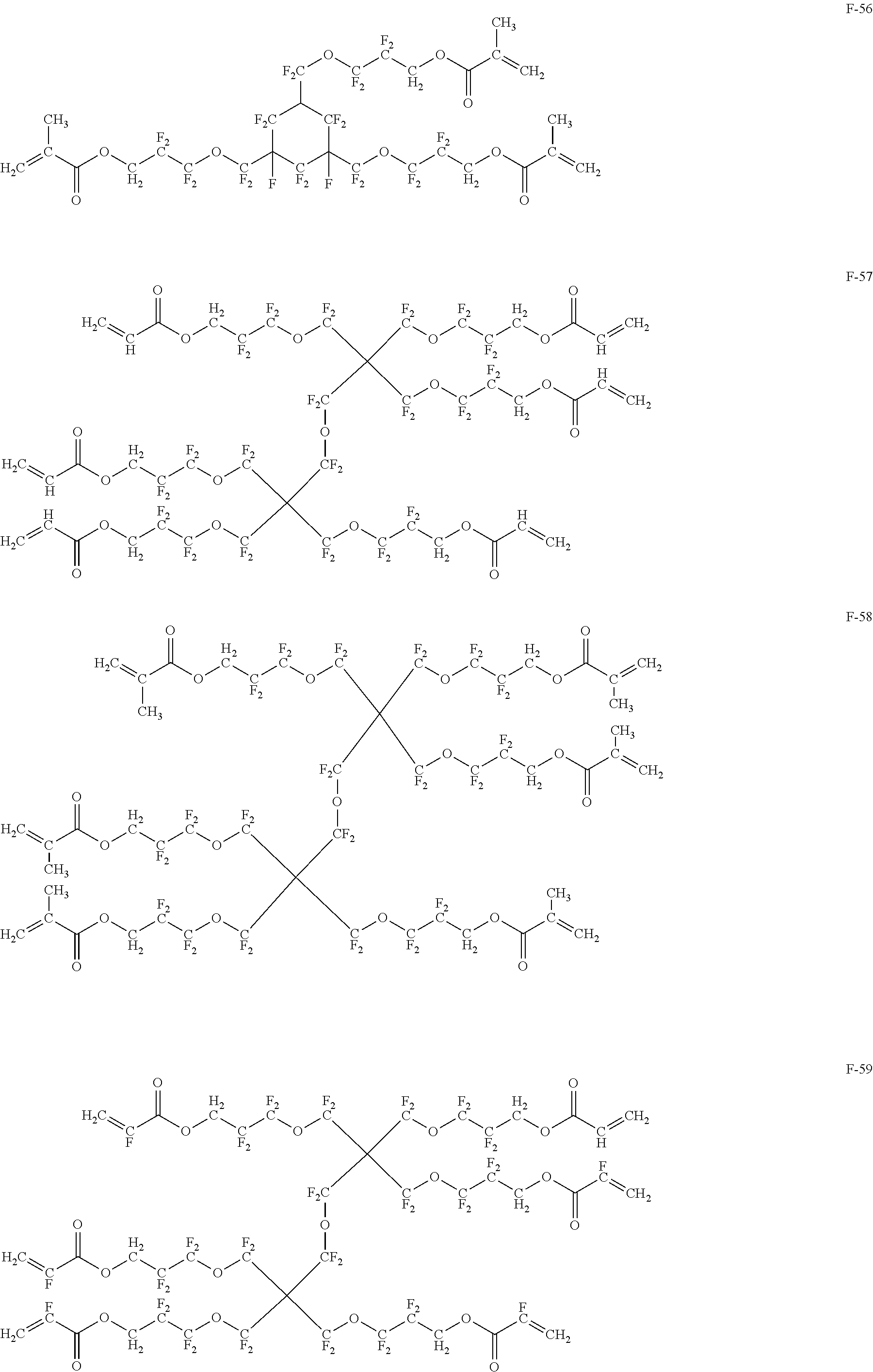

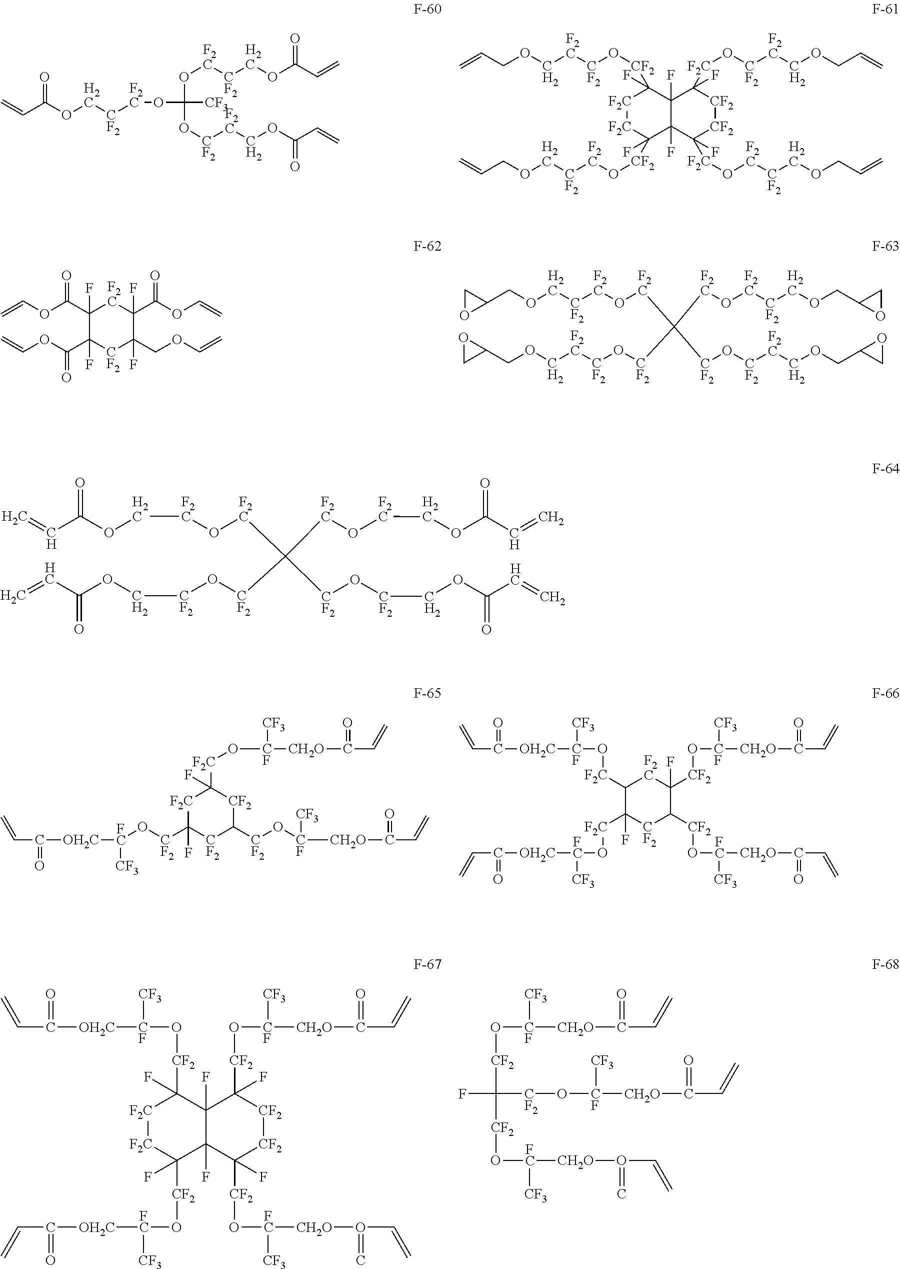

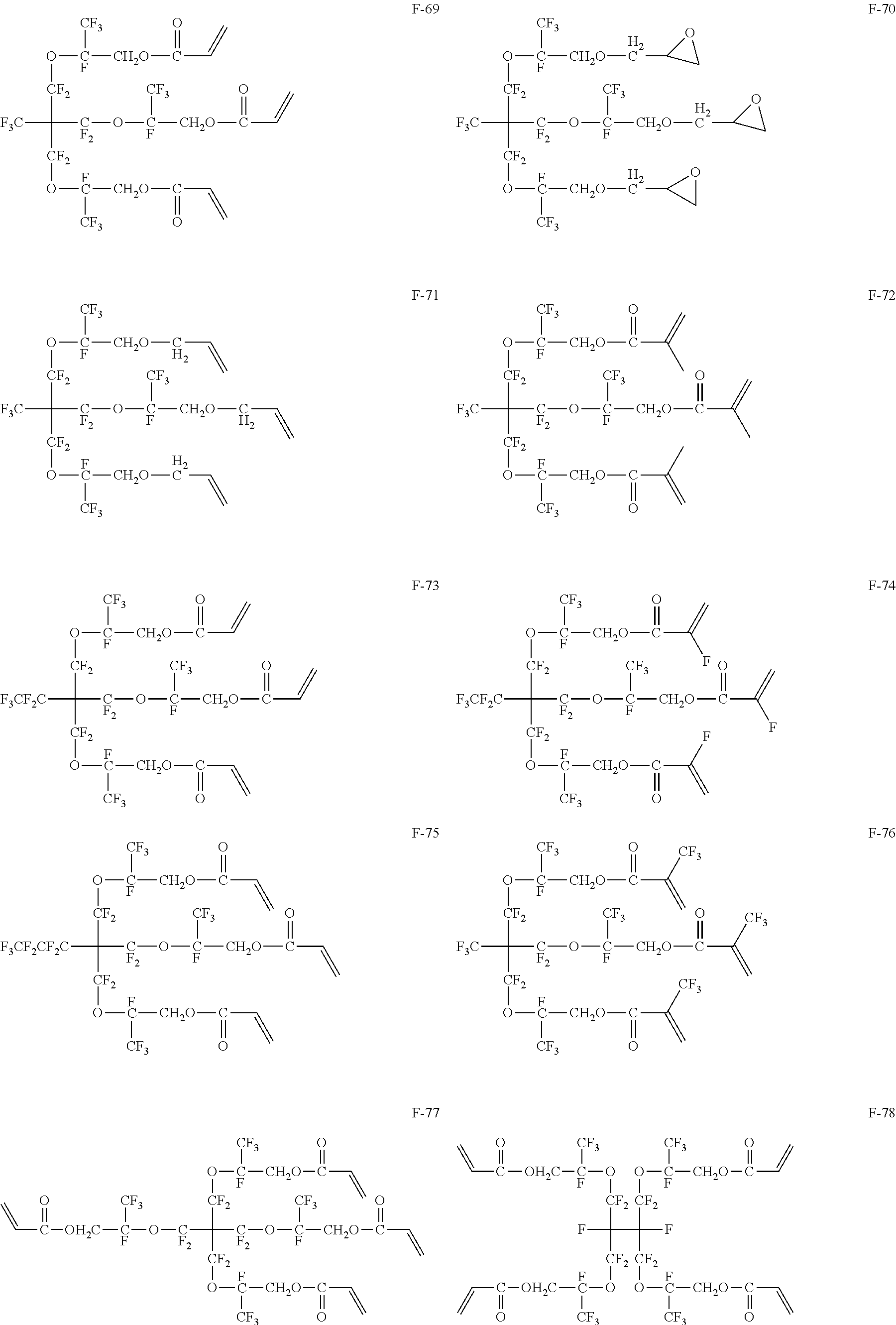

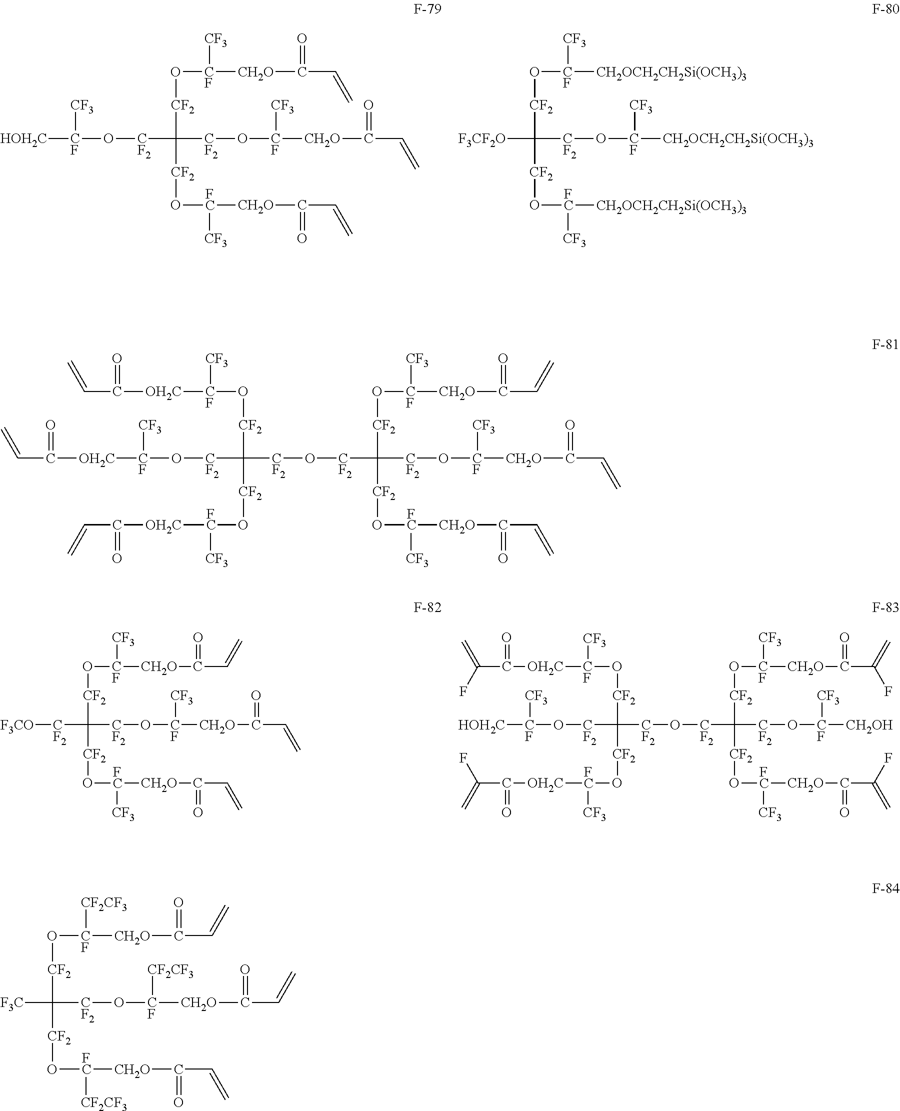

Furthermore, in view of compatibility with other binders or fluorine-free monomers, a monomer having a repeating unit of an alkyl chain substituted with fluorine through an ether bond, represented by the following formula (II), may used as the fluorine-containing monomer.

Y—(CF₂—CFX—O)ₙ₂—Y Formula (II)

(wherein X represents —F or —CF₃, n2 represents an integer of 1 to 20, and Y represents a polymerizable group).

The preferred range and specific examples of Y are same as those of Y in formula (I).

Specific examples of the polyfunctional fluorine-containing monomer represented by formula (II) are set forth below, but the present invention is not limited thereto.

FP-1: CH₂═CH—COOCH₂(CF₂CF₂—O)₂CH₂OCOCH═CH₂

FP-2: CH₂═CH—COOCH₂(CF₂CF₂—O)₄CH₂OCOCH═CH₂

FP-3: CH₂═C(CH₃)—COOCH₂(CF₂CF₂—O)₂CH₂OCOC(CH₃)═CH₂

FP-4: CH₂═C(CH₃)—COOCH₂(CF₂C(CF₃)F—O)₄CH₂OCOC(CH₃)═CH₂

FP-5: CH₂═C(CH₃)—COOCH₂(CF₂C(CF₃)F—O)₈ CH₂OCOC(CH₃)═CH₂

The following polyfunctional fluorine-containing (meth)acrylic acid ester may be also preferably used, because a crosslinking structure can be formed and the strength and hardness of the cured film are high. Specific examples thereof include 1,3-bis{(meth)acryloyloxy}-2,2-difluoropropane, 1,4-bis{(meth)acryloyloxy}-2,2,3,3-tetrafluorobutane, 1,5-bis{(meth)acryloyloxy}-2,2,3,3,4,4-hexafluoropentane, 1,6-bis{(meth)acryloyloxy}-2,2,3,3,4,4,5,5-octafluorohexane, 1,7-bis{(meth)acryloyloxy}-2,2,3,3,4,4,5,5,6,6-decafluoroheptane, 1,8-bis{(meth)acryloyloxy}-2,2,3,3,4,4,5,5,6,6,7,7-dodecafluorooctane, 1,9-bis{(meth)acryloyloxy}-2,2,3,3,4,4,5,5,6,6,7,7,8,8-tetradecafluorononane, 1,10-bis{(meth)acryloyloxy}-2,2,3,3,4,4,5,5,6,6,7,7,8,8,9,9-hexadecafluorodecane, 1,11-bis{(meth)acryloyloxy}-2,2,3,3,4,4,5,5,6,6,7,7,8,8,9,9,10,10-octadecafluoroundecane, 1,12-bis{(meth)acryloyloxy}-2,2,3,3,4,4,5,5,6,6,7,7,8,8,9,9,10,10,11,11-eicosafluorododecane, 1,8-bis{(meth)acryloyloxy}-2,7-dihydroxy-4,4,5,5-tetrafluorooctane, 1,7-bis{(meth)acryloyloxy}-2,8-dihydroxy-4,4,5,5-tetrafluorooctane, 2,7-bis{(meth)acryloyloxy}-1,8-dihydroxy-4,4,5,5-tetrafluorooctane, 1,10-bis{(meth)acryloyloxy}-2,9-dihydroxy-4,4,5,5,6,6,7,7-octafluorodecane, 1,9-bis{(meth)acryloyloxy}-2,10-dihydroxy-4,4,5,5,6,6,7,7-octafluorodecane, 2,9-bis{(meth)acryloyloxy}-1,10-dihydroxy-4,4,5,5,6,6,7,7-octafluorodecane, 1,2,7,8-tetrakis {(meth)acryloyloxy}-4,4,5,5-tetrafluorodecane, 1,2,8,9-tetrakis {(meth)acryloyloxy}-4,4,5,5,6,6-hexafluorononane, 1,2,9,10-tetrakis {(meth)acryloyloxy}-4,4,5,5,6,6,7,7-octafluorodecane, 1,2,10,11-tetrakis {(meth)acryloyloxy}-4,4,5,5,6,6,7,7,8,8-decafluoroundecane, 1,2,11,12-tetrakis{(meth)acryloyloxy}-4,4,5,5,6,6,7,7,8,8,9,9-dodecafluorododecane, 1,10-bis(α-fluoroacryloyloxy)-2,9-dihydroxy-4,4,5,5,6,6,7,7-octafluorodecane, 1,9-bis(α-fluoroacryloyloxy)-2,10-dihydroxy-4,4,5,5,6,6,7,7-octafluorodecane, 2,9-bis(α-fluoroacryloyloxy)-1,10-dihydroxy-4,4,5,5,6,6,7,7-octafluorodecane, 1,2,9,10-tetrakis(α-fluoroacryloyloxy)-4,4,5,5,6,6,7,7-octafluorodecane and 1,2,11,12-tetrakis(α-fluoroacryloloxy)-4,4,5,5,6,6,7,7,8,8,9,9-dodecafluorododecane.

Such a fluorine-containing polyfunctional (meth)acrylic acid ester can be produced by a known method and, for example, is produced by a ring-opening reaction of a corresponding fluorine-containing epoxy compound with a (meth)acrylic acid or an esterification reaction of a corresponding fluorine-containing polyhydric alcohol or a fluorine-containing (meth)acrylic acid ester having a hydroxyl group obtained as an intermediate in the ring-opening reaction above, with (meth)acrylic acid chloride.

### (Fluorine Content of Fluorine-Containing Monomer)

From the standpoint of allowing for phase separation from the component (C) and reducing the surface energy to achieve uneven upward distribution, the fluorine content of the fluorine-containing monomer is preferably 25.0 mass % or more, more preferably from 45.0 to 80.0 mass %, and most preferably from 50.0 to 80.0 mass %, based on the molecular weight of the fluorine-containing monomer. If the fluorine content exceeds 80.0 mass %, the strength and hardness of the coat are decreased and the coat surface lacks in the scratch resistance and abrasion resistance, though the content of fluorine atom in the cured film is high.

The fluorine-containing curable compound (E) for use in the present invention is preferably a fluorine-containing polymer in view of stability of the film surface state. Also, from the standpoint of improving the solubility of the coating composition and the adherence, a fluorine-containing curable monomer is preferred. Combination use of a fluorine-containing polymer and a fluorine-containing curable monomer is particularly preferred, because all of the performances above can be satisfied at a high level.

### [Structure of Antireflection Film]

The antireflection film of the present invention is an antireflection film obtained by the above-described method.

By virtue of having, in order, a step of applying the coating composition of the present invention on a base material to form a coating film, a step of drying the coating film to volatilize the solvent therefrom, and a step of curing the coating film to form a cured layer, a cured film having substantially a two-layer structure is obtained. The two layers created by the separation consist of a low refractive index layer formed by uneven distribution of the component (B) to the air interface side and a high refractive index layer in which other constituent components are present. In the present invention, it is preferred that the low refractive index layer is configured to have, as the main component, the component (B) and a component derived from the component (A) and the high refractive index layer is configured to have, as the main component, a component derived from the component (C). In the present invention, the components (A) and (B) are preferably present in the low refractive index layer in a concentration of 1.5 times or more the average density of the entire coating film layer formed of the coating composition of the present invention. The concentration is more preferably 2.0 times or more, and most preferably from 3.0 to 200 times. Also, in the low refractive index layer, the component (B) is preferably present at a density of 20 to 90 vol %, more preferably from 30 to 80 vol %, and most preferably from 40 to 70 vol %.

The multilayer structure having different refractive indexes in the cured film obtained by coating the composition above is a structure consisting of at least two layers, that is, a low refractive index layer formed by uneven distribution of the component (B) to the air interface side and a high refractive index layer in which other constituent components are present, and may contain a layer in which constituents components are mixed (for example, a layer in which a component derived from the component (A) and a component derived from the component (C) are mixed, a layer in which the component (B) and a component derived from the component (C) are mixed, or a layer in which a component derived from the component (A), the component (B) and a component derived from the component (C) are mixed) near the interface of two layers above within the range substantially not impairing the performance.

The component derived from the component (E) for use in the present invention is preferably present in the layer created by uneven distribution of the component (B) and the component (A).

The multilayer structure of the cured film as the antireflection film of the present invention can be confirmed, for example, by cross-sectional TEM observation of the film obtained or by C60 sputtering and ESCA observation. In the cross-sectional TEM, the in-film distribution state of the component (B) can be observed, and in the C60 sputtering and ESCA, the composition distribution of the components derived from the components (A), (C) and (E) in the film thickness direction can be acquired by analyzing the intensity ratio of fluorine atom or silicon atom in the depth (film thickness) direction.

For example, it can be observed by cross-sectional TEM that the component (B) is abundantly present on the air interface side, and can be observed by C60 sputtering and ESCA that a layer in which a fluorine or silicon atom abundantly exists is present on the air interface side, the amount of fluorine or silicon atom starts decreasing at a depth corresponding to a film thickness of 10 to 100 nm from the surface on the air interface side, and a region in which a fluorine or silicon atom is substantially not detected is present deeper than 300 nm.

When the coating composition of the present invention is applied and dried, the component derived from the component (A) and the component (C) with the free energy of mixing being zero or more undergo phase separation to start separating from each other. At this time, the component derived from the component (A) contains a fluorine component or silicone component having a low surface energy and therefore, is unevenly distributed to the hydrophobic interface (air interface) and the component (B) covered with the component derived from the component (A) is unevenly distributed upward at the same time, whereby a layer in which substantially the component (B) and the component derived from the component (A) are unevenly distributed can be formed. Both the component (B) and the component derived from the component (A) are a low refractive index material, so that a low refractive index layer can be formed as the upper layer (the air interface side). At the same time, the component (C) is unevenly distributed in the lower layer (the base material interface side), so that a layer composed of, as the main component, substantially the component derived from the component (C) can be formed. The component derived from the component (C) is a high refractive index material compared with the component (B) and the component derived from the component (A) and therefore, a high refractive index layer can be formed, producing a refractive index difference, whereby an antireflection ability can be obtained.

Uneven upward distribution of particles not only enhances the scratch resistance but also reduces the amount used and this is advantageous in view of cost.

In addition, when the component (E) having a low surface energy similarly to the component (A) is used, the component (E) is unevenly distributed upward and a layer in which substantially the component (B), a component derived from the component (A) and a component derived from the component (E) are unevenly distributed can be formed. The component (E) is a curable fluorine polymer or monomer and therefore, endows the antireflection film with excellent scratch resistance, and furthermore, a surface state improving effect is produced.

The film thickness of the low refractive index layer produced through a step of applying the coating composition of the present invention on a base material to form a coating film, a step of drying the coating film to volatilize the solvent therefrom, and a step of curing the coating film to form a cured layer indicates, in the cross-sectional TEM photograph of the coating film, the region where the inorganic fine particle as the component (B) is present in a concentration of 1.5 times or more the average density of the entire coating film formed of the coating composition of the present invention, and the film thickness is preferably from 40 to 300 nm, more preferably from 50 to 200 nm, still more preferably from 60 to 150 nm.

The film thickness of the high refractive index layer comprising the component (C) as the main component and being produced through a step of applying the coating composition of the present invention on a base material to form a coating film, a step of drying the coating film to volatilize the solvent therefrom, and a step of curing the coating film to form a cured layer is calculated as a value obtained by subtracting the film thickness of the low refractive index layer from the entire thickness determined by cross-sectional TEM and is preferably from 100 to 20,000 nm, more preferably from 300 to 10,000 nm, still more preferably from 500 to 8,000 nm. The film thickness is determined by optical fitting based on the reflectance measured in the specular reflectance measurement or by cross-sectional TEM observation. The high refractive index layer comprising the component (C) as the main component is preferably imparted with a hardcoat performance. For example, the component (C) is preferably esters of a polyhydric alcohol with a (meth)acrylic acid are preferred, and a polyfunctional monomer having three or more (meth)acryloyl groups per molecule is more preferred.

In the antireflection film of the present invention, the refractive index of the low refractive index layer in which the component (B) is unevenly distributed is preferably from 1.15 to 1.48, more preferably from 1.20 to 1.45, still more preferably from 1.30 to 1.40. If the refractive index is too high, this causes reduction in the antireflection ability, whereas if it is excessively low, this causes reduction in the scratch resistance.

In the antireflection film of the present invention, the refractive index of the high refractive index layer comprising, as the main component, a component derived from the component (C) is preferably from 1.48 to 1.80, more preferably from 1.48 to 1.70, still more preferably from 1.50 to 1.60.

At the time of applying the coating composition on a base material, the layer having the above-described multilayer structure is of course designed to have an optimal refractive index and an optimal film thickness and in order to more reduce the reflectance, for example, a medium refractive index layer, an antistatic functional layer for preventing dust adhesion, a hardcoat layer for imparting physical strength, an antiglare layer for imparting antiglare property may be provided according to the purpose.

In the case of producing the antireflection film by the production method of the present invention, the antireflection film may be produced by using a transparent film base material as the base material and applying the coating composition of the present invention. In this case, examples of the preferred embodiment ensuring good performance in the optical characteristics, physical characteristics and the like include configurations of [film base material/high refractive index layer/low refractive index layer], [film base material/hardcoat layer/high refractive index layer/low refractive index layer], [film base material/undercoat layer/high refractive index layer/low refractive index layer], [film base material/electrically conductive layer/high refractive index layer/low refractive index layer], [film base material/interference unevenness preventing layer/high refractive index layer/low refractive index layer], [film base material/light-diffusing layer/high refractive index layer/low refractive index layer], and [film base material/adherence layer/high refractive index layer/low refractive index layer].

### [Base Material]

The base material which can be used in the present invention may be any base material as long as various layers can be stacked thereon, but in view of continuous conveyance leading to high productivity, a film base material is preferred.

The film base material is not particularly limited as long as it has an excellent visible light transmittance (preferably a light transmittance of 90% or more) and excellent transparency (preferably a haze value of 1% or less). Specific examples thereof include a film composed of a transparent polymer such as polyester-based polymer (e.g., polyethylene terephthalate, polyethylene naphthalate), a cellulose-based polymer (e.g., diacetyl cellulose, triacetyl cellulose), polycarbonate-based polymer and acrylic polymer (e.g., polymethyl methacrylate); a film composed of a transparent polymer such as styrene-based polymer (e.g., polystyrene, acrylonitrile.styrene copolymer), olefin-based polymer (e.g., polyethylene, polypropylene, cyclic or norbornene structure-containing polyolefin, ethylene-propylene copolymer), vinyl chloride-based polymer, and amide-based polymer (e.g., nylon, aromatic polyamide); and a film composed of a transparent polymer such as imide-based polymer, sulfone-based polymer, polyethersulfone-based polymer, polyether ketone-based polymer, polyphenylene sulfide-based polymer, vinyl alcohol-based polymer, vinylidene chloride-based polymer, vinyl butyral-based polymer, acrylate-based polymer, polyoxymethylene-based polymer, epoxy-based polymer and a blend of the polymers above. In particular, optically, those having a low birefringence are suitably used.

The thickness and width of the film base material can be appropriately determined. By taking into account, for example, the workability such as strength and handling and the thin-film property, the thickness of the film base material is generally on the order of 10 to 500 μm, preferably from 20 to 300 μm, more preferably from 30 to 200 μm. The width of the film base material is suitably from 100 to 5,000 mm, preferably from 800 to 3,000 mm, more preferably from 1,000 to 2,000 mm. Furthermore, the refractive index of the film base material is not particularly limited and is usually on the order of 1.30 to 1.80, preferably from 1.40 to 1.70.

The surface of the base material is preferably smooth, and the average roughness Ra value is preferably 1 μm or less and preferably from 0.0001 to 0.5 μm, more preferably from 0.001 to 0.1 μm.

### [Production Method of Antireflection Film]

The antireflection film of the present invention can be produced through a step of applying the coating composition, a step of drying the coating and a step of curing the coating. As described above, by using a film base material, the coating, drying and curing steps can be continuously performed, and high productivity can be realized. At this time, the obtained laminate is a film-like laminate, that is, an antireflection film is produced. Respective steps are described below. Incidentally, the production method of the present invention may contain other steps, in addition to the above-described steps.

### (Coating Step)

As the coating method in the production method of the present invention, for example, a known method such as dip coating method, air knife coating method, curtain coating method, roller coating method, wire bar coating method, gravure coating method, extrusion coating method (die coating method) (see, U.S. Pat. No. 2,681,294) and microgravure coating method, is used. Among these, a microgravure coating method and a die coating method are preferably used in view of productivity and uniformity of the coating film.

### [Step for Extrusion on Support by Using Slot Die]

For supplying the film of the present invention at high productivity, an extrusion method (die coating method) is preferably used. In particular, with respect to the die coater preferably usable in a region having a small wet coated amount (20 ml/m² or less), such as hardcoat layer and antireflection layer, for example, JP-A-2007-293313 can be referred to, and the same applies to the present invention.

### (Drying Step)

In the production method of the present invention, after applying the coating composition of the present invention on a base material, the web is conveyed to a heated zone for drying the solvent. The temperature in the drying zone is preferably from 0 to 140° C., more preferably from 10 to 120° C. It is also suitable to set, for example, a relatively low temperature in the first half of the drying zone and a relatively high temperature in the latter half. However, the temperature must be set to be lower than the temperature at which components other than the solvent contained in the coating composition start volatilizing. The drying step is not restricted except for this preferred drying condition, and a method usable for normal drying after coating can be employed.

### (Curing Method)

In the present invention, the laminate after coating and drying can be cured by ultraviolet irradiation and/or heat. Here, curing by ultraviolet irradiation indicates curing the film by irradiating the dried film with an ultraviolet ray by the use of a low-pressure mercury lamp, a medium-pressure mercury lamp, a high-pressure mercury lamp, an ultrahigh-pressure mercury lamp, a carbon arc lamp, a metal halide lamp, a xenon lamp or a light source such as ArF excimer laser, KrF excimer laser, excimer lamp and synchrotron radiation light.

The irradiation conditions vary depending on the lamp, but the irradiation dose is preferably from 20 to 10,000 mJ/cm², more preferably from 100 to 2,000 mJ/cm², still more preferably from 150 to 1,000 mJ/cm².

In the case of curing by ultraviolet ray, the layers may be irradiated one by one, or the layers may be stacked and then irradiated. For the purpose of encouraging the surface curing at the ultraviolet irradiation, the oxygen concentration may be reduced by purging with a nitrogen gas or the like. The oxygen concentration in the environment where curing is performed is preferably 5% or less. In the case where the topmost layer forms a low refractive index layer as in the antireflection film of the present invention, the oxygen concentration is preferably 0.1% or less, more preferably 0.05% or less, and most preferably 0.02% or less.

The laminate obtained by the production method of the present invention preferably has a particle-containing layer. Also, the laminate preferably has an antireflection function.

### [Hardcoat Layer]

In the antireflection film of the present invention, a hardcoat layer may be provided on one surface of the base material so as to impart physical strength.

From the standpoint of imparting satisfactory durability and impact resistance as well as in view of curling, productivity and cost, the film thickness of the hardcoat layer is generally on the order of 0.5 to 50 μm, preferably from 1 to 30 μm, more preferably from 2 to 20 μm, and most preferably from 3 to 15 μm.

The strength of the hardcoat layer is preferably H or more, more preferably 2H or more, still more preferably 3H or more, and most preferably 5H or more, in the pencil hardness test.

Furthermore, in the Taber test according to JIS K5400, the abrasion loss of the specimen between before and after test is preferably smaller.

In view of optical design, reflectance, color tint, unevenness and cost, the refractive index of the hardcoat layer is preferably from 1.48 to 1.75, more preferably from 1.49 to 1.65, still more preferably from 1.50 to 1.55.

In the case of imparting an antiglare function by the surface scattering of the hardcoat layer, the surface haze (a value obtained by subtracting the internal haze value from the entire haze value; the internal haze value can be measured by eliminating unevenness on the film surface with a substance having the same refractive index as that of the film surface) is preferably from 0.1 to 20%, more preferably from 0.2 to 5%, still more preferably from 0.2 to 2%. If the surface haze is too large, the bright-room contrast is impaired, whereas if it is excessively small, disturbing reflection is increased.

Also, in the case of imparting internal scattering by incorporating a light-transmitting particle into the hardcoat layer, the preferred internal haze value may vary depending on the purpose, but the internal haze value when imparting a function of making less perceivable the liquid crystal panel pattern, color unevenness, brightness unevenness, glaring or the like by the effect of internal scattering or enlarging the viewing angle by the scattering is preferably from 0 to 60%, more preferably form 1 to 40%, still more preferably from 10 to 35%. If the internal haze is too large, the front contrast is reduced and a light-brownish appearance is intensified, whereas if it is excessively small, the combination of usable materials is limited, making it difficult to combine the antiglare property and other characteristic values, and also the cost rises. On the other hand, in the case where the front contrast is important, the internal haze value is preferably from 0 to 30%, more preferably from 1 to 20%, and most preferably from 1 to 10%.

As for the concavoconvex shape of the hardcoat layer surface, the centerline average roughness (Ra) is preferably set to 0.30 μm or less. Ra is more preferably from 0.01 to 0.20 μm, still more preferably from 0.01 to 0.12 μm. If Ra is large, there may arise a problem that white-blurring ascribable to surface scattering may occur or the layer formed on the hardcoat layer can hardly have uniformity.

### [Electrically Conductive Layer]

In the antireflection film of the present invention, an electrically conductive layer may be provided for antistatic purpose and thanks to the electrically conductive layer, the antireflection film surface can be prevented from dust adhesion. The electrically conductive layer may be provided as a single layer separately from each layer, or any of the layers stacked may be provided as a dual-purpose layer serving also as the electrically conductive layer.

The film thickness of the electrically conductive layer is preferably from 0.01 to 10 μm, more preferably from 0.03 to 7 μm, and most preferably from 0.05 to 5 μm. The surface resistance SR (Ω/sq) of the electrically conductive layer is, in terms of logSR, preferably from 5 to 12, more preferably from 5 to 11, and most preferably from 6 to 10. The surface resistance of the electrically conductive layer may be measured by a known measuring method and, for example, can be measured by a four-probe method.

### (Interference Unevenness Preventing Layer)

In the antireflection film of the present invention, an interference unevenness preventing layer can be provided for the purpose of preventing interference unevenness, and thanks to this layer, interference unevenness on the antireflection film surface can be prevented. The interference unevenness is produced by reflected light interference due to a refractive index difference between the base material and the layer (for example, hardcoat layer) coated on the base material and the resulting change in color tint according to the film thickness unevenness, and in order to prevent this problem, there is a method of continuously changing the refractive index between the base material and the layer coated on the base material, thereby preventing interference unevenness (see, for example, JP-A-2003-205563 and JP-A-2003-131007). Such an interference unevenness preventing layer may be provided on the base material layer.

### [Polarizing Plate Protective Film]

In the case of using the antireflection film of the present invention for a liquid crystal display device, the antireflection film is used as a surface protective film of a polarizing film at the preparation of a polarizing plate (polarizing plate protective film) and therefore, the adhesiveness to the polarizing film comprising polyvinyl alcohol as the main component is preferably improved by hydrophilizing the transparent support surface on the side opposite the side having a low refractive index layer, that is, the surface on the side to be laminated with the polarizing film.

As the film base material in the antireflection film, a triacetyl cellulose film is preferably used. As regards the technique for producing the polarizing plate protective film of the present invention, two techniques may be considered, that is, (1) a technique of coating and providing each of the above-described layers (e.g., hardcoat layer, medium refractive index layer, surface two layers) on one surface of a previously saponified transparent support, and (2) a technique of coating and providing respective layers described above on one surface of a transparent support and saponifying the surface on the side to be laminated with the polarizing film. In (1), the surface to be coated with a hardcoat is also hydrophilized and the adherence between the support and the hardcoat layer can be hardly ensured. Therefore, the technique of (2) is preferred.

### [Saponification Treatment]

### (1) Dipping Method

This is a technique of dipping the antireflection film in an alkali solution under appropriate conditions to saponify all the surface having reactivity with an alkali on the entire film surface. This method requires no special equipment and is preferred in view of cost. The alkali solution is preferably an aqueous sodium hydroxide solution. The concentration is preferably from 0.5 to 3 mol/liter, more preferably from 1 to 2 mol/liter. The liquid temperature of the alkali solution is preferably from 30 to 70° C., more preferably from 40 to 60° C.

The combination of the saponification conditions is preferably a combination of relatively mild conditions but may be selected according to the material or configuration of the antireflection film or the target contact angle.

The film after dipping in an alkali solution is preferably well washed with water or dipped in a dilute acid to neutralize the alkali component so as to prevent the alkali component from remaining in the film.

By the saponification treatment, the transparent support surface opposite the surface having an antireflection layer is hydrophilized. The polarizing plate protective film is used by adhering the hydrophilized surface of the transparent support to the polarizing film.

The hydrophilized surface is effective for improving the adhesiveness to the adhesive layer comprising polyvinyl alcohol as the main component.

In the saponification treatment, the contact angle for water on the transparent support surface opposite the surface having a low refractive index layer is preferably lower in view of adhesiveness to the polarizing film, but, on the other hand, according to the dipping method, the surface having a low refractive index layer is also damaged by an alkali and therefore, it is important to select minimum necessary reaction conditions. In the case of using, as an index for damage of the antireflection layer by an alkali, the contact angle for water of the transparent support surface on the side opposite the surface having an antireflection structure layer, that is, the lamination surface of the antireflection film, particularly when the support is triacetyl cellulose, the contact angle is preferably from 20 to 500, more preferably from 30 to 50°, still more preferably from 40 to 500. When the contact angle is 50° or less, excellent adhesiveness to the polarizing film is obtained and this is preferred, and when the contact angle is 20° or more, the antireflection film is little damaged and the physical strength and light fastness are advantageously not impaired and this is preferred.

### (2) Alkali Solution Coating Method

In order to avoid the damage of the antireflection film in the dipping method, an alkali solution coating method of coating an alkali solution only on the surface opposite the surface having an antireflection layer under appropriate conditions, and subjecting the film to heating, water washing and drying, is preferably used. In this case, the “coating” means to contact an alkali solution or the like only with the surface to be saponified. At this time, the saponification treatment is preferably performed such that the contact angle for water of the lamination surface of the antireflection film becomes from 10 to 50°. Other than the coating, this method includes spraying or contact with a belt or the like impregnated with the solution. When such a method is employed, equipment and step for coating the alkali solution are separately required and therefore, this method is inferior to the dipping method of (1) in view of the cost. However, since the alkali solution comes into contact only with the surface to be saponified, the film may have a layer using a material weak to an alkali solution on the opposite surface. For example, a vapor deposition film or a sol-gel film is subject to various effects such as corrosion, dissolution and separation by an alkali solution and is not preferably provided in the dipping method, but in this coating method, such a film does not contact with the solution and therefore, can be used without problem.

The saponification methods (1) and (2) either can be performed after unrolling a roll-form support and forming respective layers and therefore, the treatment may be added after the production process above and performed in a series of operations. Furthermore, by continuously performing a step of laminating the film to a polarizing plate comprising a support which is unrolled similarly, a polarizing plate can be produced with higher efficiency than in the case of performing the same operations in the sheet-fed manner.

### [Polarizing Plate]

The polarizing plate of the present invention has a polarizing film and the above-described antireflection film as a protective film protecting at least either the front side or the back side of the polarizing film. In a preferred embodiment, the polarizing plate of the present invention is a laminate plate having two protective films protecting both surfaces of the polarizing film and at least one of the protective films is the antireflection film.

The polarizing plate has the antireflection film as at least one protective film of the polarizing film (polarizing plate protective film). The transparent support of the antireflection film is adhered to the polarizing film through an adhesive layer composed of polyvinyl alcohol, and another protective film of the polarizing film is adhered, through an adhesive layer, to the principal surface of the polarizing film opposite the principal surface adhering to the antireflection film. The polarizing plate has an adhesive layer on the principal surface of the another protective film opposite the principal surface adhering to the polarizing film.

By using the antireflection film of the present invention as a polarizing plate protective film, a polarizing plate having physical strength and an excellent antireflection function can be produced, and the cost can be greatly reduced.

Also, by producing a polarizing plate using the antireflection film of the present invention for one polarizing plate protective film and using the later-described optically compensatory film having optical anisotropy for another protective film of the polarizing film, a polarizing plate capable of improving the bright-room contrast of a liquid crystal display device and greatly broadening the viewing angle in the vertical, horizontal and oblique directions can be manufactured.

### [Image Display Device]

Examples of the image display devices having the antireflection film of the present invention include a liquid crystal display device (LCD), a plasma display panel (PDP), an electroluminescent display (OLED), cathode ray tube display (CRT), field emission display (FED) and surface-conduction electron-emitter display (SED). Above all, the antireflection film of the present invention is preferably used as the surface film of a liquid crystal panel screen. Examples of the image display device including a polarizing plate having the antireflection film of the present invention include an image display device such as liquid crystal display device (LCD) and electroluminescent display (OLED). In the image display device of the present invention, a polarizing plate having the antireflection film of the present invention is used by adhering the polarizing plate to glass of the liquid crystal cell of a liquid crystal display device, directly or through another layer.

The polarizing plate using the antireflection film of the present invention can be preferably used in a transmissive, reflective or transflective liquid crystal display device in a mode such as twisted nematic (TN), super-twisted nematic (STN), vertical alignment (VA), in-plane switching (IPS) and optically compensated bend cell (OCB).

In the case of use for a transmissive or transflective liquid crystal display device, the polarizing plate is used in combination with a commercially available brightness enhancing film (a polarization separation film having a polarization selection layer, for example, D-BEF produced by Sumitomo 3M Limited), whereby a display device having higher visibility can be obtained.

Also, when combined with a λ/4 plate, the polarizing plate can be used as a polarizing plate for reflective liquid crystal display or a surface protective plate for OLED so as to reduce reflected light from the surface and the inside.

### EXAMPLES

The present invention is described in greater detail below by referring to Examples, but the present invention should not be construed as being limited thereto. Unless otherwise indicated, the “parts” and “%” are a value on the mass basis.

### Example 1

### Production of Base Material with Undercoat Layer

### [Preparation of Coating Solution (Sub-1) for Undercoat Layer]

Respective components were mixed according to the formulation shown in Table 5 below, and the solution obtained was adjusted to a solid content concentration of 40 mass % with a MEK (methyl ethyl ketone)/MIBK (methyl isobutyl ketone)cyclohexane=45/45/10 (by mass) solvent and filtered through a polypropylene-made filter having a pore size of 30 μm to prepare a coating solution of undercoat layer.

TABLE 5

| | Coating Solution Sub-1 |
|---|---|
| Binder | DPCA-20/40 parts by mass |
| Polymerization initiator | Irgacure 184/2 pars by mass |
| Silica sol | MIBK-ST/10 parts by mass (as solid) |

The compounds used above are as follows.
DPCA-20:
Partially caprolactone-modified polyfunctional acrylate [produced by Nippon Kayaku Co., Ltd.]
Silica sol:
A liquid dispersion using MIBK-ST and MIBK solvents and having a solid content concentration of 30%, silica fine particle having an average particle size of about 15 nm, refractive index: 1.45 [produced by Nissan Chemicals Industries, Ltd.]
Irgacure 184:
Polymerization initiator [produced by Ciba Specialty Chemicals Corp.]

### [Formation of Undercoat Layer]

Coating Solution (Sub-1) for undercoat layer was coated on a triacetyl cellulose film TAC-TD80U (produced by Fujifilm Corp.) having a thickness of 80 μm and a width of 1,340 mm by a die coater under the condition of a conveying speed of 30 m/min and then dried at 60° C. for 150 seconds and thereafter, under purging with nitrogen (oxygen concentration: 0.5% or less), the coated layer was cured by irradiation with an ultraviolet ray at an illuminance of 400 mW/cm² and an irradiation dose of 150 mJ/cm² by using an air-cooled metal halide lamp (manufactured by Eye Graphics Co., Ltd.) of 160 W/cm to form an undercoat layer such that the film thickness becomes 6 μm after curing. The thus-obtained Triacetyl Cellulose Film (TAC-1) with undercoat layer was the base material used later for evaluations of the coating composition

### [Preparation of Hollow Silica Particle Liquid Dispersion S-1]

Parts by mass of γ-acryloyloxypropyltrimethoxysilane, 1.51 parts by mass of diisopropoxyaluminum ethyl acetate and 500 parts by mass of methyl ethyl ketone were added to and mixed with 500 parts by mass of Hollow Silica Fine Particle Sol A (isopropyl alcohol silica sol, average particle diameter: 40 nm, silica concentration: 20%, refractive index of silica particle: 1.30), and then 3 parts by mass of ion-exchanged water was added thereto. After reacting this mixed solution at 60° C. for 8 hours, the resulting reaction solution was cooled to room temperature, and 1.8 parts by mass of acetyl acetone was added to obtain a liquid dispersion. Thereafter, while adding cyclohexanone to keep the silica content almost constant, solvent replacement by reduced-pressure distillation was performed under a pressure of 30 Torr and by finally adjusting the concentration, Hollow Silica Particle Liquid Dispersion S-1 having a solid content concentration of 21.7% (silica concentration: 20%) and being surface-modified with an organosilane compound having a polymerizable functional group was obtained.

### [Preparation of Hollow Silica Particle Liquid Dispersion S-2]

While adding cyclohexanone to Hollow Silica Fine Particle Sol A (isopropyl alcohol silica sol, average particle diameter: 40 nm, silica concentration: 20%, refractive index of silica particle: 1.30) so as to keep the silica content almost constant, solvent replacement by reduced-pressure distillation was performed under a pressure of 30 Torr to obtain Hollow Silica Particle Liquid Dispersion S-2 having a silica concentration of 20%.

### [Production of Coating Composition for Two-Layer Configuration by One-Liquid Coating]

As the component (A), 2.0 parts by mass of EPF-1 was dissolved in a 80/10 (by mass) mixed solvent of MEK/PGME (propylene glycol monomethyl ether) to account for 20 mass %. The component (A) was mixed with 2.0 parts by mass in terms of the solid content (as the solution, 9.22 parts by mass) of Hollow Silica Liquid Dispersion S-1 as the component (B), and the mixture was treated with a solvent of MEK/PGME (propylene glycol monomethyl ether)/cyclohexane in a ratio of 80/10/10 (by mass) to make a solution having a solid content concentration of 5 mass %. Thereto, 60 parts by mass of DPHA as the component (C) and 2.0 parts by mass of Irgacure 127 as a photopolymerization initiator were mixed, and the mixture was adjusted to a solid content concentration of 13% with the same solvent composition to obtain Coating Composition (Comp-1) of the present invention.

Respective components were mixed as shown in Table 6 below in the same manner as (Comp-1) to produce a coating composition having a solid content of 13 mass %. In Table 6, the amount added of each component indicates “parts by mass”. The amount added of the inorganic fine particle as the component (B) is the parts by mass of the solid content excluding the solvent.

TABLE 6

| | Component A | | Component B | | Component C | | | Component E | | Initiator | | | |
|---|---|---|---|---|---|---|---|---|---|---|---|---|---|
| | | Amount | | Amount | | Amount | Component D | | Amount | | Amount | | |
| | Kind | Added | Kind | Added | Kind | Added | Kind | Kind | Added | Kind | Added | ΔG | Remarks |
| Comp-1 | EPF-1 | 2.0 | S-1 | 2.0 | DPHA | 60 | MEK/PGME/ | — | — | Irg. 127 | 2.0 | 0.042 | Invention |
| | | | | | | | cyclohexanone = | | | | | | |
| | | | | | | | 80/10/10 | | | | | | |
| Comp-2 | EPF-2 | 2.0 | S-1 | 2.0 | DPHA | 60 | MEK/PGME/ | — | — | Irg. 127 | 2.0 | 0.021 | Invention |
| | | | | | | | cyclohexanone = | | | | | | |
| | | | | | | | 80/10/10 | | | | | | |
| Comp-3 | EPF-3 | 2.0 | S-1 | 2.0 | DPHA | 60 | MEK/PGME/ | — | — | Irg. 127 | 2.0 | 0.022 | Invention |
| | | | | | | | cyclohexanone = | | | | | | |
| | | | | | | | 80/10/10 | | | | | | |
| Comp-4 | EPF-4 | 2.0 | S-1 | 2.0 | DPHA | 60 | MEK/PGME/ | — | — | Irg. 127 | 2.0 | 0.021 | Invention |
| | | | | | | | cyclohexanone = | | | | | | |
| | | | | | | | 80/10/10 | | | | | | |
| Comp-5 | EPF-8 | 2.0 | S-1 | 2.0 | DPHA | 60 | MEK/PGME/ | — | — | Irg. 127 | 2.0 | 0.021 | Invention |
| | | | | | | | cyclohexanone = | | | | | | |
| | | | | | | | 80/10/10 | | | | | | |
| Comp-6 | EPF-9 | 1.0 | S-1 | 2.0 | DPHA | 60 | MEK/PGME/ | P-3 | 1.0 | Irg. 127 | 2.0 | 0.022 | Invention |
| | | | | | | | cyclohexanone = | | | | | | |
| | | | | | | | 80/10/10 | | | | | | |
| Comp-7 | EPF-11 | 1.0 | S-1 | 2.0 | DPHA | 60 | MEK/PGME/ | p-3 | 1.0 | Irg. 127 | 2.0 | 0.022 | Invention |
| | | | | | | | cyclohexanone = | | | | | | |
| | | | | | | | 80/10/10 | | | | | | |
| Comp-8 | EPF-13 | 2.0 | S-1 | 2.0 | DPHA | 60 | MEK/PGME/ | — | — | Irg. 127 | 2.0 | 0.021 | Invention |
| | | | | | | | cyclohexanone = | | | | | | |
| | | | | | | | 80/10/10 | | | | | | |
| Comp-9 | EPF-4 | 2.0 | S-2 | 2.0 | DPHA | 60 | MEK/PGME/ | — | — | Irg. 127 | 2.0 | 0.021 | Invention |
| | | | | | | | cyclohexanone = | | | | | | |
| | | | | | | | 80/10/10 | | | | | | |
| Comp-10 | EPF-4 | 2.0 | MEK- | 2.0 | DPHA | 60 | MEK/PGME/ | — | — | Irg. 127 | 2.0 | 0.021 | Invention |
| | | | ST-L | | | | cyclohexanone = | | | | | | |
| | | | | | | | 80/10/10 | | | | | | |
| Comp-11 | A-1 for | 2.0 | S-1 | 2.0 | DPHA | 60 | MEK/PGME/ | — | — | Irg. 127 | 2.0 | −0.002 | Comparative |
| | Com- | | | | | | cyclohexanone = | | | | | | Example |
| | parison | | | | | | 80/10/10 | | | | | | |
| Comp-12 | P-14 | 2.0 | S-1 | 2.0 | DPHA | 60 | MEK/PGME/ | — | — | Irg. 127 | 2.0 | 0.006 | Comparative |
| | | | | | | | cyclohexanone = | | | | | | Example |
| | | | | | | | 80/10/10 | | | | | | |
| Ln-1 | EPF-4 | 2.0 | S-1 | 2.0 | — | — | MEK/PGME/ | — | — | Irg. 127 | 0.06 | — | Comparative |
| | | | | | | | cyclohexanone = | | | | | | Example |
| | | | | | | | 80/10/10 | | | | | | |
| Ln-2 | EPF-4 | 2.0 | MEK- | 2.0 | — | — | MEK/PGME/ | — | — | Irg. 127 | 0.06 | — | Comparative |
| | | | ST-L | | | | cyclohexanone = | | | | | | Example |
| | | | | | | | 80/10/10 | | | | | | |
| HC-1 | — | — | — | — | DPHA | 60 | MEK/PGME/ | — | — | Irg. 127 | 2.0 | — | Comparative |
| | | | | | | | cyclohexanone = | | | | | | Example |
| | | | | | | | 80/10/10 | | | | | | |

The compounds used above are as follows.
DPHA: A mixture of dipentaerythritol pentaacrylate and dipentaerythritol hexaacrylate (produced by Nippon Kayaku Co., Ltd.)
IRGACURE 127: A photopolymerization initiator [produced by Ciba Specialty Chemicals Corp.]
MEK-ST-L: A silica liquid dispersion having an average particle size of about 45 nm, solvent: MEK (produced by Nissan Chemicals Industries, Ltd.), refractive index of silica particle = 1.45
A-1 for Comparison: A compound having a basic functional group not containing a fluorine-containing hydrocarbon structure and a polysiloxane structure (a polymer where in (EPF-2), a structural unit derived from an HFP monomer is replaced by a structural unit derived from an EVE monomer, mass average molecular weight: 25,000)
P-14: Compound exemplified as the fluorine-containing polymer of the component (E) for use in the present invention (not containing a basic functional group in the molecule)

### [Formation of Laminate]

Coating Composition Comp-1 was coated on the undercoat layer of Base Material TAC-1 by a die coater under the condition of a conveying speed of 30 m/min and then dried at 60° C. for 150 seconds and thereafter, under purging with nitrogen (oxygen concentration: 0.1% or less), the coated layer was cured by irradiation with an ultraviolet ray at an illuminance of 400 mW/cm² and an irradiation dose of 400 mJ/cm² by using an air-cooled metal halide lamp (manufactured by Eye Graphics Co., Ltd.) of 160 W/cm to form Laminate 101 such that the film thickness becomes 1.6 μm after curing. With respect to other coating compositions (Comp-2 to Comp-12) in the Table, Laminates 102 to 112 were produced in the same manner. At this time, the coated amount was adjusted in steps of 10% in the range of ±40% so that the minimal wavelength of the reflectance could become from 520 to 560 nm in the measurement of reflectance later.

Also, as the laminate for comparison, Coating Solution (HC-1) for hardcoat layer was coated on Base Material TAC-1 by a die coater under the condition of a conveying speed of 30 m/min and then dried at 60° C. for 150 seconds and thereafter, under purging with nitrogen (oxygen concentration: 0.1% or less), the coated layer was cured by irradiation with an ultraviolet ray at an illuminance of 400 mW/cm² and an irradiation dose of 400 mJ/cm² by using an air-cooled metal halide lamp (manufactured by Eye Graphics Co., Ltd.) of 160 W/cm to form a hardcoat layer such that the film thickness becomes 1.5 μm after curing. Furthermore, Coating Solution Ln-1 for low refractive index layer was coated thereon by a die coater under the condition of a conveying speed of 30 m/min and then dried at 60° C. for 150 seconds and thereafter, under purging with nitrogen (oxygen concentration: 0.1% or less), the coated layer was cured by irradiation with an ultraviolet ray at an illuminance of 400 mW/cm² and an irradiation dose of 400 mJ/cm² by using an air-cooled metal halide lamp (manufactured by Eye Graphics Co., Ltd.) of 160 W/cm to form Comparative Laminate 113 such that the film thickness becomes 95 nm after curing. Also, Sample 114 was produced by changing the coating solution for low refractive index layer to Ln-2 in Comparative Laminate 113.

### [Evaluation of Laminate]

With respect to the obtained laminates (antireflection films), the following evaluations and measurements were performed.

### [Uneven Distribution of Particle]

The antireflection film sample after curing was vertically cut in the thickness direction and the cross section was observed by a transmission electron microscope. The cross-sectional image was observed over 5 μm in the width direction, and the condition under which the inorganic fine particle was present was evaluated on the following 5-stage scale.

AA: The inorganic fine particle-containing layer was unevenly distributed upward and the thickness unevenness thereof was less than 5%.

A: The inorganic fine particle-containing layer was unevenly distributed upward and the thickness unevenness thereof was from 5% to less than 10%.

B: The inorganic fine particle-containing layer was unevenly distributed upward, the thickness unevenness thereof was from 10% to less than 30%, and a part of the inorganic fine particle was present also in the lower layer.

C: The thickness unevenness of the inorganic fine particle-containing layer was 30% or more or the interface between the uneven distribution layer of the inorganic fine particle and the lower layer was ambiguous.

CC: The thickness unevenness of the inorganic fine particle-containing layer was 50% or more or the uneven distribution layer of the inorganic fine particle was substantially not formed.

### [Surface Failure]

A black PET film was laminated to the back surface (support side) of the antireflection film sample to prepare a sample for surface evaluation, where the back surface reflection was suppressed. The front surface side of the sample was irradiated with a 3-wavelength fluorescent lamp to have a surface illuminance of 500 lux. Only an area of 5 m² was inspected with an eye, the obtained value was divided by 5, and the occurrence frequency of surface failure attributable to the inorganic particle per 1 m² was evaluated according to the following criteria. Levels not lower than AB are preferred.

AA: From 0 to less than 0.1 failures.

A: From 0.1 to less than 0.2 failures.

AB: From 0.2 to less than 0.3 failures.

B: From 0.3 to less than 0.4 failures.

C: From 0.4 to less than 1.0 failures.

CC: 1.0 Failures or more.

### [Integrated Reflectance]

The back surface (support side) of the antireflection film sample was roughened with sand paper and then treated with black ink to eliminate the back surface reflection and in this state, the front surface side was measured for the integrated spectral reflectance at an incident angle of 5° in the wavelength region of 380 to 780 nm by using a spectrophotometer (manufactured by JASCO Corp.). For the result, the arithmetic mean value of the integrated reflectance at 450 to 650 nm was used.

### [Steel Wool Scratch Resistance]

A rubbing test was performed using a rubbing tester under the following conditions.

Environmental conditions of evaluation: 25° C. and 60% RH

### Rubbing Material:

A steel wool {No. 0000, manufactured by Nihon Steel Wool Co., Ltd.} was wound around the rubbing tip (1 cm×1 cm) of the tester, which comes into contact with the sample, and immovably fixed with a band, and a reciprocating rubbing motion was executed under the following conditions.

Moving distance (one way): 13 cm, Rubbing speed: 13 cm/sec
Load: 500 g/cm², Contact area of tip: 1 cm×1 cm
Number of rubbings: 10 reciprocations

An oily black ink was applied to the back side of the rubbed sample, and scratches in the rubbed portion were observed by reflected light with an eye and evaluated according to the following criteria.

A: Scratches were not observed at all even in very careful check.

AB: Weak scratches were slightly observed in very careful check.

B: Weak scratches were observed.

BC: Moderate scratches were observed.

C: Scratches were recognized at a glance.

When the scratch resistance is not lower than the level AB, the practical value is high.

### [Adherence]

The antireflection film sample was moisture-conditioned for 2 hours under the conditions of a temperature of 25° C. and 60 RH %. The surface on the side having the low refractive index layer of each sample was incised with a cutter knife to form 11 longitudinal lines and 11 transverse lines in a grid pattern and thereby define 100 squares in total, and a polyester pressure-sensitive adhesive tape (No. 31B) produced by Nitto Denko Corp. was adhered to the surface. After passing of 30 minutes, the tape was swiftly peeled off, and the number of peeled-off squares was counted and evaluated according to the following 4 criteria.

The same adherence evaluation was performed three times, and the average thereof was employed.

AA: Peeling off was not recognized at all in 100 squares.

A: Peeling off of one or two squares was recognized in 100 squares.

B: Peeling off of 3 to 10 squares was recognized in 100 squares (within an acceptable range).

C: Peeling off of 11 or more squares was recognized in 100 squares.

### [Calculation Method of Film Thickness]

The antireflection film sample after curing was vertically cut in the thickness direction, the cross section was observed by a transmission electron microscope, and the region where the inorganic fine particle as the component (B) was present in a concentration of 1.5 times or more the average density of the entire coating film layer formed of the coating composition of the present invention, was calculated. Also, the film thickness of the high refractive index layer comprising, as the main component, a component derived from the component (C) was calculated as a value obtained by subtracting the film thickness of the low refractive index layer from the entire film thickness determined by cross-sectional TEM. In the case of having no low refractive index layer, the thickness of the cured film is shown as the film thickness of the high refractive index layer.

The refractive indexes of the low refractive index layer and the high refractive index layer were calculated by optical fitting (least square method).

### [Calculation Method of Free Energy of Mixing]

As for the free energy of mixing (ΔG=ΔH−T·ΔS) of the component (A) and the component (C), the free energy of mixing (ΔG=ΔH−T·ΔS, wherein ΔH: enthalpy, ΔS: entropy, and T: absolute temperature) was determined by the Flory-Huggins's lattice theory. The calculation was executed using the polymerization degrees of the component (A) and the component (C), the volume fraction (φ; in publications, sometimes referred to as composition fraction), and the interaction parameter (χ) of the component (A) and the component (C).

The results are shown in Table 7.

TABLE 7

| | | | | | | Low Refractive | | High Refractive | | | | |
|---|---|---|---|---|---|---|---|---|---|---|---|---|
| | | | | | | Index Layer | | Index Layer | | | | |
| | | | Uneven | | Integrated | Re- | Film | Re- | Film | | | |
| Sample | Base | Coating | Distribution of | Surface | Reflect- | fractive | Thickness | fractive | Thickness | Scratch | Ad- | |
| No. | Material | Composition | Fine Particle | Failure | ance | Index | (nm) | Index | (μm) | Resistance | herence | Remarks |
| 101 | TAC-1 | Comp-1 | A | A | 1.6% | 1.37 | 96 | 1.53 | 1.5 | AB | A | Invention |
| 102 | TAC-1 | Comp-2 | A | A | 1.6% | 1.37 | 95 | 1.53 | 1.5 | A | AA | Invention |
| 103 | TAC-1 | Comp-3 | AA | A | 1.4% | 1.36 | 95 | 1.53 | 1.5 | A | AA | Invention |
| 104 | TAC-1 | Comp-4 | AA | A | 1.3% | 1.36 | 94 | 1.53 | 1.5 | A | AA | Invention |
| 105 | TAC-1 | Comp-5 | A | A | 1.6% | 1.36 | 95 | 1.52 | 1.5 | A | A | Invention |
| 106 | TAC-1 | Comp-6 | AA | A | 1.3% | 1.36 | 94 | 1.53 | 1.5 | A | AA | Invention |
| 107 | TAC-1 | Comp-7 | AA | A | 1.4% | 1.36 | 95 | 1.53 | 1.5 | A | AA | Invention |
| 108 | TAC-1 | Comp-8 | A | AB | 1.6% | 1.37 | 95 | 1.53 | 1.5 | AB | AA | Invention |
| 109 | TAC-1 | Comp-9 | A | AB | 1.7% | 1.37 | 94 | 1.52 | 1.5 | AB | AA | Invention |
| 110 | TAC-1 | Comp-10 | AA | A | 2.7% | 1.45 | 95 | 1.53 | 1.5 | A | AA | Invention |
| 111 | TAC-1 | Comp-11 | CC | A | 4.5% | — | — | 1.51 | 1.6 | A | AA | Comparative |
| | | | | | | | | | | | | Example |
| 112 | TAC-1 | Comp-12 | CC | A | 3.5% | — | — | 1.51 | 1.6 | AB | AA | Comparative |
| | | | | | | | | | | | | Example |
| 113 | TAC-1 | HC-1/Ln-1 | — | A | 1.3% | 1.36 | 95 | 1.53 | 1.5 | A | B | Comparative |
| | | | | | | | | | | | | Example |
| 114 | TAC-1 | HC-1/Ln-2 | — | A | 2.6% | 1.45 | 95 | 1.53 | 1.5 | A | B | Comparative |
| | | | | | | | | | | | | Example |

As seen from Table 7, in Samples 101 to 109 where a fine particle-containing layer is unevenly distributed upward and two layers differing in the composition are simultaneously formed by one coating, the production efficiency is high and compared with Sample 113 by sequential coating, excellent results are obtained, that is, the uneven distribution of particles is on the same level, the level of surface failure is not lower than AB, the integrated reflectance is 1.7% or less, the scratch resistance is not lower than AB, and the adherence is not lower than A. Also, in Samples 101 to 109 where a compound having at least one structure selected from a fluorine-containing hydrocarbon structure and a polysiloxane structure and having at least one basic functional group is used for the component (A), excellent results are obtained, that is, the uneven distribution of particles is not lower than A, the level of surface failure is not lower than AB, the integrated reflectance is 1.7% or less, the scratch resistance is not lower than AB, and the adherence is not lower than A (comparison between Sample 111 and Sample 112: in Sample 111, the refractive index interface is not formed, resulting in a uniform layer).

Furthermore, in Sample 110 using a silica particle not having a hollow structure, compared with Sample 114 by sequential coating, excellent results are obtained, that is, the uneven distribution of particles is not lower than A, the level of surface failure is not lower than AB, the integrated reflectance is 2.7% or less, the scratch resistance is not lower than A, and the adherence is not lower than AA.

In Samples 106 and 107 where the component (E) for use in the present invention is used, higher effects are achieved in view of uneven distribution of particles and scratch resistance, and excellent results are obtained, that is, the uneven distribution of particles is not lower than AA, the level of surface failure is not lower than A, the integrated reflectance is 1.4% or less, the scratch resistance is not lower than A, and the adherence is not lower than AA.

### Example 2

Respective components were mixed as shown in Table 8 and diluted with the solvent shown in the Table below to produce a coating solution for low refractive index layer having a solid content of 20 mass %. In Table 8, the amount added of each component indicates “parts by mass”.

TABLE 8

| | Component A | | Component B | | Component C | | | Component E | | Initiator | | | |
|---|---|---|---|---|---|---|---|---|---|---|---|---|---|
| | | Amount | | Amount | | Amount | Component D | | Amount | | Amount | | |
| | Kind | Added | Kind | Added | Kind | Added | Kind | Kind | Added | Kind | Added | ΔG | Remarks |
| Comp-201 | EPF-101 | 2.0 | S-1 | 2.0 | DPHA | 90 | MEK/PGME/ | — | — | Irg. 127 | 3.0 | 0.023 | Invention |
| | | | | | | | cyclohexanone = | | | | | | |
| | | | | | | | 90/5/5 | | | | | | |
| Comp-202 | EPF-103 | 2.0 | S-1 | 2.0 | DPHA | 90 | MEK/PGME/ | — | — | Irg. 127 | 3.0 | 0.021 | Invention |
| | | | | | | | cyclohexanone = | | | | | | |
| | | | | | | | 90/5/5 | | | | | | |
| Comp-203 | EPF-104 | 2.0 | S-1 | 2.0 | DPHA | 90 | MEK/PGME/ | — | — | Irg. 127 | 3.0 | 0.023 | Invention |
| | | | | | | | cyclohexanone = | | | | | | |
| | | | | | | | 90/5/5 | | | | | | |
| Comp-204 | EPF-109 | 2.0 | S-1 | 2.0 | DPHA | 90 | MEK/PGME/ | — | — | Irg. 127 | 3.0 | 0.021 | Invention |
| | | | | | | | cyclohexanone = | | | | | | |
| | | | | | | | 90/5/5 | | | | | | |
| Comp-205 | EPF-110 | 2.0 | S-1 | 2.0 | DPHA | 90 | MEK/PGME/ | — | — | Irg. 127 | 3.0 | 0.020 | Invention |
| | | | | | | | cyclohexanone = | | | | | | |
| | | | | | | | 90/5/5 | | | | | | |
| Comp-206 | EPF-111 | 2.0 | S-1 | 2.0 | DPHA | 90 | MEK/PGME/ | — | — | Irg. 127 | 3.0 | 0.020 | Invention |
| | | | | | | | cyclohexanone = | | | | | | |
| | | | | | | | 90/5/5 | | | | | | |
| Comp-207 | EPF-114 | 2.0 | S-1 | 2.0 | DPHA | 90 | MEK/PGME/ | — | — | Irg. 127 | 3.0 | 0.021 | Invention |
| | | | | | | | cyclohexanone = | | | | | | |
| | | | | | | | 90/5/5 | | | | | | |
| Comp-208 | EPF-103 | 2.0 | S-1 | 2.0 | DPHA | 90 | MEK100 | — | — | Irg. 127 | 3.0 | 0.021 | Invention |
| Comp-209 | EPF-103 | 2.0 | S-1 | 2.0 | DPHA | 90 | MEK/ | — | — | Irg. 127 | 3.0 | 0.021 | Invention |
| | | | | | | | cyclohexanone = | | | | | | |
| | | | | | | | 80/20 | | | | | | |
| Comp-210 | EPF-103 | 2.0 | S-1 | 2.0 | A- | 90 | MEK/PGME/ | — | — | Irg. 127 | 3.0 | 0.018 | Invention |
| | | | | | TMMT | | cyclohexanone = | | | | | | |
| | | | | | | | 90/5/5 | | | | | | |
| Comp-211 | EPF-103 | 2.0 | S-1 | 2.0 | U4HA | 90 | MEK/PGME/ | — | — | Irg. 127 | 3.0 | 0.028 | Invention |
| | | | | | | | cyclohexanone = | | | | | | |
| | | | | | | | 90/5/5 | | | | | | |
| Comp-212 | EPF-103 | 0.7 | S-1 | 2.0 | DPHA | 90 | MEK/PGME/ | F-49/P- | 1.3 | Irg. 127 | 3.0 | 0.021 | Invention |
| | | | | | | | cyclohexanone = | 14 = 5/5 | | | | | |
| | | | | | | | 90/5/5 | | | | | | |
| Comp-213 | EPF-103 | 0.7 | S-1 | 2.0 | DPHA | 90 | MEK/PGME/ | F-49/P- | 1.3 | Irg. 127 | 3.0 | 0.021 | Invention |
| | | | | | | | cyclohexanone = | 14 = 8/2 | | | | | |
| | | | | | | | 90/5/5 | | | | | | |
| Comp-214 | EPF-13 | 2.0 | S-1 | 2.0 | DPHA | 90 | MEK/PGME/ | — | — | Irg. 127 | 3.0 | 0.021 | Invention |
| | | | | | | | cyclohexanone = | | | | | | |
| | | | | | | | 90/5/5 | | | | | | |
| Comp-215 | P-14 | 2.0 | S-1 | 2.0 | DPHA | 90 | MEK/PGME/ | — | — | Irg. 127 | 3.0 | 0.006 | Comparative |
| | | | | | | | cyclohexanone = | | | | | | Example |
| | | | | | | | 90/5/5 | | | | | | |
| Ln-3 | EPF-103 | 2.0 | S-1 | 2.0 | — | — | MEK/PGME/ | — | — | Irg. 127 | 0.06 | — | Comparative |
| | | | | | | | cyclohexanone = | | | | | | Example |
| | | | | | | | 90/5/5 | | | | | | |
| HC-2 | — | — | — | — | DPHA | 90 | MEK/PGME/ | — | — | Irg. 127 | 3.0 | — | Comparative |
| | | | | | | | cyclohexanone = | | | | | | Example |
| | | | | | | | 90/5/5 | | | | | | |

The compound used above is as follows.
A-TMMT: Pentaerythritol tetraacrylate (produced by Shin-Nakamura Chemical Co., Ltd.)
U-4HA: Urethane acrylate (NK Oligo U-4HA, produced by Shin-Nakamura Chemical Co., Ltd.)

### [Formation of Laminate]

Coating Composition Comp-201 in the Table above was coated on the undercoat layer of Base Material TAC-1 by a die coater under the condition of a conveying speed of 30 m/min and then dried at 60° C. for 150 seconds and thereafter, under purging with nitrogen (oxygen concentration: 0.1% or less), the coated layer was cured by irradiation with an ultraviolet ray at an illuminance of 400 mW/cm² and an irradiation dose of 400 mJ/cm² by using an air-cooled metal halide lamp (manufactured by Eye Graphics Co., Ltd.) of 160 W/cm to form Laminate 201 such that the film thickness becomes 2.4 μm after curing. With respect to other coating compositions (Comp-202 to Comp-215) in the Table, Laminates 202 to 215 were produced in the same manner. At this time, the coated amount was adjusted in steps of 10% in the range of +40% so that the minimal wavelength of the reflectance could become from 520 to 560 nm in the measurement of reflectance.

Also, as the laminate for comparison, Coating Solution (HC-2) for hardcoat layer was coated on Base Material TAC-1 to form a hardcoat layer such that the film thickness becomes 2.3 μm after curing. Furthermore, Coating Solution Ln-3 for low refractive index layer was coated thereon by a die coater to form Comparative Laminate 216 such that the film thickness becomes 95 nm after curing. As for the curing conditions and the like, the laminate was produced according to production of Sample 101 of Example 1.

The obtained antireflection film was evaluated according to the evaluations in Example 1 and the results are shown in Table 9 below.

TABLE 9

| | | | | | | Low Refractive | | High Refractive | | | | |
|---|---|---|---|---|---|---|---|---|---|---|---|---|
| | | | Uneven | | | Index Layer | | Index Layer | | | | |
| | | | Distribution | | | Re- | Film | Re- | Film | | | |
| Sample | Base | Coating | of Fine | Surface | Integrated | fractive | Thickness | fractive | Thickness | Scratch | Ad- | |
| No. | Material | Composition | Particle | Failure | Reflectance | Index | (nm) | Index | (μm) | Resistance | herence | Remarks |
| 201 | TAC-1 | Comp-201 | AA | AA | 1.2% | 1.36 | 94 | 1.53 | 2.3 | A | AA | Invention |
| 202 | TAC-1 | Comp-202 | AA | AA | 1.2% | 1.36 | 96 | 1.53 | 2.3 | A | AA | Invention |
| 203 | TAC-1 | Comp-203 | AA | A | 1.3% | 1.36 | 94 | 1.53 | 2.3 | A | AA | Invention |
| 204 | TAC-1 | Comp-204 | AA | AA | 1.2% | 1.36 | 93 | 1.53 | 2.3 | A | AA | Invention |
| 205 | TAC-1 | Comp-205 | AA | A | 1.4% | 1.37 | 94 | 1.53 | 2.3 | A | AA | invention |
| 206 | TAC-1 | Comp-206 | AA | AA | 1.3% | 1.36 | 95 | 1.53 | 2.3 | A | AA | Invention |
| 207 | TAC-1 | Comp-207 | AA | AA | 1.3% | 1.36 | 94 | 1.53 | 2.3 | A | AA | Invention |
| 208 | TAC-1 | Comp-208 | AA | A | 1.4% | 1.37 | 95 | 1.53 | 2.3 | AB | AA | Invention |
| 209 | TAC-1 | Comp-209 | AA | A | 1.4% | 1.37 | 96 | 1.53 | 2.3 | AB | AA | Invention |
| 210 | TAC-1 | Comp-210 | AA | A | 1.3% | 1.36 | 94 | 1.53 | 2.3 | AB | AA | Invention |
| 211 | TAC-1 | Comp-211 | AA | AA | 1.2% | 1.36 | 95 | 1.53 | 2.3 | A | AA | Invention |
| 212 | TAC-1 | Comp-212 | AA | AA | 1.2% | 1.36 | 93 | 1.53 | 2.3 | A | AA | Invention |
| 213 | TAC-1 | Comp-213 | AA | AA | 1.2% | 1.36 | 95 | 1.53 | 2.3 | A | AA | Invention |
| 214 | TAC-1 | Comp-214 | A | AB | 1.6% | 1.37 | 98 | 1.53 | 2.3 | AB | AA | Invention |
| 215 | TAC-1 | Comp-215 | CC | A | 2.9% | — | — | 1.51 | 2.4 | AB | AA | Comparative |
| | | | | | | | | | | | | Example |
| 216 | TAC-1 | HC-2/Ln-3 | — | A | 1.3% | 1.36 | 95 | 1.53 | 2.3 | A | B | Comparative |
| | | | | | | | | | | | | Example |

As seen from Table 9, in Samples 201 to 213 where a fine particle-containing layer is unevenly distributed upward and two layers differing in the composition are simultaneously formed by one coating, the production efficiency is high and compared with Sample 216 by sequential coating, excellent results are obtained, that is, the uneven distribution of particles is on the same level, the level of surface failure is not lower than A, the integrated reflectance is 1.4% or less, the scratch resistance is not lower than AB, and the adherence is not lower than AA.

Also, in Samples 201 to 213 where a basic component-containing constituent unit is graft-polymerized, thanks to higher adsorption ability, uneven upward distribution of particles is enhanced and therefore, compared with Sample 214, excellent results are obtained, that is, the uneven distribution of particles is on the same level, the level of surface failure is not lower than A, the integrated reflectance is 1.4% or less, the scratch resistance is not lower than AB, and the adherence is not lower than AA.

When solvents of MEK, PGME and cyclohexanone in Samples 202, 208 and 209 are used in combination, phase separation can be improved by the poor solvent whose difference in the SP value from the component (A) is about 4.5 (PGME), the time after phase separation until completion of the migration of the inorganic fine particle can be gained by the solvent having a boiling point not lower than 100° C. (cyclohexanone), and from the standpoint of enhancing the productivity, quick drying until the concentration allowing for phase separation of the inorganic fine particle (B) together with the component (A) can be achieved by the solvent having a boiling point of 100° C. or less (MEK), so that excellent results can be obtained, that is, the uneven distribution is not lower than A, the integrated reflectance is 1.4% or less, the scratch resistance is not lower than AB, and the adherence is not lower than A.

In Samples 202, 210 and 211, thanks to the component (C) of the present invention, whose free energy of mixing with the component (A) of the present invention is zero or more, the separability of the binder from the compound A is improved, and excellent results are obtained, that is, the uneven distribution of particles is not lower than A, the integrated reflectance is 1.4% or less, the scratch resistance is not lower than AB, and the adherence is not lower than A.

In Samples 212 and 213 where the component (E) for use in the present invention is used, higher effects are achieved in view of uneven distribution of particles and scratch resistance, and excellent results are obtained, that is, the uneven distribution of particles is not lower than AA, the level of surface failure is not lower than A, the integrated reflectance is 1.2% or less, the scratch resistance is not lower than A, and the adherence is not lower than AA.

### Example 3

Respective components were mixed as shown in Table 10 and diluted with the solvent shown in Table 10 to produce a coating solution for low refractive index layer having a solid content of 25 mass %. In Table 10, the amount added of each component indicates “parts by mass”.

TABLE 10

| | Component A | | Component B | | Component C | | | Component E | | Initiator | | | |
|---|---|---|---|---|---|---|---|---|---|---|---|---|---|
| | | Amount | | Amount | | Amount | Component D | | Amount | | Amount | | |
| | Kind | Added | Kind | Added | Kind | Added | Kind | Kind | Added | Kind | Added | ΔG | Remarks |
| Comp-301 | EPS-1 | 2.0 | S-1 | 2.0 | DPHA | 60 | MEK/PGME/ | — | — | Irg. 127 | 2.0 | 0.030 | Invention |
| | | | | | | | cyclohexanone = 80/10/10 | | | | | | |
| Comp-302 | EPS-3 | 2.0 | S-1 | 2.0 | DPHA | 60 | MEK/PGME/ | — | — | Irg. 127 | 2.0 | 0.025 | Invention |
| | | | | | | | cyclohexanone = 80/10/10 | | | | | | |
| Comp-303 | EPS-11 | 2.0 | S-1 | 2.0 | DPHA | 60 | MEK/PGME/ | — | — | Irg. 127 | 2.0 | 0.030 | Invention |
| | | | | | | | cyclohexanone = 80/10/10 | | | | | | |
| Comp-304 | EPS-12 | 2.0 | S-1 | 2.0 | DPHA | 60 | MEK/PGME/ | — | — | Irg. 127 | 2.0 | 0.034 | Invention |
| | | | | | | | cyclohexanone = 80/10/10 | | | | | | |
| Comp-305 | EPS-14 | 2.0 | S-1 | 2.0 | DPHA | 60 | MEK/PGME/ | — | — | Irg. 127 | 2.0 | 0.030 | Invention |
| | | | | | | | cyclohexanone = 80/10/10 | | | | | | |
| Comp-306 | EPS-23 | 2.0 | S-1 | 2.0 | DPHA | 60 | MEK/PGME/ | — | — | Irg. 127 | 2.0 | 0.031 | Invention |
| | | | | | | | cyclohexanone = 80/10/10 | | | | | | |

### [Formation of Laminate]

Coating Composition Comp-301 in Table 10 was coated on the undercoat layer of Base Material TAC-1 by a die coater and after drying the solvent, the coated layer was cured by ultraviolet irradiation to form Laminate 301 such that the film thickness becomes 1.6 μm after curing. With respect to other coating compositions (Comp-302 to Comp-306) in Table 10, Laminates 302 to 306 were produced in the same manner. At this time, the coated amount was adjusted in steps of 10% in the range of +40% so that the minimal wavelength of the reflectance could become from 520 to 560 nm in the measurement of reflectance.

The thus-obtained antireflection film samples were evaluated according to the evaluations in Example 1 and the results are shown in Table 11 below.

TABLE 11

| | | | | | | Low Refractive | | High Refractive | | | | |
|---|---|---|---|---|---|---|---|---|---|---|---|---|
| | | | | | | Index Layer | | Index Layer | | | | |
| | | | Uneven | | | Re- | Film | Re- | Film | | | |
| Sample | Base | Coating | Distribution of | Surface | Integrated | fractive | Thickness | fractive | Thickness | Scratch | Ad- | |
| No. | Material | Composition | Fine Particle | Failure | Reflectance | Index | (nm) | Index | (μm) | Resistance | herence | Remarks |
| 301 | TAC-1 | Comp-301 | A | A | 1.7% | 1.37 | 95 | 1.53 | 1.5 | AB | AA | Invention |
| 302 | TAC-1 | Comp-302 | A | A | 1.7% | 1.37 | 95 | 1.53 | 1.5 | A | AA | Invention |
| 303 | TAC-1 | Comp-303 | A | A | 1.7% | 1.37 | 95 | 1.53 | 1.5 | A | AA | invention |
| 304 | TAC-1 | Comp-304 | A | A | 1.7% | 1.37 | 95 | 1.53 | 1.5 | AB | AA | Invention |
| 305 | TAC-1 | Comp-305 | AA | A | 1.6% | 1.37 | 95 | 1.53 | 1.5 | A | AA | Invention |
| 306 | TAC-1 | Comp-306 | B | AB | 1.8% | 1.38 | 95 | 1.53 | 1.5 | AB | AA | Invention |

As seen from Table 11, in Samples 301 to 306, even when a silicone compound is used for the component (A) of the present invention, similarly to Sample 101, excellent results are obtained, that is, the uneven distribution of particles is not lower than A, the integrated reflectance is 1.8% or less, the scratch resistance is not lower than AB, and the adherence is not lower than A.

As understood from these results of Examples and Comparative Examples, the coating composition of the present invention enables the inorganic fine particle to be unevenly distributed upward, so that an inorganic particle-containing layer and an inorganic particle-free layer can be formed by one coating step, ensuring high productivity. Also, the obtained laminate is low-reflective and is an antireflection film excellent in the scratch resistance and adherence as well as in the scratch resistance after saponification.

This application is based on a Japanese patent application filed on Feb. 15, 2011 (Japanese Patent Application No. 2011-30309), and a Japanese patent application filed on Feb. 14, 2012 (Japanese Patent Application No. 2012-29894) and the contents thereof are incorporated herein by reference.

What is claimed is:

1. A production method of an antireflection film, comprising, in order:
mixing the following components (A) to (D) to obtain a coating composition,
applying the coating composition on a base material to form a coating film,
drying the coating film to volatilize the solvent therefrom, and
curing the coating film to form a cured layer,
wherein a multilayer structure having different refractive indexes is formed from the coating composition:
(A) a compound having at least one structure selected from a fluorine-containing hydrocarbon structure and a polysiloxane structure and at least one basic functional group,
(B) an inorganic fine particle,
(C) a curable binder containing no fluorine atom in the molecule, and
(D) a solvent
provided that the mass ratio of [component (A)+component (B)]/[component (C)] is from 1/199 to 60/40.

2. The production method of an antireflection film as claimed in claim 1, wherein the component (A) is a fluorine-containing polymer represented by the following formula (1):
(MF1)a-(MF2)b-(MF3)c-(MA)d-(MB)e-(MD)g Formula (1)
wherein each of a to e and g indicates the molar fraction of each constituent unit and represents a value satisfying the relationships of 0≦a≦70, 0≦b≦70, 30a+b≦70, 0≦c≦50, 0≦d≦50, 0≦e≦50, and 0.1≦g≦30;
(MF1) indicates a constituent unit polymerized from a monomer represented by CF₂═CF—Rf₁, wherein Rf₁ represents a perfluoroalkyl group having a carbon number of 1 to 5;
(MF2) indicates a constituent unit polymerized from a monomer represented by CF₂═CF—ORf₁₂, wherein Rf₁₂ represents a fluorine-containing alkyl group having a carbon number of 1 to 30;
(MF3) indicates a constituent unit polymerized from a monomer represented by CH₂═CH—ORf₁₃, wherein Rf₁₃ represents a fluorine-containing alkyl group having a carbon number of 1 to 30;
(MA) represents a constituent unit having at least one crosslinking groups;
(MB) represents an arbitrary constituent unit; and
(MD) represents a constituent unit having at least one basic functional groups.

3. The production method of an antireflection film as claimed in claim 1, wherein the component (A) is a polymer containing a polymerization unit having a fluorine-containing hydrocarbon structure and the basic component-containing constituent unit is grafted.

4. The production method of an antireflection film as claimed in claim 2, wherein the (MD) is a constituent unit obtained by reacting an unsaturated group-containing prepolymer containing a basic functional group.

5. The production method of an antireflection film as claimed in claim 2, wherein the (MD) is a constituent unit obtained by reacting a component having bonded thereto a basic functional group-containing compound through a polyfunctional epoxy compound.

6. The production method of an antireflection film as claimed in claim 1, wherein the component (A) is a polysiloxane compound represented by the following formula (2):
(polysiloxane unit)α-(MA)β-(MB)γ-(MD)ε Formula (2)
wherein each of α to γ and ε indicates the mass proportion of each constituent unit and is a value satisfying the relationships of 2≦α≦99, 0≦β≦70, and 0.1≦ε≦30;
(polysiloxane unit) represents a polysiloxane unit copolymerizable with other components;
(MA) represents a constituent unit having at least one crosslinking groups;
(MB) represents an arbitrary constituent unit; and
(MD) represents a constituent unit having at least one basic functional groups.

7. The production method of an antireflection film as claimed in claim 1, wherein the component (A) contains both a fluorine-containing hydrocarbon unit and a polysiloxane unit in the molecule.

8. The production method of an antireflection film as claimed in claim 1, wherein the component (A) contains a polymerizable functional group in the molecule.

9. The production method of an antireflection film as claimed in claim 1, wherein the component (B) is a metal oxide fine particle having an average particle diameter of 1 to 150 nm and a refractive index of 1.46 or less.

10. The production method of an antireflection film as claimed in claim 1, wherein the component (B) is an inorganic fine particle surface-treated with at least one member selected from an organosilane compound, its partial hydrolysate and a condensation product thereof.

11. The production method of an antireflection film as claimed in claim 1, wherein the component (B) is a metal oxide particle with the inorganic fine particle surface comprising at least silicon as the constituent component.

12. The production method of an antireflection film as claimed in claim 1, wherein a compound having at least a plurality of unsaturated double bonds in the molecule is contained as the curable binder of the component (C).

13. The production method of an antireflection film as claimed in claim 1, wherein the coating composition further contains, as the component (E), a curable compound having a fluorine atom in the molecule.

14. The production method of an antireflection film as claimed in claim 13, wherein both of the component (A) and the component (E) are a fluorine-containing copolymer and at least two constituent units out of constituent units forming each copolymer are common therebetween.

15. The production method of an antireflection film as claimed in claim 1, wherein the free energy of mixing (ΔG=ΔH−T·ΔS) of the curable binder as the component (C) and the compound as the component (A) is larger than 0.

16. The production method of an antireflection film as claimed in claim 13, wherein in the coating composition, the mass ratio [component (A)+component (B)+component (E)]/[component (C)] is from 1/199 to 60/40.

17. The production method of an antireflection film as claimed in claim 1, wherein the component (D) is a mixed solvent of at least the following two solvents:
(D-1) a volatile solvent wherein a difference in the compatibility parameter between the volatile solvent and either one of the component (A) and the component (C) is from 1 to 10, and
(D-2) a volatile solvent having a boiling point of 100° C. or less.

18. The production method of an antireflection film as claimed in claim 17, wherein the solvent further contains, as the component (D-3), a volatile solvent having a boiling point exceeding 100° C.

19. An antireflection film obtained by the production method claimed in claim 1.

20. The antireflection film as claimed in claim 19, wherein the film thickness of the cured layer formed of the coating composition comprising the following components (A) to (D) is from 0.1 to 20 μm, the cured layer has a low refractive index layer in which the component (B) is unevenly distributed to the air interface side, and the film thickness of the low refractive index layer is from 40 to 300 nm:
(A) a compound having at least one structure selected from a fluorine-containing hydrocarbon structure and a polysiloxane structure and at least one basic functional group,
(B) an inorganic fine particle,
(C) a curable binder containing no fluorine atom in the molecule, and
(D) a solvent
provided that the mass ratio of [component (A)+component (B)]/[component (C)] is from 1/199 to 60/40.

21. The antireflection film as claimed in claim 20, wherein the refractive index of the low refractive index layer in which the component (B) is unevenly distributed to the air interface side is from 1.15 to 1.48.

22. A coating composition obtained by mixing the following components (A) to (D):
(A) a compound having at least one structure selected from a fluorine-containing hydrocarbon structure and a polysiloxane structure and at least one basic functional group,
(B) an inorganic fine particle,
(C) a curable binder containing no fluorine atom in the molecule, and
(D) a solvent
provided that the mass ratio of [component (A)+component (B)]/[component (C)] is from 1/199 to 60/40.
